(19) United States
(12) Patent Application Publication
(10) Pub. No.: US 2018/0195003 A1
(43) Pub. Date: Jul. 12, 2018

(54) PROCESS FOR THE STABILISATION OF LIQUID CRYSTAL MEDIA

(71) Applicant: Merck Patent GmbH, Darmstadt (DE)

(72) Inventors: Martin ENGEL, Darmstadt (DE); Nico JOHN, Gross-Gerau (DE); Rocco FORTTE, Frankfurt am Main (DE); Constanze BROCKE, Gross-Gerau (DE)

(73) Assignee: Merck Patent GmbH, Darmstadt (DE)

(21) Appl. No.: 15/740,867

(22) PCT Filed: May 27, 2016
(86) PCT No.: PCT/EP2016/000888

§ 371 Date: Dec. 29, 2017

(30) Foreign Application Priority Data
Jun. 30, 2015 (GB) 1511449.9

(51) Int. Cl. C09K 19/54; C09K 19/30; G02F 1/1339; G02F 1/1341

(52) U.S. Cl. CPC C09K 19/54; C09K 19/3098; C09K 19/3003; G02F 1/1339; C09K 2019/3016; C09K 2019/3004; C09K 2019/3009; C09K 2019/301; G02F 1/1341

(57) ABSTRACT

The present invention relates to a process for the stabilisation of a Liquid crystal (LC) mixture with negative dielectric anisotropy characterised in that one or more stabilisers of formula I

R^{a}-A¹-(Z¹-A²)ₘ₁-R^{b} I

in which R^{a}, R^{b}, A¹, A², Z¹ and m1 have the meanings given in claim 1, are added to the LC mixture in a total amount of ≤0.1% based on the total mixture, to an LC medium containing one or more stabilisers of formula I and to an LC display of the VA-, IPS or FFS type comprising said stabilised liquid crystal medium.

The present invention relates to a process for the stabilisation of liquid crystal (LC) media with negative dielectric anisotropy using a stabiliser, to an LC medium containing a stabiliser and to an LC display of the VA-, IPS or FFS type comprising a stabilised liquid crystal medium.

### BACKGROUND OF THE INVENTION

The liquid crystal displays (LC displays) used at present are usually those of the TN (“twisted nematic”) type. However, these have the disadvantage of a strong viewing-angle dependence of the contrast.

In addition, so-called VA (“vertically aligned”) displays are known which have a broader viewing angle. The LC cell of a VA display contains a layer of an LC medium between two transparent electrodes, where the LC medium usually has a negative value of the dielectric anisotropy (Δε). In the switched-off state, the molecules of the LC layer are aligned perpendicular to the electrode surfaces (homeotropically) or have a tilted homeotropic alignment. On application of a voltage to the two electrodes, a realignment of the LC molecules parallel to the electrode surfaces takes place.

Furthermore, so-called FFS (“fringe-field switching”) displays have been reported (see, inter alia, S. H. Jung et al., Jpn. J. Appl. Phys., Volume 43, No. 3, 2004, 1028), which contain two electrodes on the same substrate, one of which is structured in a comb-shaped manner and the other is unstructured. A strong, so-called “fringe field” is thereby generated, i.e. a strong electric field close to the edge of the electrodes, and, throughout the cell, an electric field which has both a strong vertical component and also a strong horizontal component. FFS displays have a low viewing-angle dependence of the contrast. FFS displays usually contain an LC medium with positive dielectric anisotropy, and an alignment layer, usually of polyimide, which provides planar alignment to the molecules of the LC medium.

FFS displays can be operated as active-matrix or passive-matrix displays. In the case of active-matrix displays, individual pixels are usually addressed by integrated, non-linear active elements, such as, for example, transistors (for example thin-film transistors (“TFTs”)), while in the case of passive-matrix displays, individual pixels are usually addressed by the multiplex method, as known from the prior art.

Also known are so-called IPS (“in-plane switching”) displays, which contain an LC layer between two substrates with planar orientation, where the two electrodes are arranged on only one of the two substrates and preferably have interdigitated, comb-shaped structures. On application of a voltage to the electrodes an electric field with a significant component parallel to the LC layer is generated between them. This causes realignment of the LC molecules in the layer plane.

Furthermore, FFS displays have been disclosed (see S. H. Lee et al., Appl. Phys. Lett. 73(20), 1998, 2882-2883 and S. H. Lee et al., Liquid Crystals 39(9), 2012, 1141-1148), which have similar electrode design and layer thickness as FFS displays, but comprise a layer of an LC medium with negative dielectric anisotropy instead of an LC medium with positive dielectric anisotropy. The LC medium with negative dielectric anisotropy shows a more favourable director orientation that has less tilt and more twist orientation compared to the LC medium with positive dielectric anisotropy, as a result of which these displays have a higher transmission.

However, the use of LC media with negative dielectric anisotropy in FFS displays has also several drawbacks. For example, they have a significantly lower reliability compared to LC media with positive dielectric anisotropy.

The term “reliability” as used hereinafter means the quality of the performance of the display during time and with different stress loads, such as light load, temperature, humidity, or voltage which cause display defects such as image sticking (area and line image sticking), mura, yogore etc. and which are known to the skilled person in the field of LC displays. As a standard parameter for categorising the reliability usually the voltage holding ration (VHR) value is used, which is a measure for maintaining a constant electrical voltage in a test display. The higher the VHR value, the better the reliability of the medium.

The reduced reliability of an LC medium with negative dielectric anisotropy in an FFS display can be explained by an interaction of the LC molecules with the polyimide of the alignment layer, as a result of which ions are extracted from the polyimide alignment layer, and wherein LC molecules with negative dielectric anisotropy do more effectively extract such ions.

This results in new requirements for LC media to be used in FFS displays. In particular, the LC medium has to show a high reliability and a high VHR value after UV exposure. Further requirements are a high specific resistance, a large working-temperature range, short response times even at low temperatures, a low threshold voltage, a multiplicity of grey levels, high contrast and a broad viewing angle, and reduced image sticking.

Thus, in displays known from prior art often the undesired effect of so-called “image sticking” or “image burn” is observed, wherein the image produced in the LC display by temporary addressing of individual pixels still remains visible even after the electric field in these pixels has been switched off, or after other pixels have been addressed.

This “image sticking” can occur on the one hand if LC media having a low VHR are used. The UV component of daylight or the backlight can cause undesired decomposition reactions of the LC molecules therein and thus initiate the production of ionic or free-radical impurities. These may accumulate, in particular, at the electrodes or the alignment layers, where they may reduce the effective applied voltage.

Another problem observed in prior art is that LC media for use in displays, including but not limited to FFS displays, do often exhibit high viscosities and, as a consequence, high switching times. In order to reduce the viscosity and switching time of the LC medium, it has been suggested in prior art to add LC compounds with an alkenyl group. However, it was observed that LC media containing alkenyl compounds often show a decrease of the reliability and stability, and a decrease of the VHR especially after exposure to UV radiation but also to visible light from the backlight of a display, that usually does not emit UV light.

In order to reduce the decrease of the reliability and stability, the use of stabilisers was proposed, such as for example compounds of the HALS—(hindered amine light stabiliser) type, as disclosed in e.g. EP 2 514 800 B1 and WO 2009/129911 A1. A typical example is Tinuvin 770, a compound of the formula

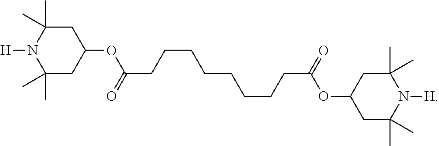

Nevertheless, these LC mixtures can still exhibit insufficient reliability during the operation of a display, e.g. upon irradiation with the typical CCFL—(Cold Cathode Fluorescent Lamp) backlight.

A different class of compound used for the stabilisation of liquid crystals are antioxidants derived from phenol, such as for example the compound

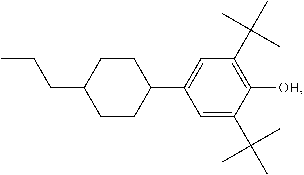 [SMILES: CCCC1CCC(c2cc(C(C)(C)C)c(O)c(C(C)(C)C)c2)CC1]

as described in DE 19539141 A1. Such stabilisers can be used to stabilise LC mixtures against heat or the influence of oxygen but typically do not show advantages under light stress.

Because of the complex modes of action of the different kinds of stabilisers and minute effects in a display, where the liquid crystal, a complex mixture of many different types of compounds itself, interacts with different kinds of species, including the polyimide, it is a challenging task also for the skilled person to choose the right stabiliser in order to identify the best material combination. Hence, there is still great demand for new types of stabilisers with different properties in order to broaden the range of applicable materials.

It is therefore an object of the present invention to provide a process for providing improved LC media for use in VA-, IPS- or FFS displays, which do not exhibit the disadvantages described above or only do so to a small extent and have improved properties. A further object of the invention is to provide FFS displays with good transmission, high reliability, a VHR value especially after backlight exposure, a high specific resistance, a large working-temperature range, short response times even at low temperatures, a low threshold voltage, a multiplicity of grey levels, high contrast and a broad viewing angle, and reduced image sticking.

This object was achieved in accordance with the present invention by providing a process for the stabilisation of LC mixtures for the use in VA-, IPS- or FFS displays as described and claimed hereinafter. In particular, the inventors of the present invention have found that the above objects can be achieved by using an LC medium comprising a stabiliser as described hereinafter, and preferably comprising one or more alkenyl compounds, in a VA-, IPS or FFS display. It has also been found that when using such stabilisers in an LC medium for use in an FFS display, surprisingly the reliability and the VHR value after backlight load are higher, compared to an LC medium without a stabiliser according to the present invention.

The stabilisers used according to the present invention have been applied as monomers in various polymer stabilised display modes such as for example PS-VA, as disclosed in US 2015/0146155 A1 where a monomer is polymerised inside the LC cell with UV light under application of a voltage to fix a particular orientation of the LC. To remove unreacted residual monomer, additional process steps can be necessary. Surprisingly it was found that such reactive compounds are, quite contrary to being harmful in terms of reliability of the LC, able to stabilise LC mixtures under light stress.

Also, the use of an LC medium comprising a stabiliser as described hereinafter allows to exploit the known advantages of alkenyl-containing LC media, like reduced viscosity and faster switching time, and at the same time leads to improved reliability and high VHR value especially after backlight exposure.

### SUMMARY OF THE INVENTION

The present invention relates to a process for the stabilisation of a liquid crystal (LC) medium with negative dielectric anisotropy characterised in that one or more stabilisers of formula I

R^{a}-A¹-(Z¹-A²)ₘ₁-R^{b} I
in which the individual radicals have the following meanings:
R^{a} and R^{b} each, independently of one another, denote P, P-Sp-, H, halogen, SF₅, NO₂, a carbyl group or a hydrocarbyl group,
P on each occurrence, identically or differently, denotes CH₂═CW¹—CO—O—,
W¹ denotes H, F, CF₃ or alkyl having 1 to 5 C atoms,
Sp on each occurrence, identically or differently, denotes a spacer group or a single bond,
A¹ and A² each, independently of one another, denote an aromatic, heteroaromatic, alicyclic or heterocyclic group, preferably having 4 to 25 ring atoms, which may also contain fused rings, and which is optionally mono- or polysubstituted by L,
Z¹ on each occurrence, identically or differently, denotes —O—, —S—, —CO—, —CO—O—, —O—CO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, CR⁰R⁰⁰ or a single bond,
L denotes P, P-Sp-, H, OH, CH₂OH, halogen, SF₅, NO₂, a carbyl group or hydrocarbyl group,
R⁰ and R⁰⁰ each, independently of one another, denote H or alkyl having 1 to 12 C atoms,
m1 denotes 0, 1, 2, 3 or 4,
n1 denotes 1, 2, 3 or 4,
wherein at least two of the radicals R^{a}, R^{b} and L denote or contain a group P or P-Sp-,

are added to the LC medium.

Preferably the stabilisers have a liquid crystalline scaffold and are selected from aromatic acrylates or methacrylates.

The invention further relates to an LC medium containing a stabiliser of formula I and an LC display of the VA-, IPS or FFS type comprising a stabilised liquid crystal medium.

### BRIEF DESCRIPTION OF THE DRAWINGS

FIG. 1 is a plot of the transmission through a liquid crystal display with UB-FFS layout against applied voltage. One curve was measured before and the other curve was measured after 10 min of UV irradiation using a metal halide mercury lamp with 320 nm UV cut filter, under application of a voltage of 6 V. The LC mixture contains 500 ppm of stabilizer.

FIG. 2 is a plot of the transmission through a liquid crystal display with UB-FFS layout against applied voltage. One curve was measured before and the other curve was measured after 10 min of UV irradiation using a metal halide mercury lamp with 320 nm UV cut filter, under application of a voltage of 6 V. The LC mixture contains 500 ppm of stabilizer.

### DEFINITIONS OF TERMS

Ultraviolet (UV) light according to the present invention is light in the wavelength region of 320-400 nm of the electromagnetic spectrum.

The term “mesogenic group” as used herein is known to the person skilled in the art and described in the literature, and means a group which, due to the anisotropy of its attracting and repelling interactions, essentially contributes to inducing a liquid crystal (LC) phase in low-molecular-weight or polymeric substances. Compounds containing mesogenic groups (mesogenic compounds) do not necessarily have to have an LC phase themselves. It is also possible for mesogenic compounds to exhibit LC phase behaviour only after mixing with other compounds. Typical mesogenic groups are, for example, rigid rod- or disc-shaped units. An overview of the terms and definitions used in connection with mesogenic or LC compounds is given in Pure Appl. Chem. 73(5), 888 (2001) and C. Tschierske, G. Pelzl, S. Diele, Angew. Chem. 2004, 116, 6340-6368.

The term “spacer group”, hereinafter also referred to as “Sp”, is known to the person skilled in the art and is described in the literature, see, for example, Pure Appl. Chem. 73(5), 888 (2001) and C. Tschierske, G. Pelzl, S. Diele, Angew. Chem. 2004, 116, 6340-6368. As used herein, the terms “spacer group” or “spacer” mean a flexible group, for example an alkylene group, which connects the mesogenic group and a stabilising group.

As used herein, the terms “active layer” and “switchable layer” mean a layer in an electrooptical display, for example an LC display, that comprises one or more molecules having structural and optical anisotropy, like for example LC molecules, which change their orientation upon an external stimulus like an electric or magnetic field, resulting in a change of the transmission of the layer for polarized or non-polarised light.

Above and below “organic group” denotes a carbon or hydrocarbon group.

Above and below,

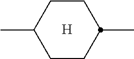

denotes a trans-1,4-cyclohexylene ring, and

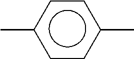

denotes a 1,4-phenylene ring.

“Carbon group” denotes a mono- or polyvalent organic group containing at least one carbon atom, where this either contains no further atoms (such as, for example, —C≡C—) or optionally contains one or more further atoms, such as, for example, N, O, S, B, P, Si, Se, As, Te or Ge (for example carbonyl, etc.). The term “hydrocarbon group” denotes a carbon group which additionally contains one or more H atoms and optionally one or more heteroatoms, such as, for example, N, O, S, B, P, Si, Se, As, Te or Ge.

“Halogen” denotes F, Cl, Br or I.

—CO—, —C(═O)— and —C(O)— denote a carbonyl group, i.e.

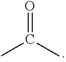

“Conjugated radical” or “conjugated group” denotes a radical or group which contains principally sp²-hybridised (or possibly also sp-hybridised) carbon atoms, which may also be replaced by corresponding heteroatoms. In the simplest case, this means the alternating presence of double and single bonds. “Principally” in this connection means that naturally (non-randomly) occurring defects which result in conjugation interruptions do not devalue the term “conjugated”. Furthermore, the term “conjugated” is likewise used in this application text if, for example, aryl amine units or certain heterocycles (i.e. conjugation via N, O, P or S atoms) are located in the radical or group.

A carbon or hydrocarbon group can be a saturated or unsaturated group. Unsaturated groups are, for example, aryl, alkenyl or alkynyl groups. A carbon or hydrocarbon radical having more than 3 C atoms can be straight-chain, branched and/or cyclic and may also contain spiro links or fused rings.

The terms “alkyl”, “aryl”, “heteroaryl”, etc., also encompass polyvalent groups, for example alkylene, arylene, heteroarylene, etc.

The term “aryl” denotes an aromatic carbon group or a group derived therefrom. The term “heteroaryl” denotes “aryl” as defined above, containing one or more heteroatoms.

### DETAILED DESCRIPTION OF THE EMBODIMENTS

Preferred carbon and hydrocarbon groups are optionally substituted alkyl, alkenyl, alkynyl, alkoxy, alkylcarbonyl, alkoxycarbonyl, alkylcarbonyloxy and alkoxycarbonyloxy having 1 to 40, preferably 1 to 25, particularly preferably 1 to 18, C atoms, optionally substituted aryl or aryloxy having 6 to 40, preferably 6 to 25, C atoms, or optionally substituted alkylaryl, arylalkyl, alkylaryloxy, arylalkyloxy, arylcarbonyl, aryloxycarbonyl, arylcarbonyloxy and aryloxycarbonyloxy having 6 to 40, preferably 6 to 25, C atoms.

Further preferred carbon and hydrocarbon groups are C₁-C₄₀ alkyl, C₂-C₄₀ alkenyl, C₂-C₄₀ alkynyl, C₃-C₄₀ allyl, C₄-C₄₀ alkyldienyl, C₄-C₄₀ polyenyl, C₆-C₄₀ aryl, C₆-C₄₀ alkylaryl, C₆-C₄₀ arylalkyl, C₆-C₄₀ alkylaryloxy, C₆-C₄₀ aryl-alkyloxy, C₂-C₄₀ heteroaryl, C₄-C₄₀ cycloalkyl, C₄-C₄₀ cycloalkenyl, etc. Particular preference is given to C₁-C₂₂ alkyl, C₂-C₂₂ alkenyl, C₂-C₂₂ alkynyl, C₃-C₂₂ allyl, C₄-C₂₂ alkyldienyl, C₆-C₁₂ aryl, C₆-C₂₀ arylalkyl and C₂-C₂₀ heteroaryl.

Further preferred carbon and hydrocarbon groups are straight-chain, branched or cyclic alkyl radicals having 1 to 40, preferably 1 to 25, C atoms, which are unsubstituted or mono- or polysubstituted by F, Cl, Br, I or CN and in which one or more non-adjacent CH₂ groups may each be replaced, independently of one another,

by —C(R^{x})═C(R^{x})—, —C≡C—, —N(R^{x})—, —O—, —S—, —CO—, —CO—O—, —O—CO—, —O—CO—O— in such a way that O and/or S atoms are not linked directly to one another.

R^{x} preferably denotes H, halogen, a straight-chain, branched or cyclic alkyl chain having 1 to 25 C atoms, in which, in addition, one or more non-adjacent C atoms may be replaced by —O—, —S—, —CO—, —CO—O—, —O—CO—, —O—CO—O— and in which one or more H atoms may be replaced by fluorine, an optionally substituted aryl or aryloxy group having 6 to 40 C atoms, or an optionally substituted heteroaryl or heteroaryloxy group having 2 to 40 C atoms.

Preferred alkoxy groups are, for example, methoxy, ethoxy, 2-methoxy-ethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy, etc.

Preferred alkyl groups are, for example, methyl, ethyl, n-propyl, isopropyl, n-butyl, isobutyl, s-butyl, t-butyl, 2-methylbutyl, n-pentyl, s-pentyl, cyclopentyl, n-hexyl, cyclohexyl, 2-ethylhexyl, n-heptyl, cycloheptyl, n-octyl, cyclooctyl, n-nonyl, n-decyl, n-undecyl, n-dodecyl, dodecanyl, trifluoromethyl, perfluoro-n-butyl, 2,2,2-trifluoroethyl, perfluorooctyl, perfluorohexyl, etc.

Preferred alkenyl groups are, for example, vinyl, ethenyl, propenyl, butenyl, pentenyl, cyclopentenyl, hexenyl, cyclohexenyl, heptenyl, cycloheptenyl, octenyl, cyclooctenyl, etc.

Preferred alkynyl groups are, for example, ethynyl, propynyl, butynyl, pentynyl, hexynyl, octynyl, etc.

Preferred alkoxy groups are, for example, methoxy, ethoxy, 2-methoxy-ethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy, etc.

Preferred amino groups are, for example, dimethylamino, methylamino, methylphenylamino, phenylamino, etc.

Further preferred carbon and hydrocarbon groups are aryl and heteroaryl groups, which preferably contain from 3 to 20 ring atoms. The aryl and heteroaryl groups can be monocyclic, i.e., containing one ring, or polycyclic, i.e., containing two or more rings. A polycyclic aryl or heteroaryl group may contain fused rings (like for example in a naphthalene group) or covalently bonded rings (like for example in a biphenyl group), or both fused rings and covalently bonded rings. Heteroaryl groups contain one or more heteroatoms preferably selected from O, N, S and Se.

Particular preference is given to mono-, bi- or tricyclic aryl groups having 5 to 25 C atoms and mono-, bi- or tricyclic heteroaryl groups having 3 to 25 ring atoms, which optionally contain fused rings and are optionally substituted. Preference is furthermore given to 5-, 6- or 7-membered aryl and heteroaryl groups, in which, in addition, one or more CH groups may be replaced by N, S or O in such a way that O atoms and/or S atoms are not linked directly to one another.

Preferred aryl groups are, for example, phenyl, biphenyl, terphenyl, [1,1′:3′,1″]terphenyl-2′-yl, naphthyl, anthracene, binaphthyl, phenanthrene, 9,10-dihydro-phenanthrene, pyrene, dihydropyrene, chrysene, perylene, tetracene, pentacene, benzopyrene, fluorene, indene, indenofluorene, spirobifluorene, etc.

Preferred heteroaryl groups are, for example, 5-membered rings, such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6-membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, isoindole, indolizine, indazole, benzimidazole, benzotriazole, purine, naphthimidazole, phenanthrimidazole, pyridimidazole, pyrazinimidazole, quinoxalinimidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]thiophene, dithienothiophene, isobenzothiophene, dibenzothiophene, benzothiadiazothiophene, or combinations of these groups.

The aryl and heteroaryl groups mentioned above and below may also be substituted by alkyl, alkoxy, thioalkyl, fluorine, fluoroalkyl or further aryl or heteroaryl groups.

Further preferred carbon and hydrocarbon groups are non-aromatic carbocyclic or heterocyclic groups, which preferably contain from 3 to 20 ring atoms. The carbocyclic and heterocyclic groups may contain saturated rings, i.e., rings that are composed exclusively of single bonds, and/or partially unsaturated rings, i.e., rings which are composed of single bonds and multiple bonds like e.g. double bonds. Heterocyclic groups contain one or more hetero atoms preferably selected from Si, O, N, S and Se.

The non-aromatic carbocyclic and heterocyclic groups can be monocyclic, i.e., containing only one ring, or polycyclic, i.e., containing two or more rings. A polycyclic carbocyclic or heterocyclic group may contain fused rings (like for example in decahydronaphthalene or bicyclo[2.2.1]octane) or covalently bonded rings (like for example in 1,1′-bicyclohexane), or both fused rings and covalently bonded rings.

Particular preference is given to non-aromatic carbocyclic and heterocyclic groups that contain only saturated rings. Preference is furthermore given to non-aromatic carbocyclic and heterocyclic groups that are mono-, bi- or tricyclic, have 5 to 25 ring atoms, optionally contain fused rings, and are optionally substituted. Preference is furthermore given to 5-, 6-, 7- or 8-membered carbocyclic groups, in which, in addition, one or more C atoms may be replaced by Si and/or one or more CH groups may be replaced by N and/or one or more non-adjacent CH₂ groups may be replaced by —O— and/or —S—.

Preferred carbocyclic and heterocyclic groups are, for example, 5-membered groups, such as cyclopentane, tetrahydrofuran, tetrahydrothiofuran, pyrrolidine, 6-membered groups, such as cyclohexane, silinane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]-pentane-1,3-diyl, bicyclo[2.2.2]octane-1,4-diyl, spiro[3.3]heptane-2,6-diyl, octahydro-4,7-methanoindane-2,5-diyl, 2H-chromene (2H-1-benzopyrane), 4H-chromene (4H-1-benzopyran), coumarin (2H-chromen-2-one).

Preferred substituents are, for example, solubility-promoting groups, such as alkyl or alkoxy, electron-withdrawing groups, such as fluorine, nitro or nitrile, or substituents for increasing the glass transition temperature (Tg) in the polymer, in particular bulky groups, such as, for example, t-butyl or optionally substituted aryl groups.

Further preferred substituents, also referred to as “L” above and below, are, for example, F, Cl, Br,

I, —CN, —NO₂, —NCO, —NCS, —OCN, —SCN, —C(═O)N(R^{x})₂, —C(═O)Y¹, —C(═O)R^{x}, —N(R^{x})₂, in which R^{x} has the meaning indicated above, and Y¹ denotes halogen, optionally substituted silyl or aryl having 6 to 40, preferably 6 to 20, C atoms, and straight-chain or branched alkyl, alkoxy, alkylcarbonyl, alkoxycarbonyl, alkylcarbonyloxy or alkoxycarbonyloxy having 1 to 25 C atoms, in which one or more H atoms may optionally be replaced by F or Cl.

“Substituted silyl or aryl” preferably means substituted by halogen, —CN, R⁰, —OR⁰, —CO—R⁰, —CO—O—R⁰, —O—CO—R⁰ or —O—CO—O—R⁰, in which R⁰ has the meaning indicated above.

Particularly preferred substituents L are, for example, F, Cl, CN, NO₂, CH₃, C₂H₅, OCH₃, OC₂H₅, COCH₃, COC₂H₅, COOCH₃, COOC₂H₅, CF₃, OCF₃, OCHF₂, OC₂F₅, furthermore phenyl.

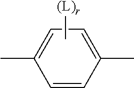

is preferably

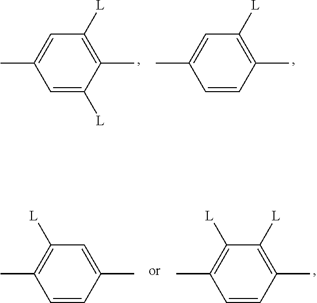

in which L has one of the meanings indicated above.

If the spacer group Sp is different from a single bond, it is preferably of the formula Sp″-X″, so that the respective radical P-Sp- conforms to the formula P-Sp″-X″, wherein
Sp″ denotes alkylene having 1 to 20, preferably 1 to 12, C atoms, which is optionally mono- or polysubstituted by F, Cl, Br, I or CN and in which, in addition, one or more non-adjacent CH₂ groups may each be replaced, independently of one another, by —O—, —S—, —NH—, —N(R⁰)—, —Si(R⁰R⁰⁰)—, —CO—, —CO—O—, —O—CO—, —O—CO—O—, —S—CO—, —CO—S—, —N (R⁰⁰)—CO—O—, —O—CO—N(R⁰)—, —N(R⁰)—CO—N(R⁰⁰)—, —CH═CH— or —C≡C— in such a way that O and/or S atoms are not linked directly to one another,
X″ denotes —O—, —S—, —CO—, —CO—O—, —O—CO—, —O—CO—O—, —CO—N(R⁰)—, —N(R⁰)— CO—, —N(R⁰)—CO—N(R⁰⁰)—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY²═CY³—, —C≡C—, —CH═CH—CO—O—, —O—CO—CH═CH— or a single bond,
R⁰ and R⁰⁰ each, independently of one another, denote H or alkyl having 1 to 20 C atoms, and
Y² and Y³ each, independently of one another, denote H, F, Cl or CN.
X″ is preferably —O—, —S—, —CO—, —CO—O—, —O—CO—, —O—CO—O—, —CO—NR⁰—, —NR⁰—CO—, —NR⁰—CO—NR⁰⁰— or a single bond.

Typical spacer groups Sp and -Sp″-X″— are, for example, —(CH₂)ₚ₁—, —(CH₂)ₚ₁—O—, —(CH₂)ₚ₁—O—CO—, —(CH₂)ₚ₁—CO—O—, —(CH₂)ₚ₁—O—CO—O—, —(CH₂CH₂O)_{q1}—CH₂CH₂—, —CH₂CH₂—S—CH₂CH₂—, —CH₂CH₂—NH—CH₂CH₂— or —(SiR⁰R⁰⁰—O)ₚ₁—, in which p1 is an integer from 1 to 12, q1 is an integer from 1 to 3, and R⁰ and R⁰⁰ have the meanings indicated above.

Particularly preferred groups Sp and -Sp″-X″— are —(CH₂)ₚ₁—, —(CH₂)ₚ₁—O—, —(CH₂)ₚ₁—O—CO—, —(CH₂)ₚ₁—CO—O—, —(CH₂)ₚ₁—O—CO—O—, in which p1 and q1 have the meanings indicated above.

Particularly preferred groups Sp″ are, in each case straight-chain, ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene and butenylene.

In another preferred embodiment of the invention the compounds of formula I and its subformulae contain a spacer group Sp that is linked to at least two stabilising groups P, so that the group Sp-P corresponds to Sp(P)ₛ, with s being (branched stabilising groups).

Preferred compounds of formula I according to this preferred embodiment are those wherein s is 2, i.e. compounds which contain a group Sp(P)₂. Very preferred compounds of formula I according to this preferred embodiment contain a group selected from the following formulae:

—X-alkyl-CHPP S1

—X-alkyl-CH((CH₂)ₐₐP)((CH₂)_{bb}P) S2

—X—N((CH₂)ₐₐP)((CH₂)_{bb}P) S3

—X-alkyl-CHP—CH₂—CH₂P S4

—X-alkyl-C(CH₂P)(CH₂P)—CₐₐH₂ₐₐ₊₁ S5

—X-alkyl-CHP—CH₂P S6

—X-alkyl-CPP—CₐₐH₂ₐₐ₊₁ S7

—X-alkyl-CHPCHP—CₐₐH₂ₐₐ₊₁ S8

in which P is as defined in formula I,
alkyl denotes a single bond or straight-chain or branched alkylene having 1 to 12 C atoms which is unsubstituted or mono- or polysubstituted by F, Cl or CN and in which one or more non-adjacent CH₂ groups may each, independently of one another, be replaced by —C(R⁰)═C(R⁰)—, —C≡C—, —N(R⁰)—, —O—, —S—, —CO—, —CO—O—, —O—CO—, —O—CO—O— in such a way that O and/or S atoms are not linked directly to one another, where R⁰ has the meaning indicated above,

aa and bb each, independently of one another, denote 0, 1, 2, 3, 4, 5 or 6,
X has one of the meanings indicated for X″, and is preferably O, CO, SO₂, O—CO—, CO—O or a single bond.

Preferred spacer groups Sp(P)₂ are selected from formulae S1, S2 and S3.

Very preferred spacer groups Sp(P)₂ are selected from the following subformulae:

—CHPP S1a

—O—CHPP S1b

—CH₂—CHPP S1c

—OCH₂—CHPP S1d

—CH(CH₂—P)(CH₂—P) S2a

—OCH(CH₂—P)(CH₂—P) S2b

—CH₂—CH(CH₂—P)(CH₂—P) S2c

—OCH₂—CH(CH₂—P)(CH₂—P) S2d

—CO—NH((CH₂)₂P)((CH₂)₂P) S3a

The stabilising group P, P¹, P² or P³ according to the present invention is a group which shows a stabilising effect when incorporated in compounds of formula I.

Preferred stabilising groups are selected from the group consisting of CH₂═CW¹—CO—O—,

wherein

W¹ denotes H, F, CF₃ or alkyl having 1 to 5 C atoms, preferably H or CH₃.

The LC medium may also comprise one or more additional stabilisers or inhibitors. Suitable types and amounts of stabilisers are known to the person skilled in the art and are described in the literature. Especially preferred stabilisers are shown in Table C below.

Particularly suitable are, for example, the commercially available stabilisers from the Irganox® series (Ciba AG), such as, for example, Irganox® 1076. If stabilisers other than stabilisers of formula I, II or III are employed, their proportion, based on the total amount of compounds of formula I, II and III in the LC medium, is preferably 10-500,000 ppm, particularly preferably 50-50,000 ppm.

The LC medium may also comprise one or more chiral dopants, for example to induce a twisted molecular structure. Suitable types and amounts of chiral dopants are known to the person skilled in the art and are described in the literature. Particularly suitable are, for example, the commercially available chiral dopants R/S-811, R/S-1011, R/S-2011, R/S-3011, R/S-4011, or R/S-5011 (Merck KGaA). If chiral dopants are employed, their proportion in the LC medium is preferably 0.001 to 15% by weight, particularly preferably 0.1 to 5% by weight. Especially preferred chiral dopants are shown in Table BC below.

In a further preferred embodiment the LC medium does not contain any chiral compounds.

Preferably the LC medium according to the present invention essentially consists of an LC host mixture and one or more stabilisers selected from the group of stabilisers of formulae I, II and Ill, preferably of formula I, as described above and below. However, the LC medium or LC host mixture may additionally comprise one or more further components or additives, preferably selected from the list including but not limited to chiral dopants, stabilizers, surfactants, wetting agents, lubricating agents, dispersing agents, hydrophobing agents, adhesive agents, flow improvers, defoaming agents, deaerators, diluents, reactive diluents, auxiliaries, colorants, dyes, pigments and nanoparticles.

Preference is furthermore given to LC media which have a nematic liquid crystal phase, and preferably have no chiral liquid crystal phase.

Preference is furthermore given to achiral LC media which contain only compounds selected from the group consisting of achiral compounds.

The LC media comprise one or more stabilisers containing two or more stabilising groups. Preferred are compounds which comprise two, three or four stabilising groups, very preferably two or three stabilising groups.

Preference is furthermore given to displays and LC media which contain exclusively stabilisers containing two or three stabilising groups.

It is also possible that the LC medium comprises two or more different stabilisers of formula I, II or III.

The proportion of the stabiliser of formula I in the LC media according to the invention is preferably from >0 to ≤1000 ppm, particularly preferably from 100 to 750 ppm, very particularly preferably from 400 to 600 ppm.

Particularly preferred stabilisers of the formula I are those in which
A¹ and A² each, independently of one another, denote 1,4-phenylene, 1,3-phenylene, 1,2-phenylene, naphthalene-1,4-diyl, naphthalene2,6-diyl, phenanthrene-2,7-diyl, anthracene-2,7-diyl, fluorene-2,7-diyl, in which, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl, octahydro-4,7-methanoindane-2,5-diyl, 9,10-dihydro-phenanthrene-2,7-diyl, 2H-chromen-2-one-3,6-diyl, 2H-chromen-2-one-3,8-diyl, or 2H-chromen-2-one-3,7-diyl, [1,1′]Binaphthalenyl-2,2′-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O) Y¹, —C(═O)R^{x}, —N(R^{x})₂, optionally substituted silyl, optionally substituted aryl having 6 to 20 C atoms, straight-chain or branched alkyl or alkoxy having 1 to 25 C atoms, or straight-chain or branched alkenyl, alkinyl, alkylcarbonyl, alkoxycarbonyl, alkylcarbonyloxy or alkoxycarbonyloxy having 2 to 25 C atoms, wherein in all of these groups, in addition, one or more H atoms may be replaced by F, Cl or P-Sp-,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl or P-Sp-, an optionally substituted aryl or aryloxy group having 6 to 40 C atoms, or an optionally substituted heteroaryl or heteroaryloxy group having 2 to 40 C atoms,

where at least one of the radicals R^{a}, R^{b} and L denotes P or P-Sp-.

Particular preference is given to compounds of the formula I in which
m1 is 1 or 2,
one or both of R^{a} and R^{b} denote P or P-Sp-,
both R^{a} and R^{b} denote P or P-Sp-,
at least two, preferably two or three of the radicals R^{a}, R^{b} and L denote or contain a group P or P-Sp-,
at least one of A¹ and A² is substituted by a group L denoting P or P-Sp-,
P is selected from acrylate and methacrylate groups,
Sp is selected from *—(CH₂)ₚ₁—, *—(CH₂)ₚ₂—O—(CH₂)ₚ₃—, *—(CH₂)ₚ₂—S—(CH₂)ₚ₃, *—(CH₂)ₚ₂—NH—(CH₂)ₚ₃, *—(CH₂)ₚ₁—O—, *—(CH₂)ₚ₁—CO—, *—(CH₂)ₚ₁—CO—O—,* —(CH₂)ₚ₁—O—CO—,

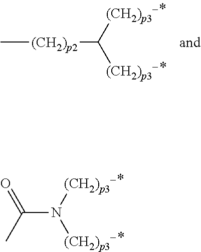

wherein the asterisk (*) denotes the link to the respective functional group(s), p1 is an integer from 1 to 12, preferably from 1 to 6, and p2 and p3 are independently of each other an integer from 1 to 6, preferably 1, 2 or 3,
A¹ and A² are selected from the group consisting of 1,4-phenylene, 1,3-phenylene-, 1,2-phenylene, naphthalene-2,6-diyl, phenanthrene-2,7-diyl, 9,10-dihydro-phenanthrene-2,7-diyl, 2H-chromen-2-one-3,6-diyl, 2H-chromen-2-one-3,8-diyl, 2H-chromen-2-one-3,7-diyl, where, in addition, one or two CH groups in these rings are optionally replaced by N, and where these rings are optionally mono- or polysubstituted by L, as described above and below,
A¹ and A² are selected from the group consisting of 1,4-phenylene, 1,3-phenylene, 1,2-phenylene, naphthalene-2,6-diyl, 2H-chromen-2-one-3,6-diyl, 2H-chromen-2-one-3,8-diyl, and 2H-chromen-2-one-3,7-diyl,
A¹ and A² are selected from the group consisting of 1,4-phenylene, 1,3-phenylene, 1,2-phenylene, naphthalene-2,6-diyl,
-A¹-(Z¹-A²)ₘ₁- denotes biphenyl-4,4′-diyl, terphenyl-4,4″-diyl, naphthalene-2,6-diyl, 6-(phenyl-4′yl)-napthalene-2-yl, 3-(phenyl-4′yl)-chromen-2-one-6-yl, 3-(phenyl-4′yl)-chromen-2-one-7-yl, 3-(phenyl-4′yl)-chromen-2-one-8-yl,
Z¹ is selected from the group consisting of —O—, —CO—O—, —OCO—, —OCH₂—, —CH₂O—, —CF₂O—, —OCF₂—, —CH₂CH₂—, —CH═CH—, —CF═CF—, —CH═CF—, —CF═CH—, —C≡C—, and a single bond,
Z¹ is a single bond,
at least one of A¹ and A² is substituted by a group L that is not a stabilising group according to the present invention, preferably selected from F, Cl, —CN and straight-chain or branched alkyl having 1 to 25, particularly preferably 1 to 10, C atoms, in which, in addition, one or more non-adjacent CH₂ groups may each be replaced, independently of one another, by —C(R⁰⁰)═C(R⁰⁰⁰)—, —C≡C—, —N(R⁰⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, Br, I or CN.

Particularly preferred compounds of the formula I are selected from the following sub-formulae:

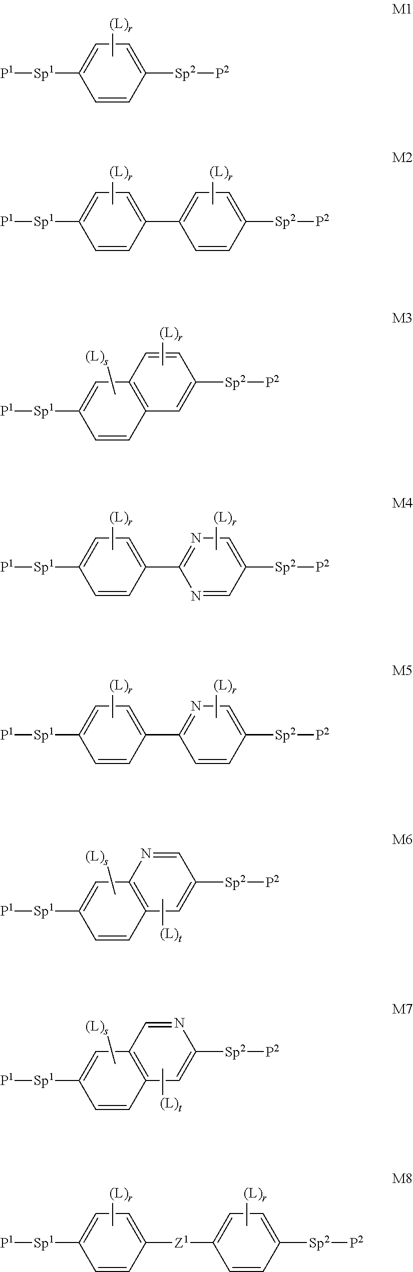

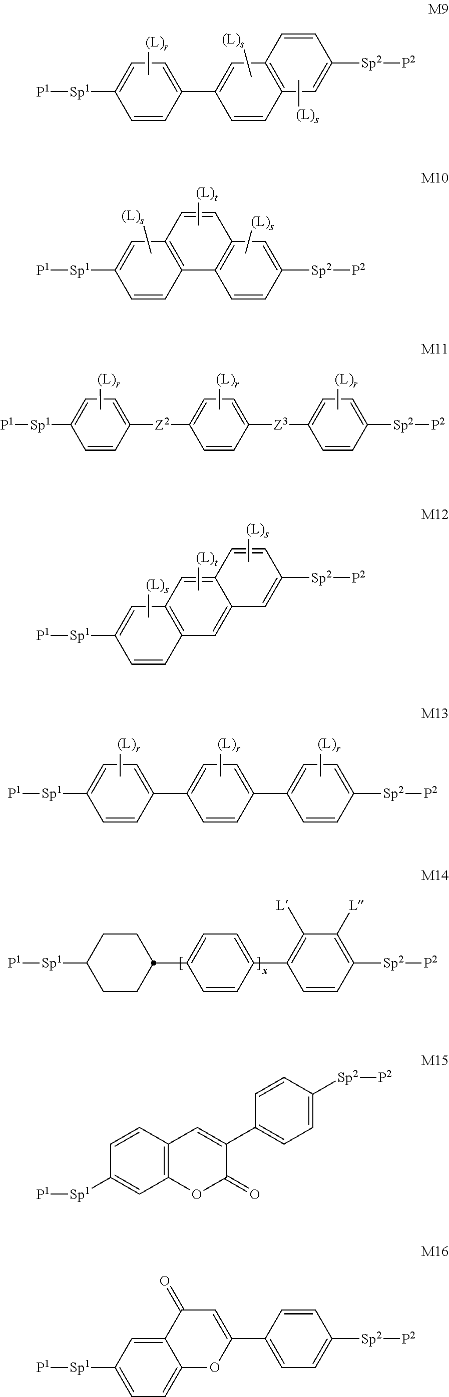

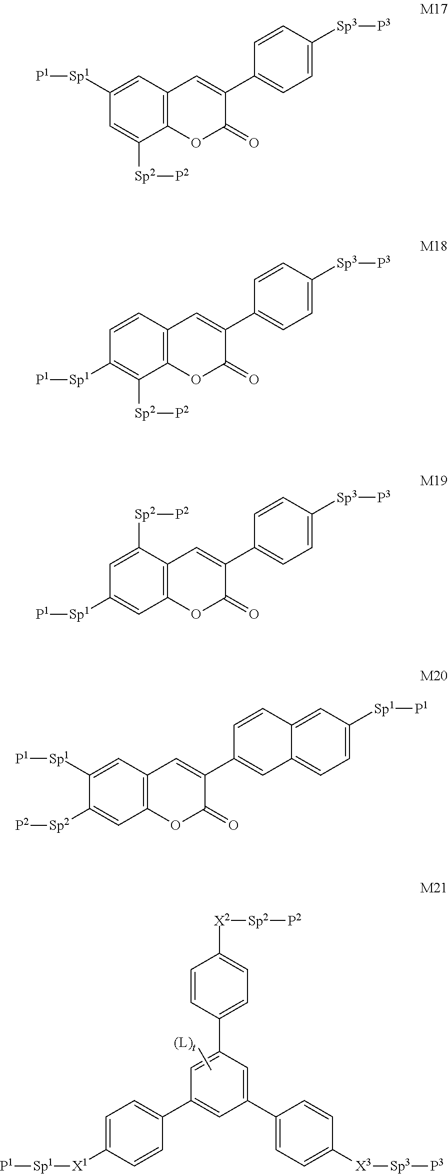

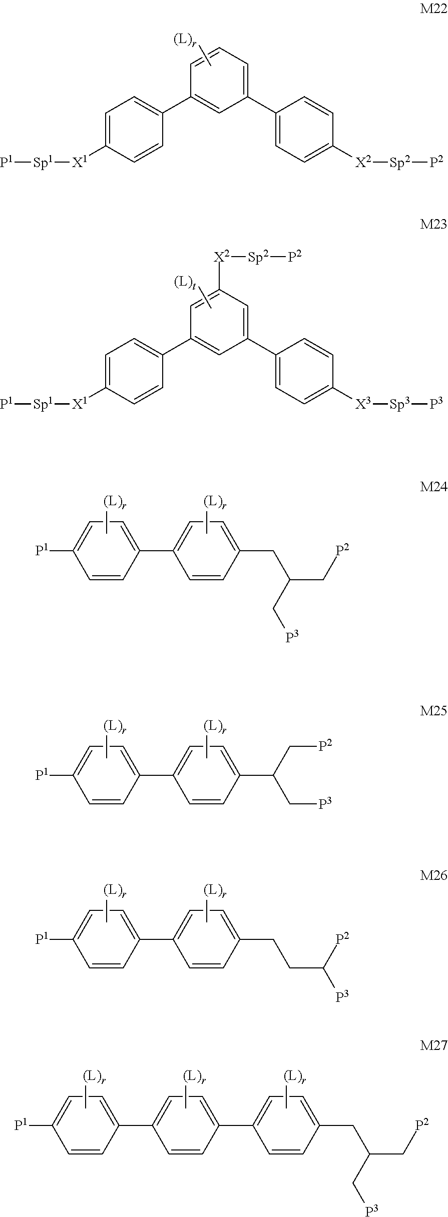

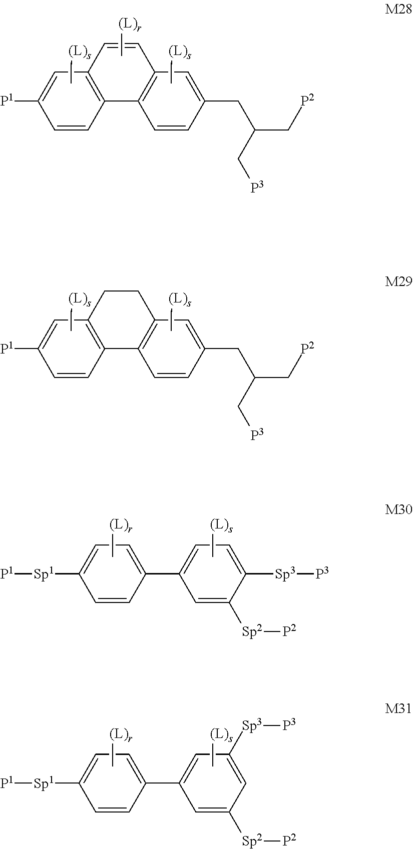

in which the individual radicals have the following meanings:
P¹, P² and P³ each, independently of one another, denote an acrylate or methacrylate group,
Sp¹, Sp² and Sp³ each, independently of one another, denote a single bond or a spacer group having one of the meanings indicated above for Sp, and particularly preferably denote —(CH₂)ₚ₁—, —(CH₂)ₚ₁—O—, —(CH₂)ₚ₁—CO—O—, —(CH₂)ₚ₁—O—CO— or —(CH₂)ₚ₁—O—CO—, in which p1 is an integer from 1 to 12, where, in addition, one or more of the radicals P¹-Sp¹-, P²-Sp²- and P³-Sp³- may denote R^{aa}, with the proviso that at least one of the radicals P¹-Sp¹-, P²-Sp² and P³-Sp³- present is different from R^{aa},
R^{aa} denotes H, F, Cl, CN or straight-chain or branched alkyl having 1 to 25 C atoms, in which, in addition, one or more non-adjacent CH₂ groups may each be replaced, independently of one another, by C(R⁰)═C(R⁰⁰)—, —C≡C—, —N(R⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, CN or P¹-Sp¹-, particularly preferably straight-chain or branched, optionally mono- or polyfluorinated alkyl, alkoxy, alkenyl, alkynyl, alkylcarbonyl, alkoxycarbonyl, alkylcarbonyloxy or alkoxycarbonyloxy having 1 to 12 C atoms (where the alkenyl and alkynyl radicals have at least two C atoms and the branched radicals have at least three C atoms),
R⁰, R⁰⁰ each, independently of one another and identically or differently on each occurrence, denote H or alkyl having 1 to 12 C atoms,
R^{y} and R^{z} each, independently of one another, denote H, F, CH₃ or CF₃,
X¹, X² and X³ each, independently of one another, denote —CO—O—, —O—CO— or a single bond,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ—, where n is 2, 3 or 4,
L on each occurrence, identically or differently, denotes F, Cl, CN or straight-chain or branched, optionally mono- or poly-fluorinated alkyl, alkoxy, alkenyl, alkynyl, alkylcarbonyl, alkoxycarbonyl, alkylcarbonyloxy or alkoxycarbonyloxy having 1 to 12 C atoms, preferably F,
L′ and L″ each, independently of one another, denote H, F or Cl,
r denotes 0, 1, 2, 3 or 4,
s denotes 0, 1, 2 or 3,
t denotes 0, 1 or 2,
x denotes 0 or 1.

Especially preferred are compounds of formulae M2, M13, M17, M23 and M29.

Further preferred are trireactive compounds M15 to M31, in particular M17, M18, M19, M23, M24, M25, M29 and M30.

In the compounds of formulae M1 to M31 the group

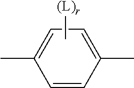

is preferably

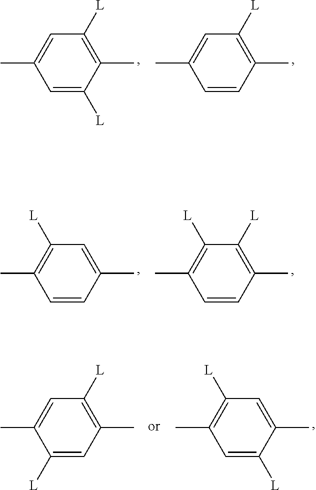

wherein L on each occurrence, identically or differently, has one of the meanings given above or below, and is preferably F, Cl, CN, NO₂, CH₃, C₂H₅, C(CH₃)₃, CH(CH₃)₂, CH₂CH(CH₃)C₂H₅, OCH₃, OC₂H₅, COCH₃, COC₂H₅, COOCH₃, COOC₂H₅, CF₃, OCF₃, OCHF₂, OC₂F₅ or P-Sp-, very preferably F, Cl, CN, CH₃, C₂H₅, OCH₃, COCH₃, OCF₃ or P-Sp-, more preferably F, Cl, CH₃, OCH₃, COCH₃ or OCF₃, especially F or CH₃.

Further preferred stabilisers are chiral compounds selected from formula II:

(R*—(B¹—Z¹)ₘ₁)ₖ-Q II

in which B¹, Z¹ and m1 have on each occurrence, identically or differently, one of the meanings indicated in formula I,
R* on each occurrence, identically or differently, has one of the meanings indicated for R^{a} in formula I,
Q denotes a k-valent chiral group, which is optionally mono- or polysubstituted by L,
k is 1, 2, 3, 4, 5 or 6,

where the compounds contain at least one radical R* or L which denotes or contains a group P-Sp- as defined above.

Particularly preferred compounds of the formula II contain a monovalent group Q of the formula III

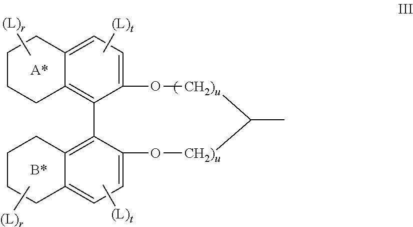

in which L and r have on each occurrence, identically or differently, the meanings indicated above,
A* and B* each, independently of one another, denote fused benzene, cyclohexane or cyclohexene,
t on each occurrence, identically or differently, denotes 0, 1 or 2, and
u on each occurrence, identically or differently, denotes 0, 1 or 2.

Particular preference is given to groups of the formula III in which x denotes 1 or 2.

Further preferred compounds of the formula II contain a monovalent group Q or one or more groups R* of the formula IV

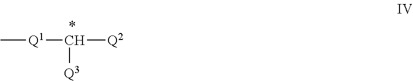

in which
Q¹ denotes alkylene or alkyleneoxy having 1 to 9 C atoms or a single bond,
Q² denotes optionally fluorinated alkyl or alkoxy having 1 to 10 C atoms, in which, in addition, one or two non-adjacent CH₂ groups may be replaced by —O—, —S—, —CH═CH—, —CO—, —OCO—, —COO—, —O—COO—, —S—CO—, —CO—S— or —C≡C— in such a way that O and/or S atoms are not linked directly to one another,
Q³ denotes F, Cl, CN or alkyl or alkoxy as defined for Q², but different from Q².

Preferred groups of the formula IV are, for example, 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa-4-methylpentyl, 4-methylhexyl, 2-hexyl, 2-octyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleroyloxy, 4-methylhexanoyloxy, 2-chloropropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, 1,1,1-trifluoro-2-octyloxy, 1,1,1-trifluoro-2-octyl, 2-fluoro-methyloctyloxy.

Further preferred compounds of the formula II contain a divalent group Q of the formula V

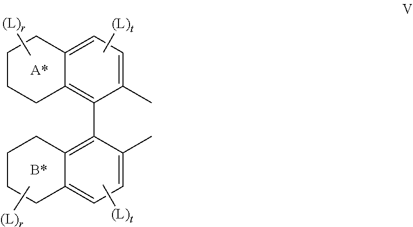

in which L, r, t, A* and B* have the meanings indicated above.

Further preferred compounds of the formula II contain a divalent group Q selected from the following formulae:

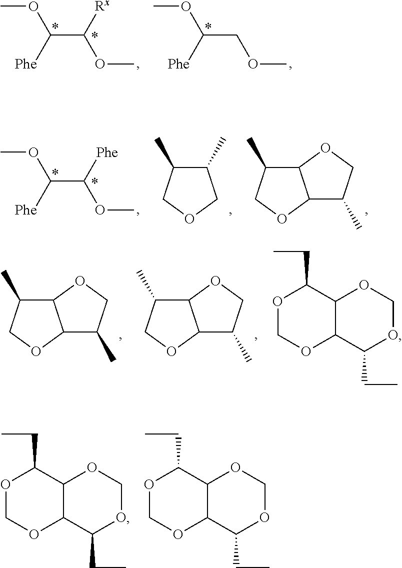

in which Phe denotes phenyl, which is optionally mono- or polysubstituted by L, and R^{x} denotes F or optionally fluorinated alkyl having 1 to 4 C atoms.

Particularly preferred compounds of the formula II are selected from the following sub-formulae:

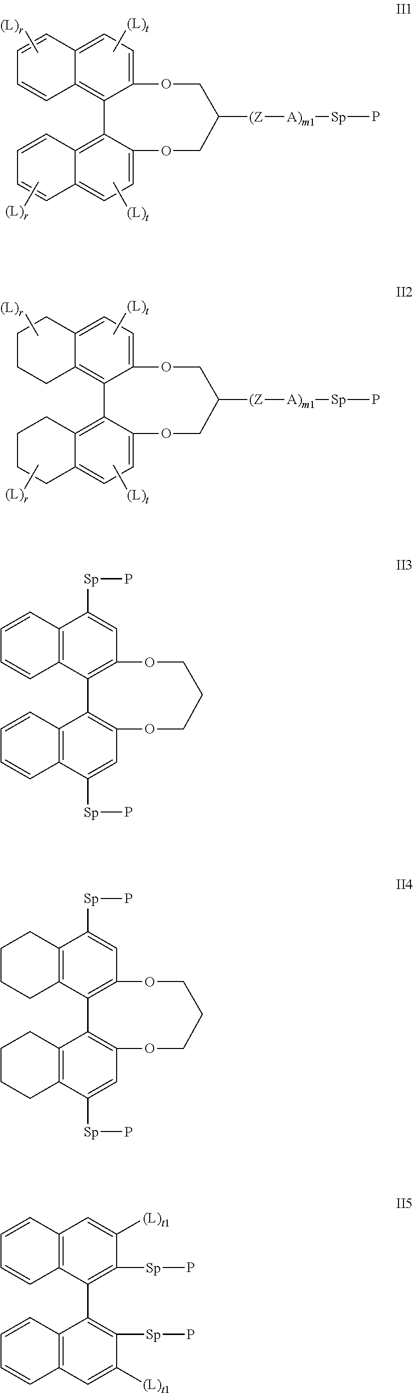

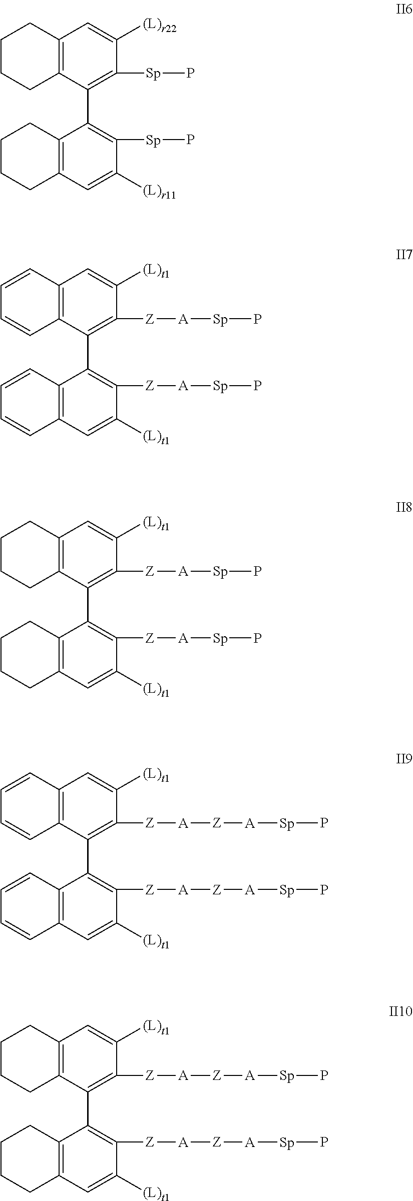

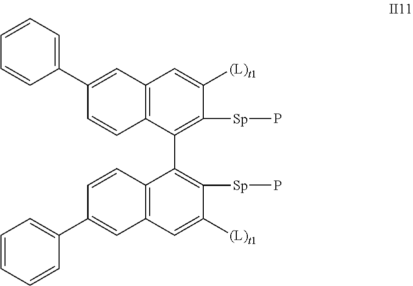

in which L, P, Sp, m1, r and t have the meanings indicated above, Z and A have on each occurrence, identically or differently, one of the meanings indicated for Z¹ and A¹ respectively, and t1 on each occurrence, identically or differently, denotes 0 or 1.

The chiral compounds of formula II can be employed either in optically active form, i.e. as pure enantiomers, or as any desired mixture of the two enantiomers, or as the racemate thereof. The use of the racemates is preferred. The use of the racemates has some advantages over the use of pure enantiomers, such as, for example, significantly more straightforward synthesis and lower material costs.

The LC media for use in the LC displays according to the invention comprise an LC mixture (“host mixture”) comprising one or more, preferably two or more mesogenic compounds and one or more compounds selected from stabilisers of formulae I, II and Ill described above.

The LC host mixture is preferably a nematic LC mixture, and preferably does not have a chiral LC phase.

The LC medium preferably contains an LC host mixture based on compounds with negative dielectric anisotropy. Particularly preferred embodiments of such an LC medium, and the corresponding LC host mixture, are those of sections a)-z) below:
a) LC medium which comprises one or more compounds of the formulae CY and/or PY:

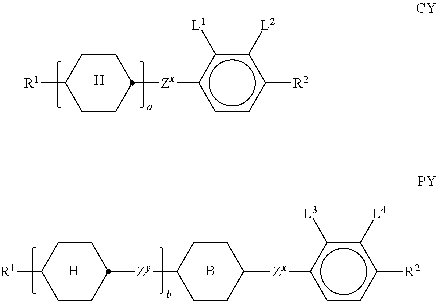

wherein
   a denotes 1 or 2,
   b denotes 0 or 1,

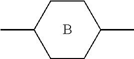

denotes

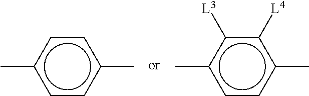

R¹ and R² each, independently of one another, denote alkyl having 1 to 12 C atoms, where, in addition, one or two non-adjacent CH₂ groups may be replaced by —O—, —CH═CH—, —CO—, —OCO— or —COO— in such a way that O atoms are not linked directly to one another, preferably alkyl or alkoxy having 1 to 6 C atoms,
   Z^{x} and Z^{y} each, independently of one another, denote —CH₂CH₂—, —CH═CH—, —CF₂O—, —OCF₂—, —CH₂O—, —OCH₂—, —CO—O—, —O—CO—, —C₂F₄—, —CF═CF—, —CH═CH—CH₂O— or a single bond, preferably a single bond,
   L¹⁻⁴ each, independently of one another, denote F, Cl, OCF₃, CF₃, CH₃, CH₂F, CHF₂.
   Preferably, both L¹ and L² denote F or one of L¹ and L² denotes F and the other denotes Cl, or both L³ and L⁴ denote F or one of L³ and L⁴ denotes F and the other denotes Cl.
   The compounds of the formula CY are preferably selected from the group consisting of the following sub-formulae:

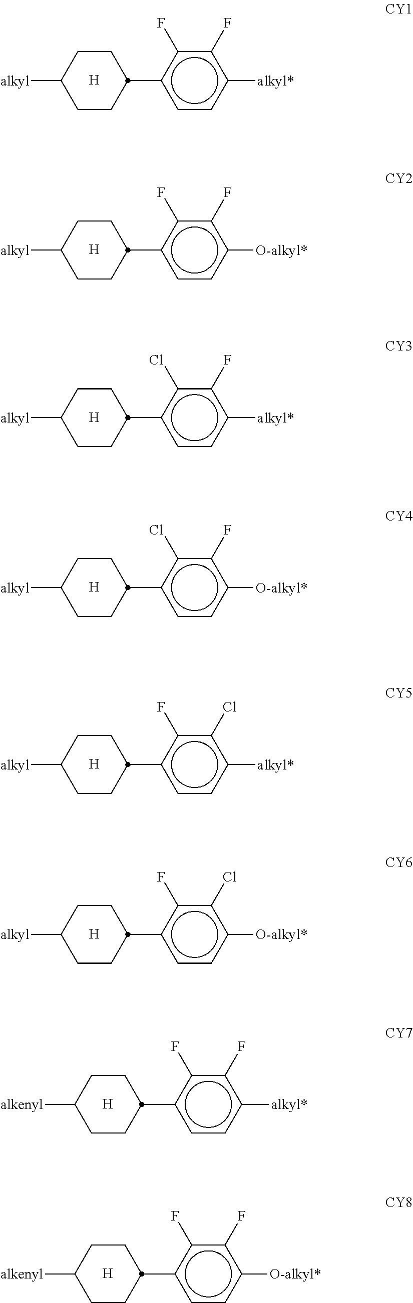

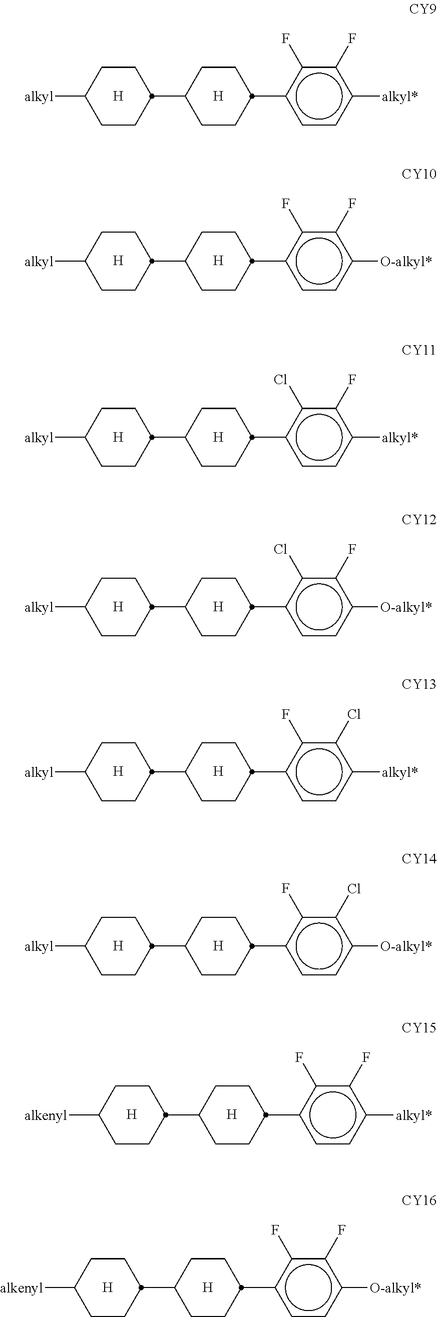

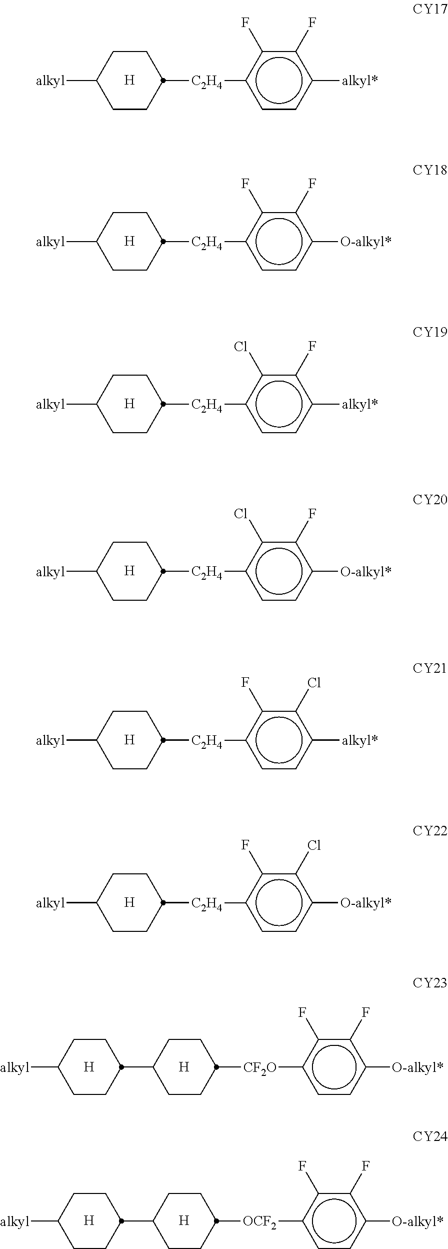

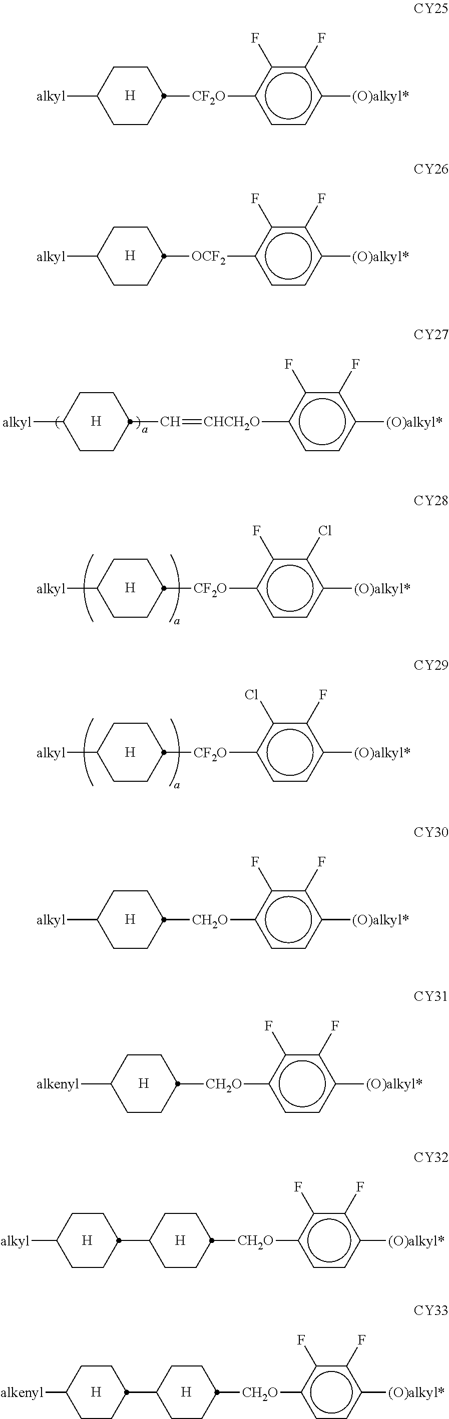

in which a denotes 1 or 2, alkyl and alkyl* each, independently of one another, denote a straight-chain alkyl radical having 1-6 C atoms, and alkenyl denotes a straight-chain alkenyl radical having 2-6 C atoms, and (O) denotes an oxygen atom or a single bond. Alkenyl preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   The compounds of the formula PY are preferably selected from the group consisting of the following sub-formulae:

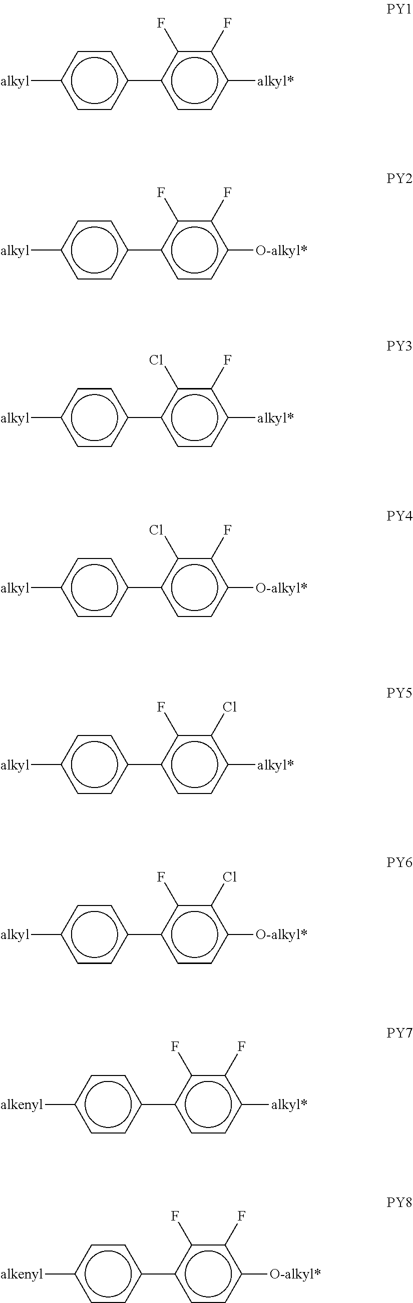

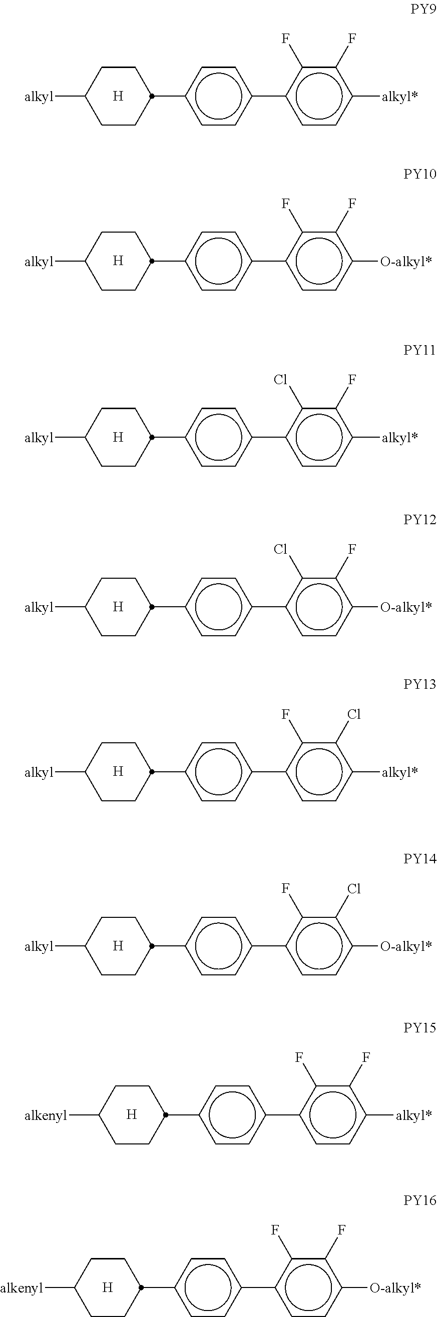

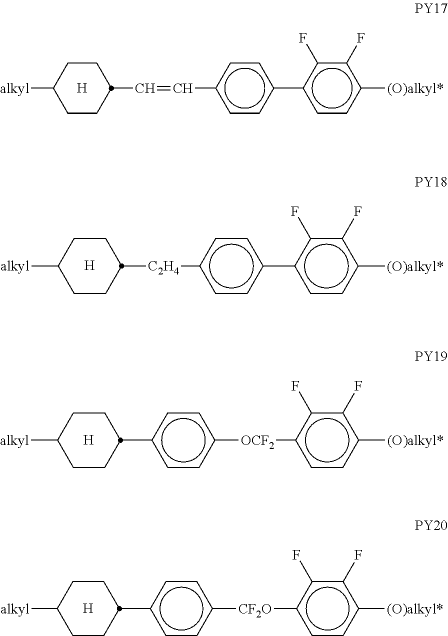

in which alkyl and alkyl* each, independently of one another, denote a straight-chain alkyl radical having 1-6 C atoms, and alkenyl denotes a straight-chain alkenyl radical having 2-6 C atoms, and (O) denotes an oxygen atom or a single bond. Alkenyl preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
b) LC medium which additionally comprises one or more compounds of the following formula:

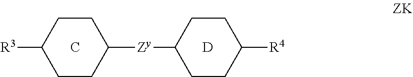

in which the individual radicals have the following meanings:

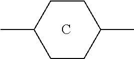

denotes

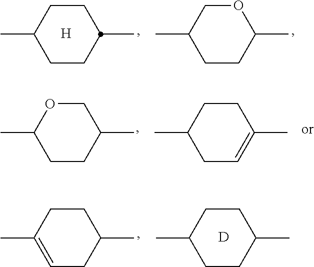

denotes

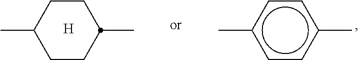

R³ and R⁴ each, independently of one another, denote alkyl having 1 to 12 C atoms, in which, in addition, one or two non-adjacent CH₂ groups may be replaced by —O—, —CH═CH—, —CO—, —O—CO— or —CO—O— in such a way that O atoms are not linked directly to one another,
   Z^{y} denotes —CH₂CH₂—, —CH═CH—, —CF₂O—, —OCF₂—, —CH₂O—, —OCH₂—, —CO—O—, —O—CO—, —C₂F₄—, —CF═CF—, —CH═CH—CH₂O— or a single bond, preferably a single bond.
   The compounds of the formula ZK are preferably selected from the group consisting of the following sub-formulae:

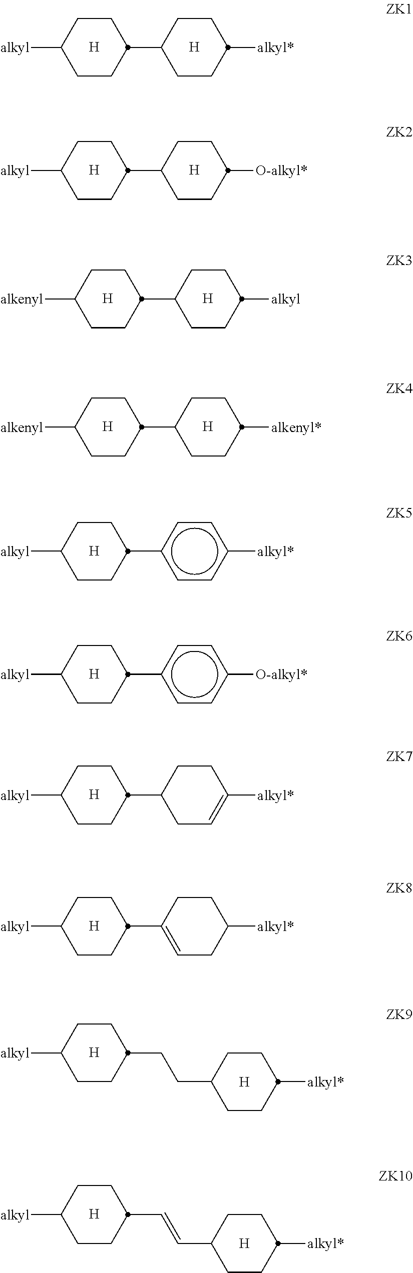

in which alkyl and alkyl* each, independently of one another, denote a straight-chain alkyl radical having 1-6 C atoms, and alkenyl denotes a straight-chain alkenyl radical having 2-6 C atoms. Alkenyl preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   Especially preferred are compounds of formula ZK1 and ZK3.
   Particularly preferred compounds of formula ZK are selected from the following sub-formulae:

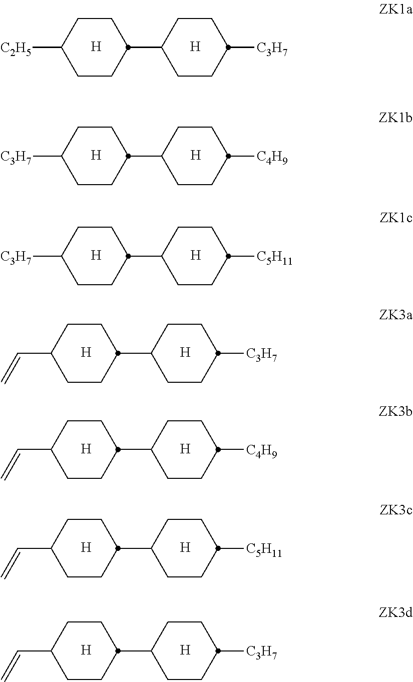

wherein the propyl, butyl and pentyl groups are straight-chain groups.
   Most preferred are compounds of formula ZK1a and ZK3a.
c) LC medium which additionally comprises one or more compounds of the following formula:

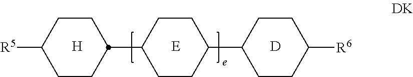

in which the individual radicals on each occurrence, identically or differently, have the following meanings:
   R⁵ and R⁶ each, independently of one another, denote alkyl having 1 to 12 C atoms, where, in addition, one or two non-adjacent CH₂ groups may be replaced
      by —O—, —CH═CH—, —CO—, —COO— or —COO— in such a way that O atoms are not linked directly to one another, preferably alkyl or alkoxy having 1 to 6 C atoms,

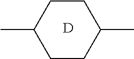

denotes

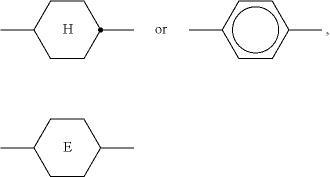

denotes

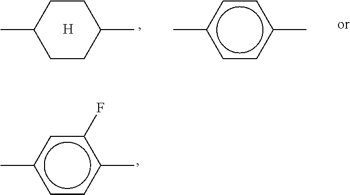

e denotes 1 or 2.
The compounds of the formula DK are preferably selected from the group consisting of the following sub-formulae:

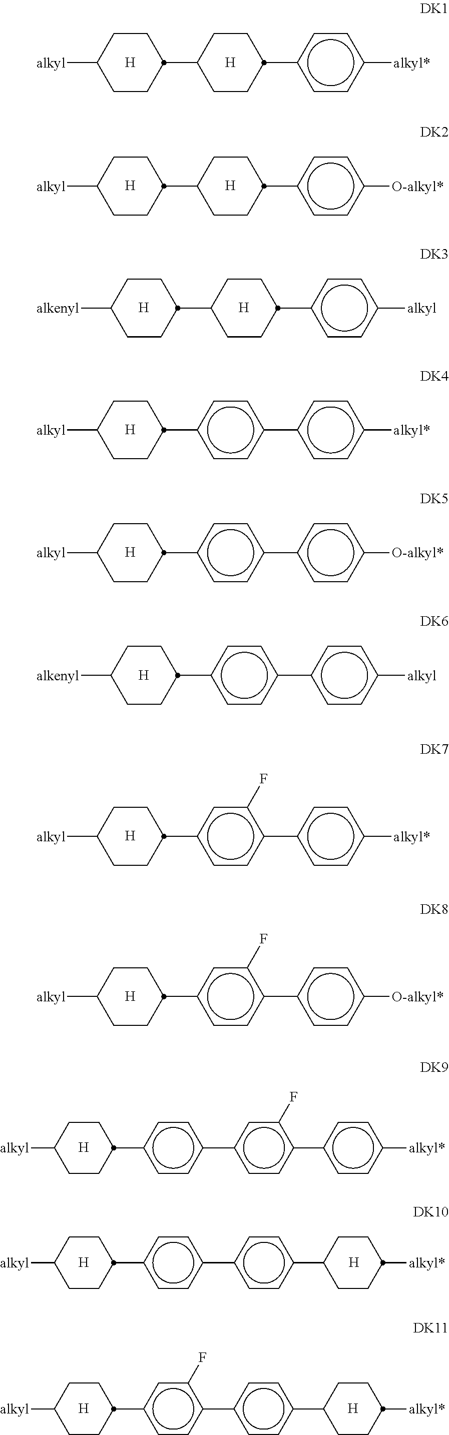

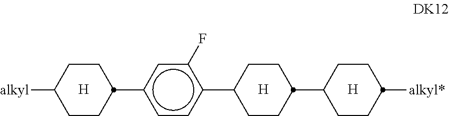

in which alkyl and alkyl* each, independently of one another, denote a straight-chain alkyl radical having 1-6 C atoms, and alkenyl denotes a straight-chain alkenyl radical having 2-6 C atoms. Alkenyl preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
d) LC medium which additionally comprises one or more compounds of the following formula:

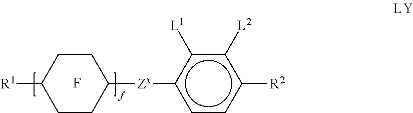

in which the individual radicals have the following meanings:

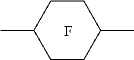

denotes

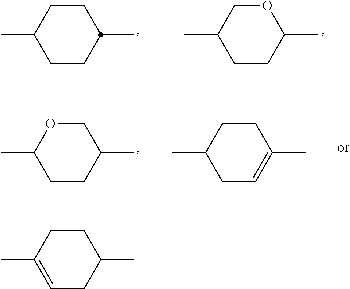

with at least one ring F being different from cyclohexylene,
f denotes 1 or 2,
   R¹ and R² each, independently of one another, denote alkyl having 1 to 12 C atoms, where, in addition, one or two non-adjacent CH₂ groups may be replaced by —O—, —CH═CH—, —CO—, —OCO— or —COO— in such a way that O atoms are not linked directly to one another,
   Z^{x} denotes —CH₂CH₂—, —CH═CH—, —CF₂O—, —OCF₂—, —CH₂O—, —OCH₂—, —CO—O—, —O—CO—, —C₂F₄—, —CF═CF—, —CH═CH—CH₂O— or a single bond, preferably a single bond,
   L¹ and L² each, independently of one another, denote F, Cl, OCF₃, CF₃, CH₃, CH₂F, CHF₂.
   Preferably, both radicals L¹ and L² denote F or one of the radicals L¹ and L² denotes F and the other denotes Cl.
   The compounds of the formula LY are preferably selected from the group consisting of the following sub-formulae:

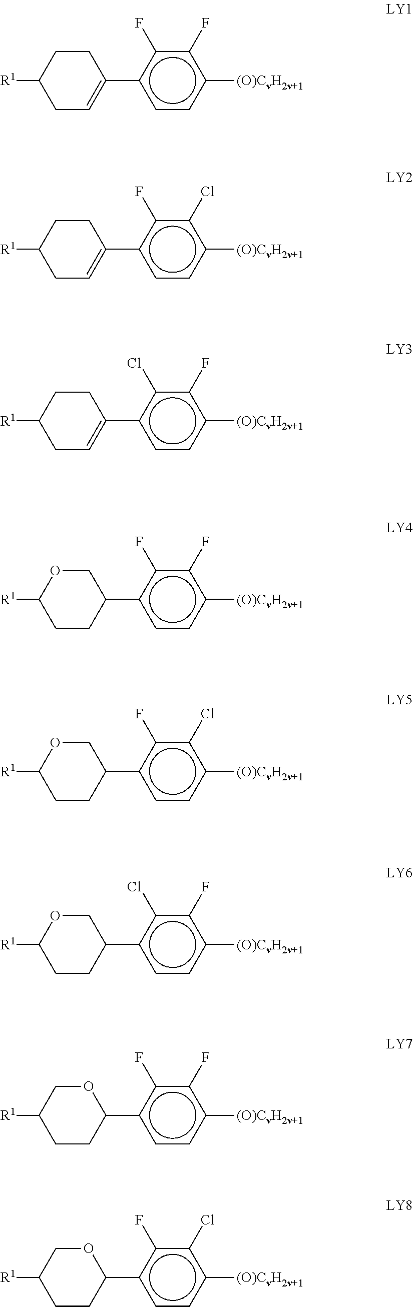

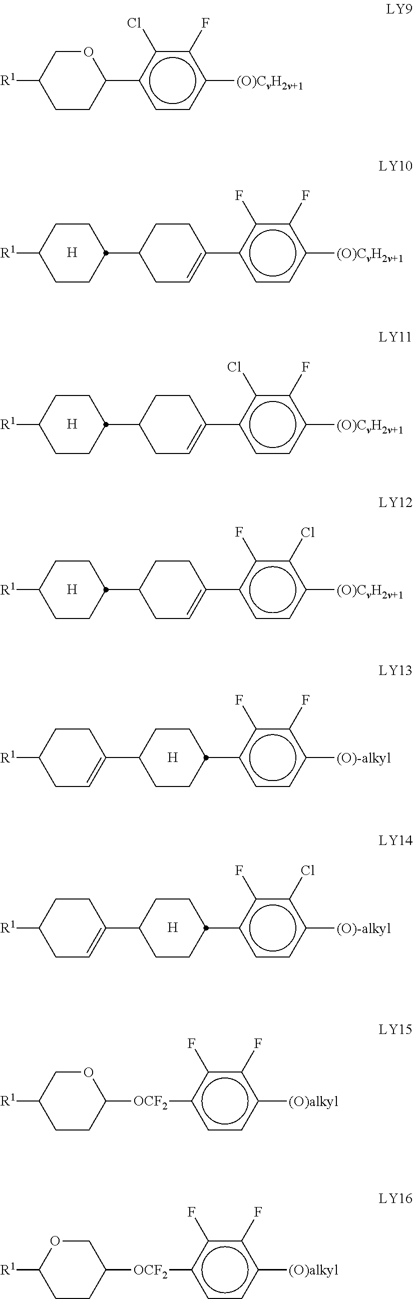

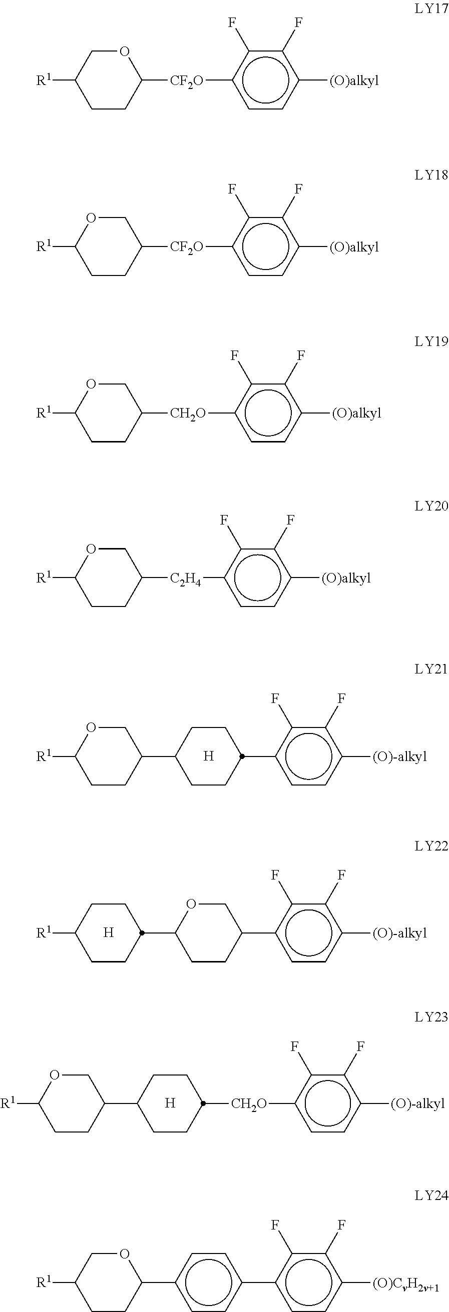

in which R¹ has the meaning indicated above, alkyl denotes a straight-chain alkyl radical having 1-6 C atoms, (O) denotes an oxygen atom or a single bond, and v denotes an integer from 1 to 6. R¹ preferably denotes straight-chain alkyl having 1 to 6 C atoms or straight-chain alkenyl having 2 to 6 C atoms, in particular CH₃, C₂H₅, n-C₃H₇, n-C₄H₉, n-C₅H₁₁, CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
e) LC medium which additionally comprises one or more compounds selected from the group consisting of the following formulae:

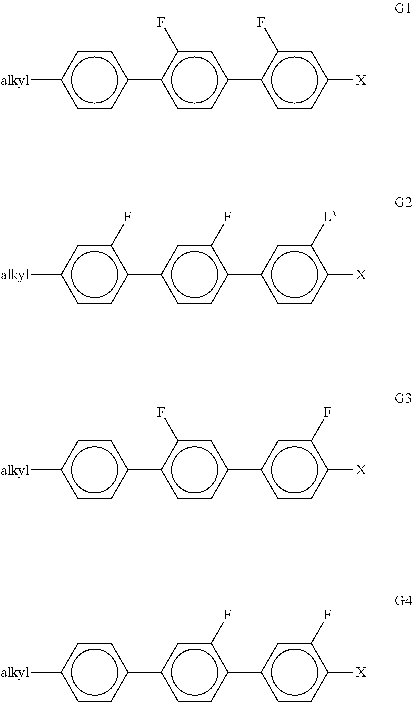

in which alkyl denotes C₁₋₆-alkyl, L^{x} denotes H or F, and X denotes F, Cl, OCF₃, OCHF₂ or OCH═CF₂. Particular preference is given to compounds of the formula G1 in which X denotes F.
f) LC medium which additionally comprises one or more compounds selected from the group consisting of the following formulae:

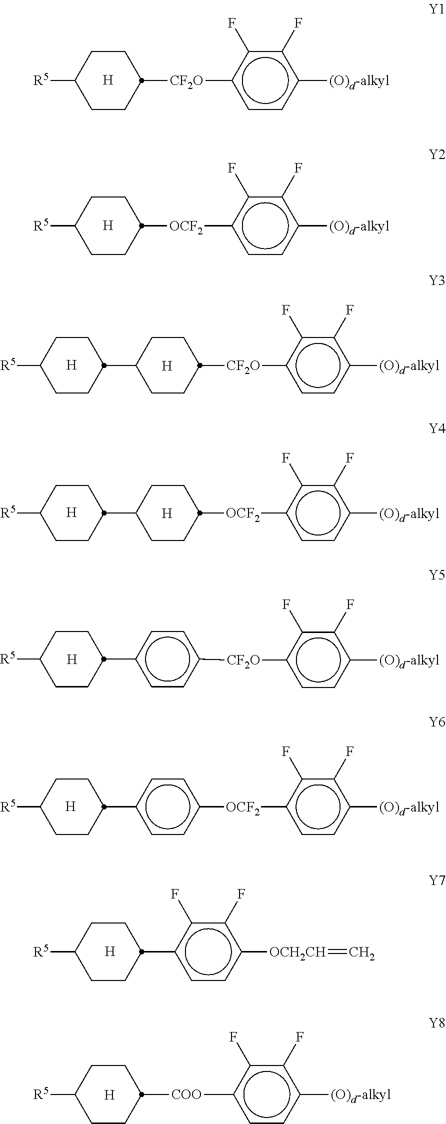

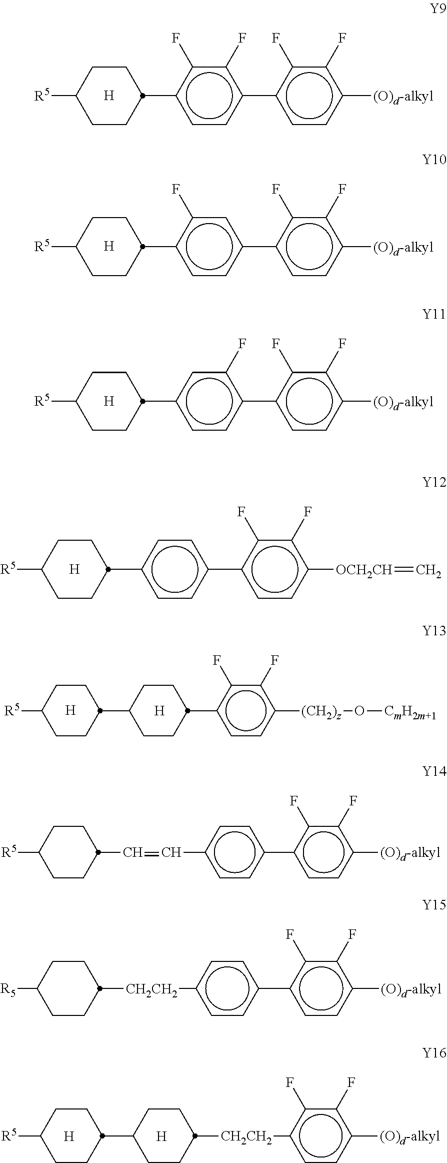

in which R⁵ has one of the meanings indicated above for R¹, alkyl denotes C₁₋₆-alkyl, d denotes 0 or 1, and z and m each, independently of one another, denote an integer from 1 to 6. R⁵ in these compounds is particularly preferably C₁₋₆-alkyl or -alkoxy or C₂₋₆-alkenyl, d is preferably 1. The LC medium according to the invention preferably comprises one or more compounds of the above-mentioned formulae in amounts of 5% by weight.
g) LC medium which additionally comprises one or more biphenyl compounds selected from the group consisting of the following formulae:

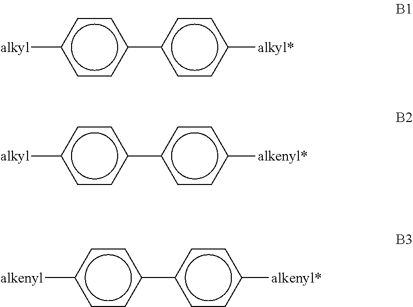

in which alkyl and alkyl* each, independently of one another, denote a straight-chain alkyl radical having 1-6 C atoms, and alkenyl and alkenyl* each, independently of one another, denote a straight-chain alkenyl radical having 2-6 C atoms. Alkenyl and alkenyl* preferably denote CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   The proportion of the biphenyls of the formulae B1 to B3 in the LC mixture is preferably at least 3% by weight, in particular ≥5% by weight.
   The compounds of the formula B2 are particularly preferred.
   The compounds of the formulae B1 to B3 are preferably selected from the group consisting of the following sub-formulae:

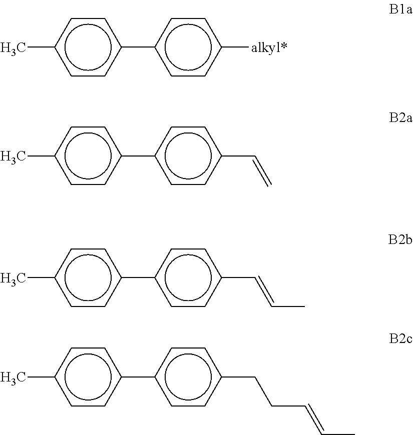

in which alkyl* denotes an alkyl radical having 1-6 C atoms. The medium according to the invention particularly preferably comprises one or more compounds of the formulae B1a and/or B2c.
h) LC medium which additionally comprises one or more terphenyl compounds of the following formula:

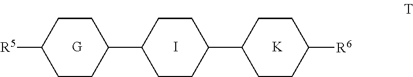

in which R⁵ and R⁶ each, independently of one another, have one of the meanings indicated above, and

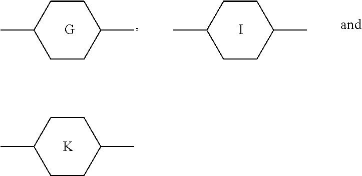

each, independently of one another, denote

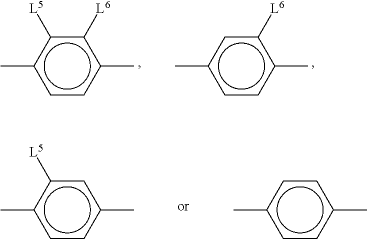

in which L⁵ denotes F or Cl, preferably F, and L⁶ denotes F, Cl, OCF₃, CF₃, CH₃, CH₂F or CHF₂, preferably F.
   The compounds of the formula T are preferably selected from the group consisting of the following sub-formulae:

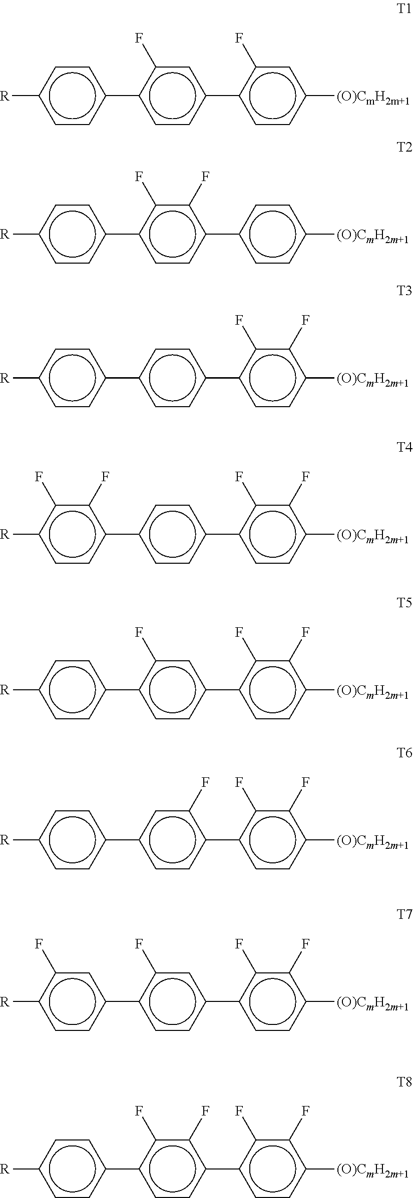

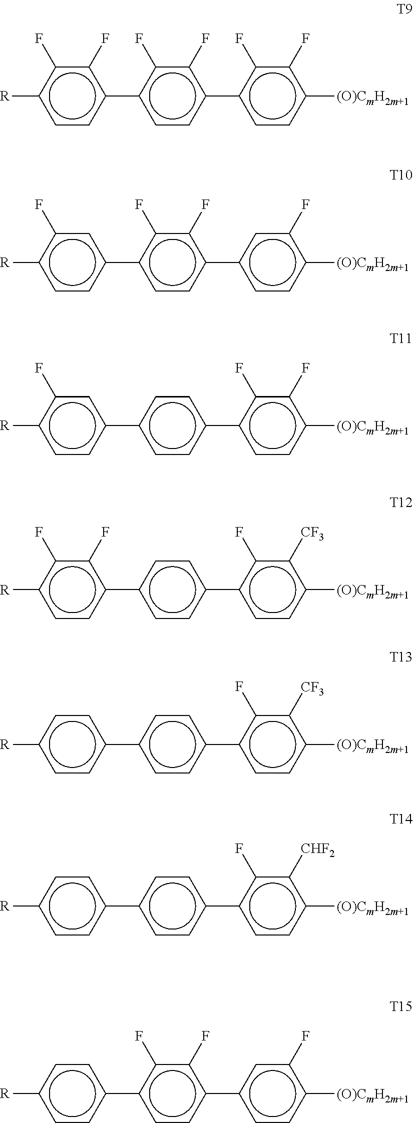

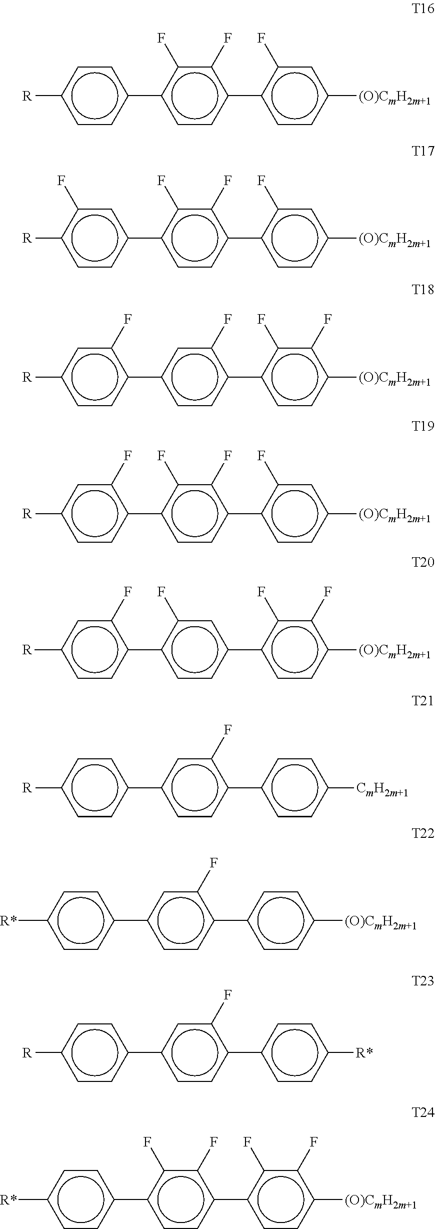

in which R denotes a straight-chain alkyl or alkoxy radical having 1-7 C atoms, R* denotes a straight-chain alkenyl radical having 2-7 C atoms, (O) denotes an oxygen atom or a single bond, and m denotes an integer from 1 to 6. R* preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   R preferably denotes methyl, ethyl, propyl, butyl, pentyl, hexyl, methoxy, ethoxy, propoxy, butoxy or pentoxy.
   The LC medium according to the invention preferably comprises the terphenyls of the formula T and the preferred sub-formulae thereof in an amount of 0.5-30% by weight, in particular 1-20% by weight.
   Particular preference is given to compounds of the formulae T1, T2, T3 and T21. In these compounds, R preferably denotes alkyl, furthermore alkoxy, each having 1-5 C atoms.
   The terphenyls are preferably employed in mixtures according to the invention if the Δn value of the mixture is to be ≥0.1. Preferred mixtures comprise 2-20% by weight of one or more terphenyl compounds of the formula T, preferably selected from the group of compounds T1 to T22.
i) LC medium which additionally comprises one or more compounds selected from the group consisting of the following formulae:

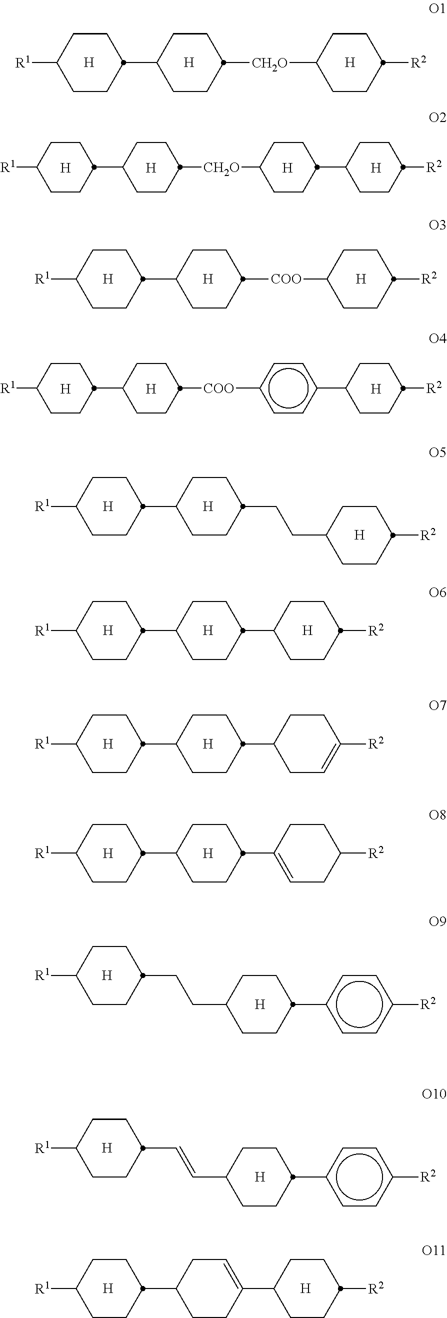

in which R¹ and R² have the meanings indicated above and preferably each, independently of one another, denote straight-chain alkyl having 1 to 6 C atoms or straight-chain alkenyl having 2 to 6 C atoms.
   Preferred media comprise one or more compounds selected from the formulae O1, O3 and O4.
k) LC medium which additionally comprises one or more compounds of the following formula:

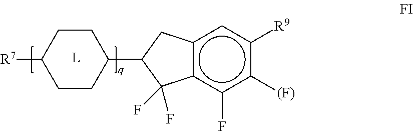

in which

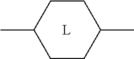

denotes

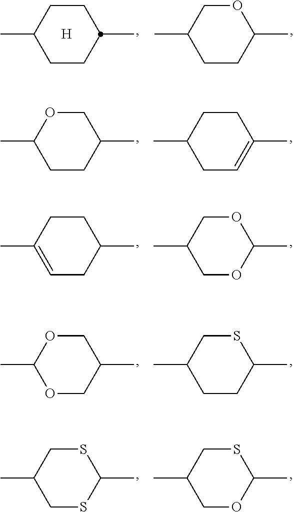

R⁹ denotes H, CH₃, C₂H₅ or n-C₃H₇, (F) denotes an optional fluorine substituent, and q denotes 1, 2 or 3, and R⁷ has one of the meanings indicated for R¹, preferably in amounts of >3% by weight, in particular ≥5% by weight and very particularly preferably 5-30% by weight.
   Particularly preferred compounds of the formula Fl are selected from the group consisting of the following sub-formulae:

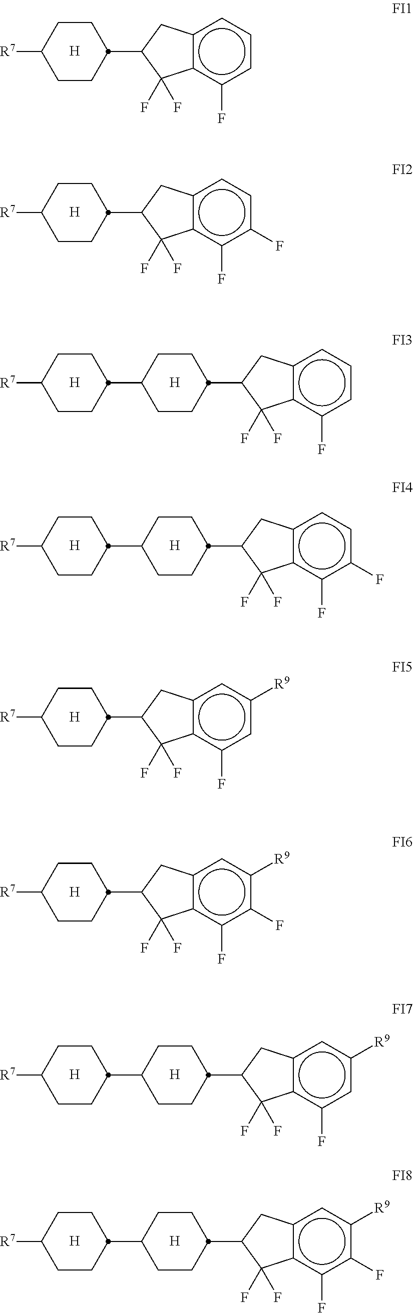

in which R⁷ preferably denotes straight-chain alkyl, and R⁹ denotes CH₃, C₂H₅ or n-C₃H₇. Particular preference is given to the compounds of the formulae FI1, FI2 and FI3.
l) LC medium which additionally comprises one or more compounds selected from the group consisting of the following formulae:

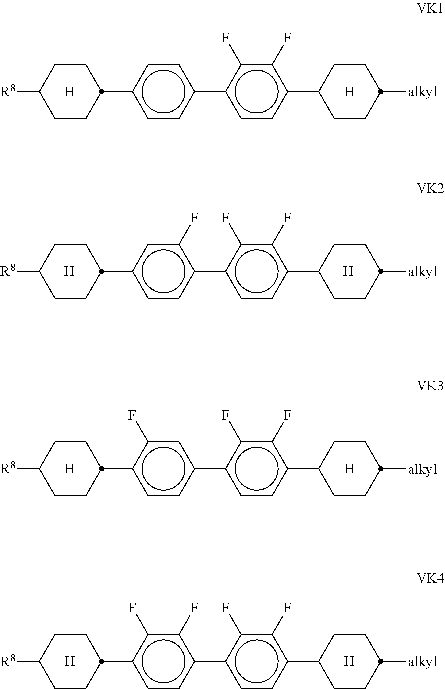

in which R⁸ has the meaning indicated for R¹, and alkyl denotes a straight-chain alkyl radical having 1-6 C atoms.
m) LC medium which additionally comprises one or more compounds which contain a tetrahydronaphthyl or naphthyl unit, such as, for example, the compounds selected from the group consisting of the following formulae:

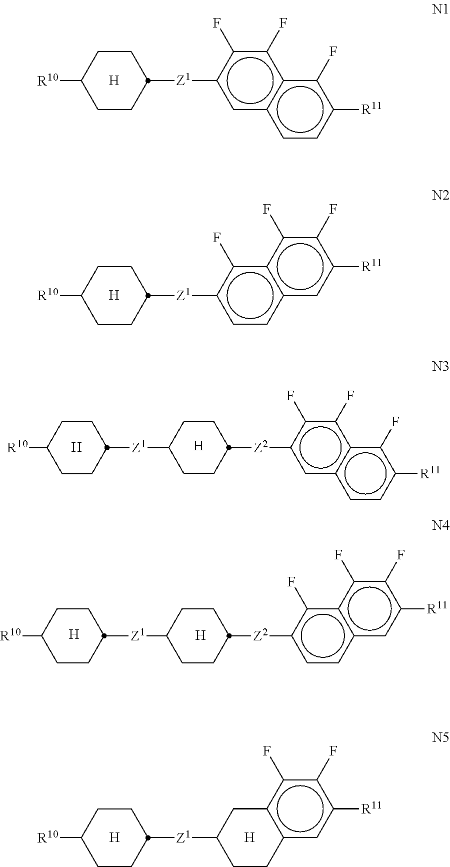

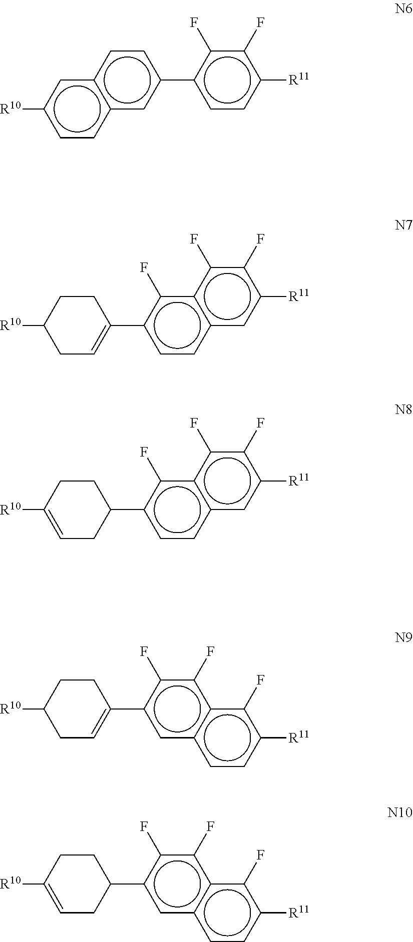

in which
   R¹⁰ and R¹¹ each, independently of one another, denote alkyl having 1 to 12 C atoms, where, in addition, one or two non-adjacent CH₂ groups may be replaced
      by —O—, —CH═CH—, —CO—, —OCO— or —COO— in such a way that O atoms are not linked directly to one another, preferably alkyl or alkoxy having 1 to 6 C atoms,
   and R¹⁰ and R¹¹ preferably denote straight-chain alkyl or alkoxy having 1 to 6 C atoms or straight-chain alkenyl having 2 to 6 C atoms, and
   Z¹ and Z² each, independently of one another, denote —C₂H₄—, —CH═CH—, —(CH₂)₄—, —(CH₂)₃O—, —O(CH₂)₃—, —CH═CH—
      CH₂CH₂—, —CH₂CH₂CH═CH—, —CH₂O—, —OCH₂—, —CO—O—, —O—CO—, —C₂F₄—, —CF═CF—, —CF═CH—, —CH═CF—, —CH₂— or a single bond.
n) LC medium which additionally comprises one or more difluorodibenzopyrans and/or chromans of the following formulae:

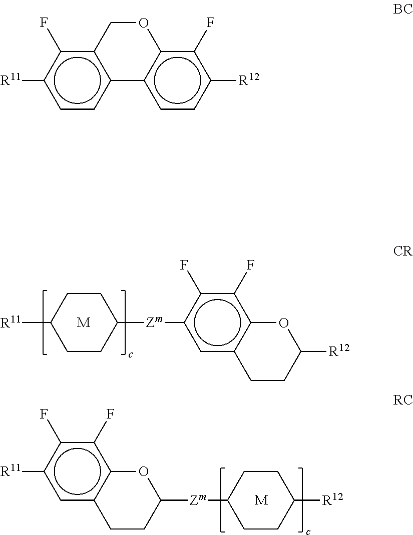

in which
   R¹¹ and R¹² each, independently of one another, have one of the meanings indicated above for R¹¹,
   ring M is trans-1,4-cyclohexylene or 1,4-phenylene,
   Z^{m} —C₂H₄—, —CH₂O—, —OCH₂—, —CO—O— or —O—CO—,
   c is 0, 1 or 2,
   preferably in amounts of 3 to 20% by weight, in particular in amounts of 3 to 15% by weight.
   Particularly preferred compounds of the formulae BC, CR and RC are selected from the group consisting of the following sub-formulae:

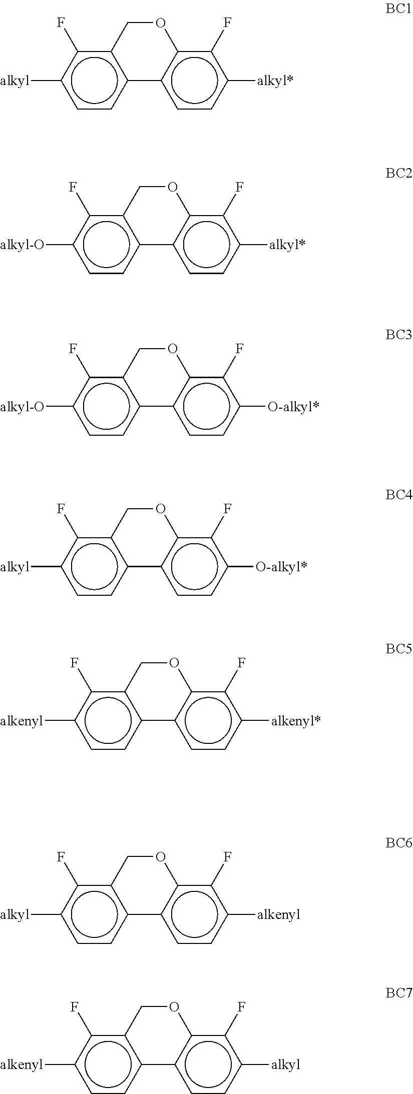

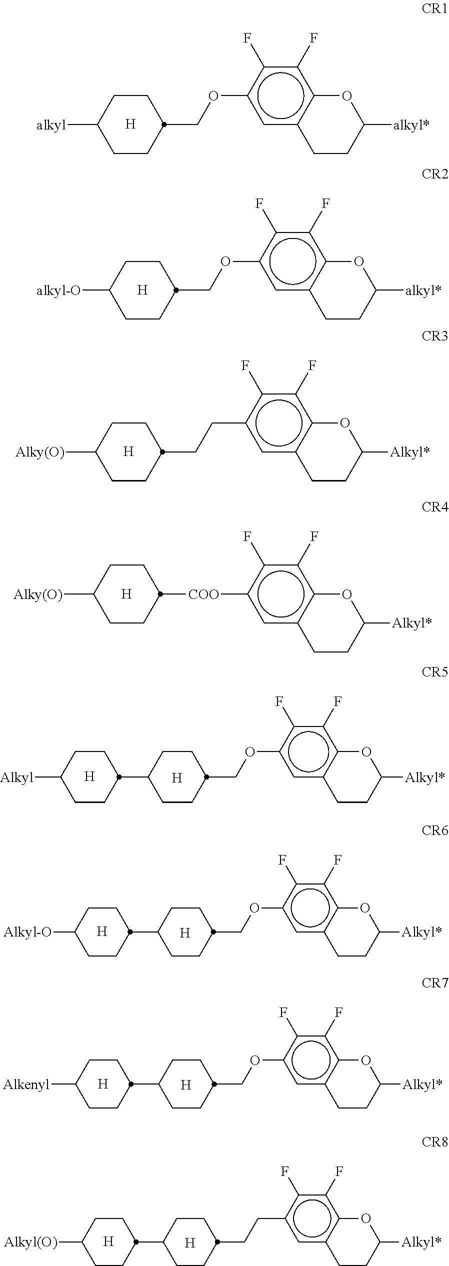

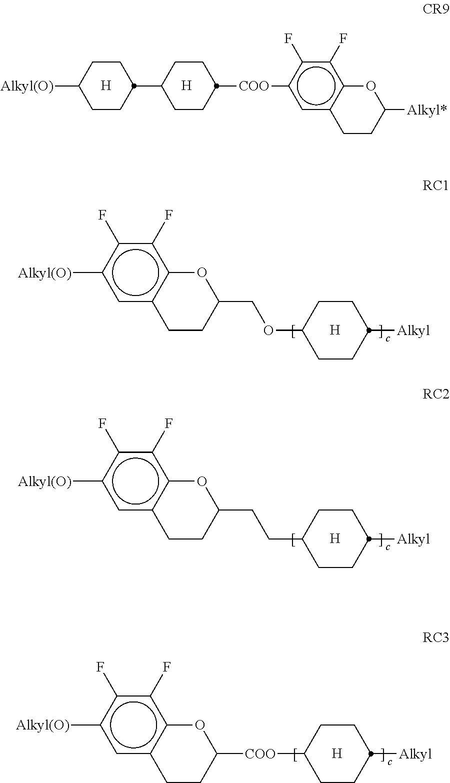

in which alkyl and alkyl* each, independently of one another, denote a straight-chain alkyl radical having 1-6 C atoms, (O) denotes an oxygen atom or a single bond, c is 1 or 2, and alkenyl and alkenyl* each, independently of one another, denote a straight-chain alkenyl radical having 2-6 C atoms. Alkenyl and alkenyl* preferably denote CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   Very particular preference is given to mixtures comprising one, two or three compounds of the formula BC-2.
o) LC medium which additionally comprises one or more fluorinated phenanthrenes and/or dibenzofurans of the following formulae:

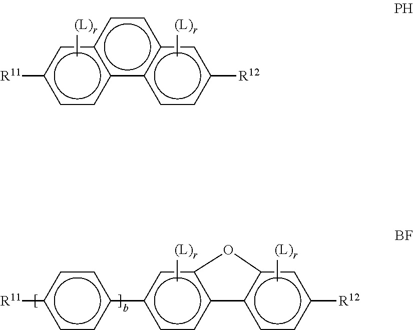

in which R¹¹ and R¹² each, independently of one another, have one of the meanings indicated above for R¹¹, b denotes 0 or 1, L denotes F, and r denotes 1, 2 or 3.
   Particularly preferred compounds of the formulae PH and BF are selected from the group consisting of the following sub-formulae:

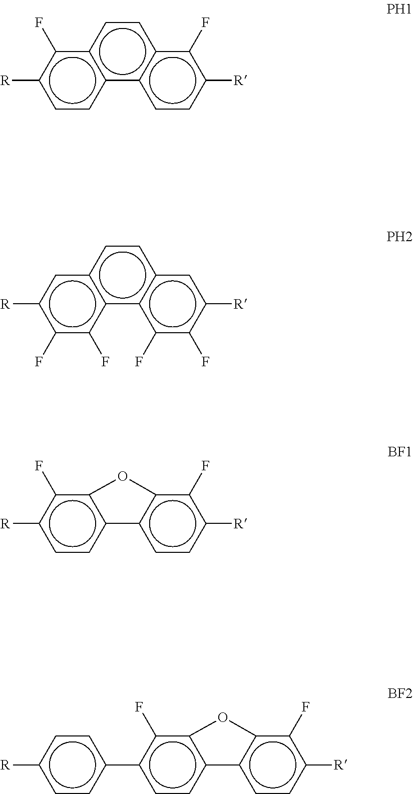

in which R and R′ each, independently of one another, denote a straight-chain alkyl or alkoxy radical having 1-7 C atoms.
p) LC medium which additionally comprises one or more monocyclic compounds of the following formula

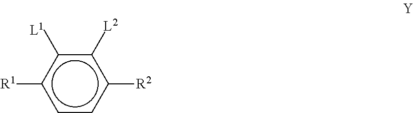

wherein
   R¹ and R² each, independently of one another, denote alkyl having 1 to 12 C atoms, where, in addition, one or two non-adjacent CH₂ groups may be replaced by —O—, —CH═CH—, —CO—, —OCO— or —COO— in such a way that O atoms are not linked directly to one another, preferably alkyl or alkoxy having 1 to 6 C atoms,
   L¹ and L² each, independently of one another, denote F, Cl, OCF₃, CF₃, CH₃, CH₂F, CHF₂.
   Preferably, both L¹ and L² denote F or one of L¹ and L² denotes F and the other denotes Cl,
   The compounds of the formula Y are preferably selected from the group consisting of the following sub-formulae:

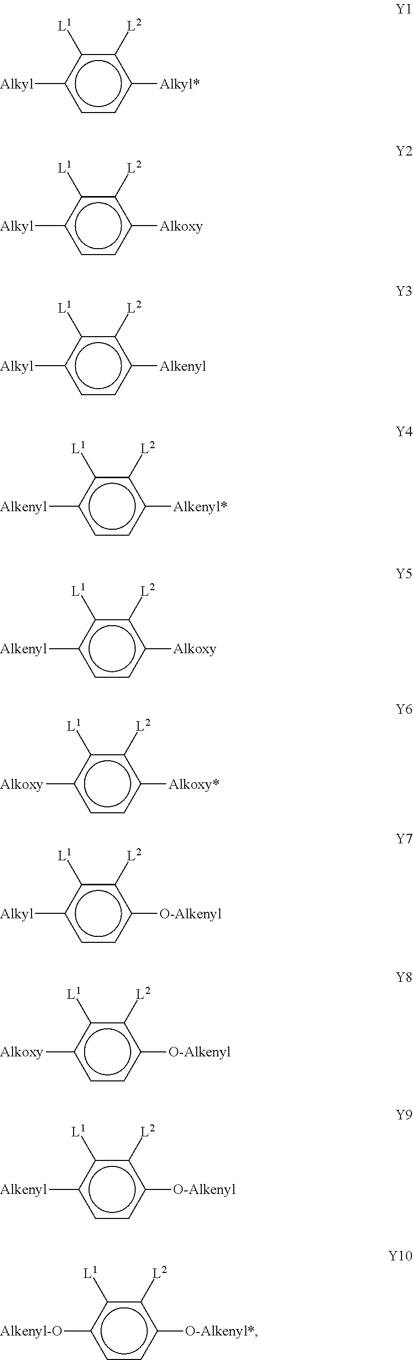

in which, Alkyl and Alkyl* each, independently of one another, denote a straight-chain alkyl radical having 1-6 C atoms, Alkoxy denotes a straight-chain alkoxy radical having 1-6 C atoms, Alkenyl and Alkenyl* each, independently of one another, denote a straight-chain alkenyl radical having 2-6 C atoms, and O denotes an oxygen atom or a single bond. Alkenyl and Alkenyl* preferably denote CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH— or CH₃—CH═CH—(CH₂)₂—.
   Particularly preferred compounds of the formula Y are selected from the group consisting of the following sub-formulae:

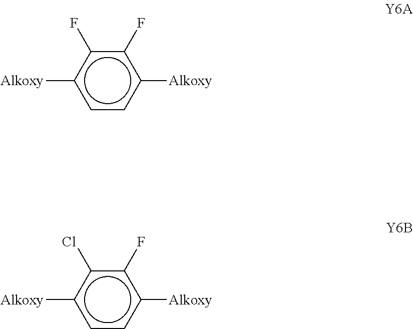

wherein Alkoxy preferably denotes straight-chain alkoxy with 3, 4, or 5 C atoms.
q) LC medium which, apart from the stabilisers according to the invention, in particular of the formula I or sub-formulae thereof and the co-monomers, comprises no compounds which contain a terminal vinyloxy group (—O—CH═CH₂).
r) LC medium which comprises 1 to 5, preferably 1, 2 or 3, stabilisers, preferably selected from stabilisers according to the invention, in particular of the formula I or sub-formulae thereof.
s) LC medium in which the proportion of stabilisers, in particular of the formula I or sub-formulae thereof, in the mixture as a whole is in the range from >0 to ≤1000 ppm, preferably 10 to 900 ppm, particularly preferably from 100 to 750 ppm, very particularly preferably from 400 to 600 ppm.
t) LC medium which comprises 1 to 8, preferably 1 to 5, compounds of the formulae CY1, CY2, PY1 and/or PY2. The proportion of these compounds in the mixture as a whole is preferably 5 to 60%, particularly preferably 10 to 35%. The content of these individual compounds is preferably in each case 2 to 20%.
u) LC medium which comprises 1 to 8, preferably 1 to 5, compounds of the formulae CY9, CY10, PY9 and/or PY10. The proportion of these compounds in the mixture as a whole is preferably 5 to 60%, particularly preferably 10 to 35%. The content of these individual compounds is preferably in each case 2 to 20%.
v) LC medium which comprises 1 to 10, preferably 1 to 8, compounds of the formula ZK, in particular compounds of the formulae ZK1, ZK2 and/or ZK6. The proportion of these compounds in the mixture as a whole is preferably 3 to 25%, particularly preferably 5 to 45%. The content of these individual compounds is preferably in each case 2 to 20%.
w) LC medium in which the proportion of compounds of the formulae CY, PY and ZK in the mixture as a whole is greater than 70%, preferably greater than 80%.
x) LC medium in which the LC host mixture contains one or more compounds containing an alkenyl group, preferably selected from the group consisting of formula CY, PY and LY, wherein one or both of R¹ and R² denote straight-chain alkenyl having 2-6 C atoms, formula ZK and DK, wherein one or both of R³ and R⁴ or one or both of R⁵ and R⁶ denote straight-chain alkenyl having 2-6 C atoms, and formula B2 and B3, very preferably selected from formulae CY15, CY16, CY24, CY32, PY15, PY16, ZK3, ZK4, DK3, DK6, B2 and B3, most preferably selected from formulae ZK3, ZK4, B2 and B3. The concentration of these compounds in the LC host mixture is preferably from 2 to 70%, very preferably from 3 to 55%.
y) LC medium which contains one or more, preferably 1 to 5, compounds selected of formula PY1-PY8, very preferably of formula PY2. The proportion of these compounds in the mixture as a whole is preferably 1 to 30%, particularly preferably 2 to 20%. The content of these individual compounds is preferably in each case 1 to 20%.
z) LC medium which contains one or more, preferably 1, 2 or 3, compounds of formula T2. The content of these compounds in the mixture as a whole is preferably 1 to 20%.

The combination of compounds of the preferred embodiments mentioned above with the stabilisers described above causes low threshold voltages, low rotational viscosities and very good low-temperature stabilities in the LC media according to the invention at the same time as constantly high clearing points and high VHR values. In particular, the LC media exhibit significantly shortened response times, in particular also the grey-shade response times, compared to displays from the prior art.

The LC medium and the LC host mixture preferably has a nematic phase range of at least 80 K, particularly preferably at least 100 K, and a rotational viscosity of not greater than 250 mPa·s, preferably not greater than 200 mPa·s, very preferably not greater than 150 mPa·s, at 20° C.

The LC medium according to the invention preferably has a negative dielectric anisotropy Δϵ from −0.5 to −10, very preferably from −2.5 to −7.5, at 20° C. and 1 kHz.

The LC medium according to the invention preferably has a birefringence Δn below 0.16, very preferably from 0.06 to 0.14, very particularly preferably from 0.07 to 0.12.

The LC medium according to the invention may also comprise further additives which are known to the person skilled in the art and are described in the literature, such as, for example, stabilisers, surface-active substances or chiral dopants.

In a preferred embodiment the LC medium contains one or more chiral dopants, preferably in a concentration from 0.01 to 1%, very preferably from 0.05 to 0.5%. The chiral dopants are preferably selected from the group consisting of compounds from Table B below, very preferably from the group consisting of R- or S-1011, R- or S-2011, R- or S-3011, R- or S-4011, and R- or S-5011.

In another preferred embodiment the LC medium contains a racemate of one or more chiral dopants, which are preferably selected from the chiral dopants mentioned in the previous paragraph.

Furthermore, it is possible to add to the LC medium for example 0 to 15% by weight of pleochroic dyes, furthermore nanoparticles, conductive salts, preferably ethyldimethyldodecylammonium 4-hexoxybenzoate, tetrabutyl-ammonium tetraphenylborate or complex salts of crown ethers (cf., for example, Haller et al., Mol. Cryst. Liq. Cryst. 24, 249-258 (1973)), for improving the conductivity, or substances for modifying the dielectric anisotropy, the viscosity and/or the alignment of the nematic phases. Substances of this type are described, for example, in DE-A 22 09 127, 22 40 864, 23 21 632, 23 38 281, 24 50 088, 26 37 430 and 28 53 728.

The individual components of the preferred embodiments a)-z) of the LC medium according to the invention are either known or methods for the preparation thereof can readily be derived from the prior art by the person skilled in the relevant art, since they are based on standard methods described in the literature. Corresponding compounds of the formula CY are described, for example, in EP-A-0 364 538. Corresponding compounds of the formula ZK are described, for example, in DE-A-26 36 684 and DE-A-33 21 373.

In a preferred embodiment the process of stabilisation of the LC media according to the present invention comprises mixing one or more of the above-mentioned compounds with one or more stabilisers of formula I, and optionally with further liquid crystalline compounds and/or additives. In a particularly preferred embodiment, the desired amount of the components used in lesser amount is dissolved in the components making up the principal constituent.

It is further preferred, to add the stabiliser of formula I to the LC mixture under inert atmosphere, preferably under nitrogen or argon.

Advantageously, the process is performed at elevated temperature, preferably above 20° C. and below 120° C., more preferably above 30° C. and below 100° C., most preferably above 40° C. and below 80° C.

It is also possible to mix solutions of the components in an organic solvent, for example in acetone, chloroform or methanol, and to remove the solvent again, for example by distillation, after thorough mixing. The invention furthermore relates to the process for the preparation of the LC media according to the invention.

The stabilisation process according to the present invention is particularly useful for LC media exposed to an LCD backlight, typically during the operation of an LC display. Such backlights are preferably cold cathode fluorescent lamps (CCFL) or LED (light-emitting diode) light sources. Advantage of these types of light source is the fact that they do not emit UV light or if so, to a negligible extent. Hence, the light stress the LC mixture is exposed to is comparatively small, because of the absence of UV light which could trigger photochemical reactions.

The stabilisers of formula I are particularly effective when exposed to light with a very small or preferably no portion in the UV region of the spectrum and when used in concentrations of ≤1000 ppm in the LC mixtures.

The present invention further relates to LC displays comprising LC mixtures described above and below. The liquid crystal display panel includes first and second substrates, an active region on the first substrate, the active region including a plurality of thin film transistors and pixel electrodes, a sealing region along a periphery of the active region and along a corresponding region of the second substrate, sealant in the sealing region, the sealant attaching the first substrate and the second substrate to one another and maintaining a gap therebetween, and a liquid crystal layer within the gap and on the active region side of the sealant.

In another aspect of the present invention, a method of manufacturing an LCD panel includes forming a plurality of pixel electrodes in an active region on a first substrate, applying UV-type hardening sealant on a sealing region positioned along a periphery of the active region, attaching the first and second substrates to each other, and irradiating UV-rays to the sealant to harden the sealant.

In yet another aspect of the present invention, a method of manufacturing an LCD panel includes forming an UV-type hardening sealant in a first sealing region of a first substrate, and dropping liquid crystal on a surface of the first substrate. The first and second substrates are attached to each other at the first and second sealing regions and UV-rays are used to harden the sealant.

In a preferred embodiment according to the present invention, the active area of the display, i.e. the region of the display that contains switchable liquid crystal, is not exposed to UV light during its manufacture. For example, when hardening a UV-type hardening sealant of the panel, the active region, i.e. the part of the display panel inside the frame used for displaying information, is preferably covered by a shadow mask.

In yet another preferred embodiment of the present invention the liquid crystal mixture is not exposed to UV light during the whole manufacturing process.

Exposure to UV light according to the present invention means exposure to UV light that is capable of triggering photochemical reactions, in particular photopolymerisation or polymerisation or decomposition of monomers by radical reactions.

It goes without saying to the person skilled in the art that the LC media according to the invention may also comprise compounds in which, for example, H, N, O, Cl, F have been replaced by the corresponding isotopes.

The structure of the LC displays according to the invention corresponds to the usual geometry for VA, IPS or FFS displays, as described in the prior art cited at the outset.

The following examples explain the present invention without restricting it. However, they show the person skilled in the art preferred mixture concepts with compounds preferably to be employed and the respective concentrations thereof and combinations thereof with one another. In addition, the examples illustrate which properties and property combinations are accessible.

The following abbreviations are used:

(n, m, z: in each case, independently of one another, 1, 2, 3, 4, 5 or 6)

TABLE A

| | |
|---|---|
| 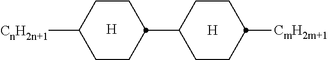 | CCH-nm |
| 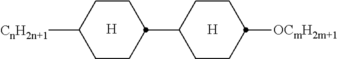 | CCH-nOm |
| 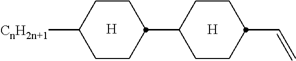 | CC-n-V |
| 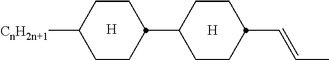 | CC-n-V1 |
| 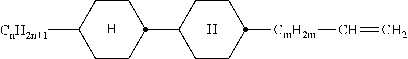 | CC-n-mV |
| 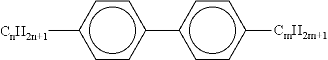 | PP-n-m |
| 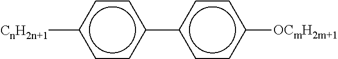 | PP-n-Om |
| 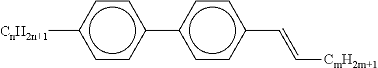 | PP-n-Vm |
| 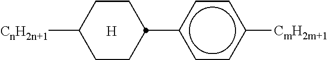 | PCH-nm |
| 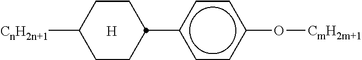 | PCH-nOm |
| 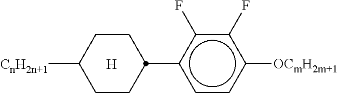 | CY-n-Om |
| 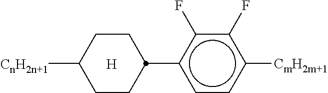 | CY-n-m |
| 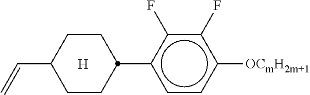 | CY-V-Om |
| 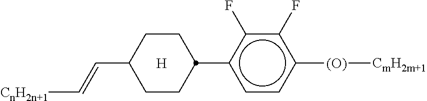 | CY-nV-(O)m |
| 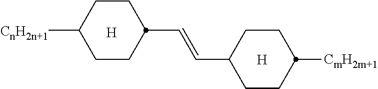 | CVC-n-m |
| 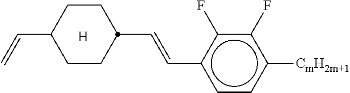 | CVY-V-m |
| 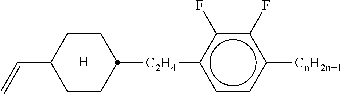 | CEY-V-m |
| 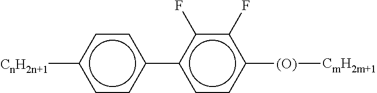 | PY-n-(O)m |
| 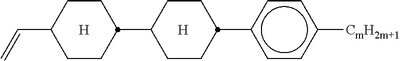 | CCP-V-m |
| 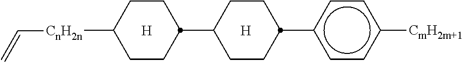 | CCP-Vn-m |
| 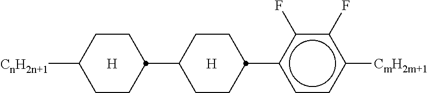 | CCY-n-m |
| 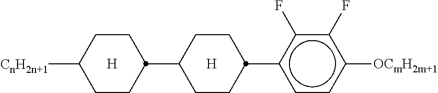 | CCY-n-Om |
| 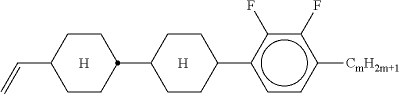 | CCY-V-m |
| 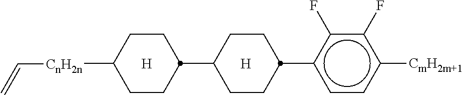 | CCY-Vn-m |
| 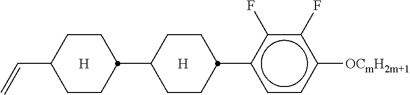 | CCY-V-Om |
| 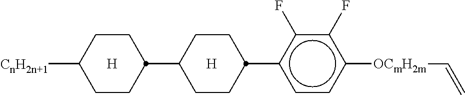 | CCY-n-OmV |
| 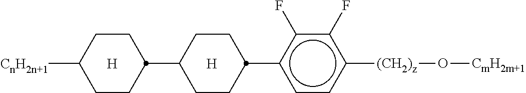 | CCY-n-zOm |
| 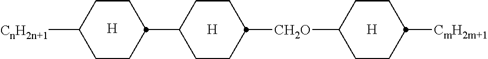 | CCOC-n-m |
| 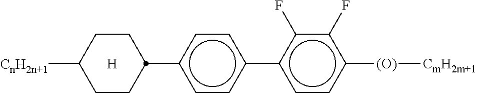 | CPY-n-(O)m |
| 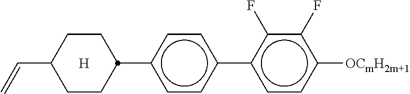 | CPY-V-Om |
| 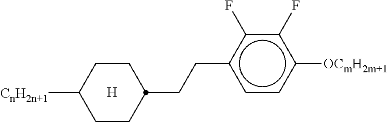 | CEY-n-Om |
| 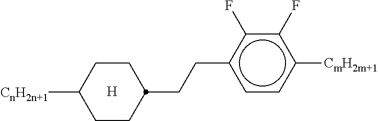 | CEY-n-m |
| 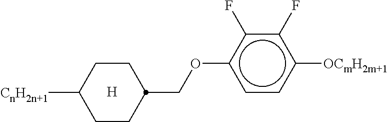 | COY-n-Om |
| 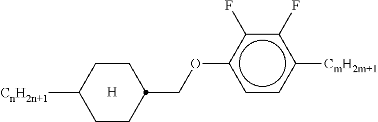 | COY-n-m |
| 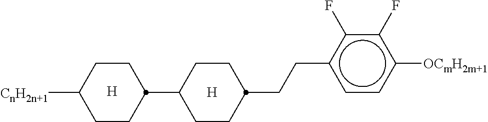 | CCEY-n-Om |
| 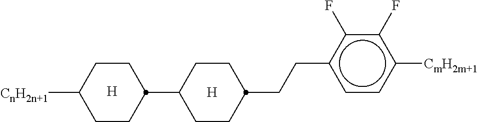 | CCEY-n-m |
| 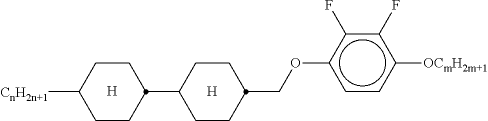 | CCOY-n-Om |
| 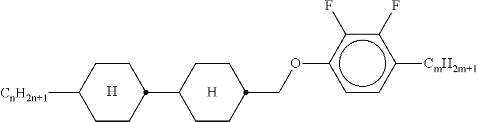 | CCOY-n-m |
| 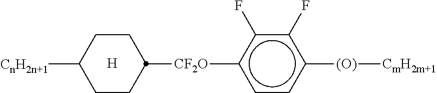 | CQY-n-(O)m |
| 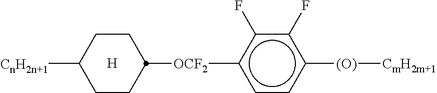 | CQIY-n-(O)m |
| 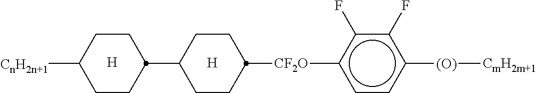 | CCQY-n-(O)m |
| 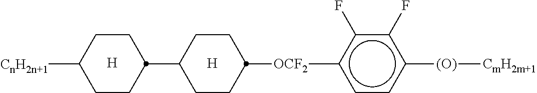 | CCQIY-n-(O)m |
| 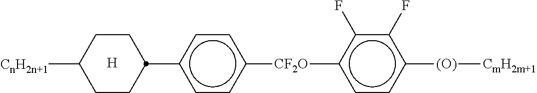 | CPQY-n-(O)m |
| 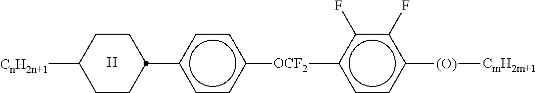 | CPQIY-n-Om |
| 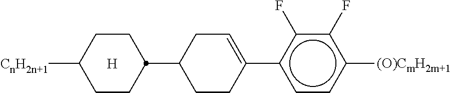 | CLY-n-(O)m |
| 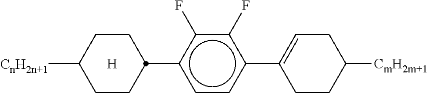 | CYLI-n-m |
| 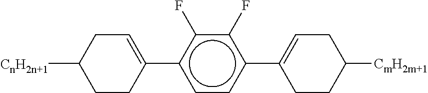 | LYLI-n-m |
| 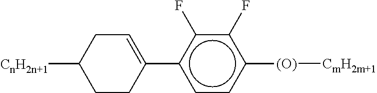 | LY-n-(O)m |
| 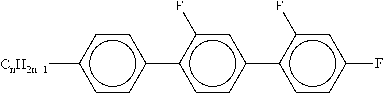 | PGIGI-n-F |
| 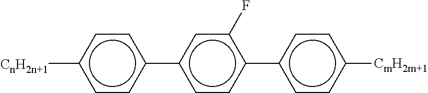 | PGP-n-m |
| 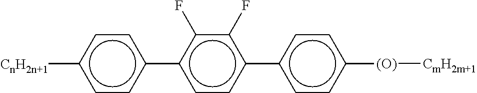 | PYP-n-(O)m |
| 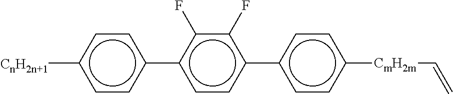 | PYP-n-mV |
| 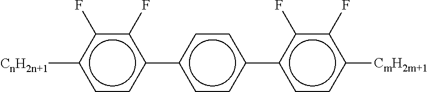 | YPY-n-m |
| 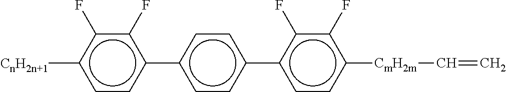 | YPY-n-mV |
| 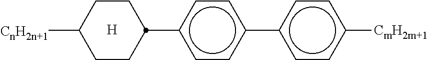 | BCH-nm |
| 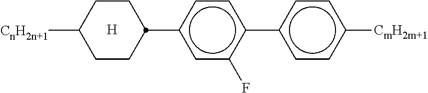 | BCH-nmF |
| 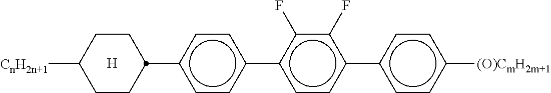 | CPYP-n-(O)m |
| 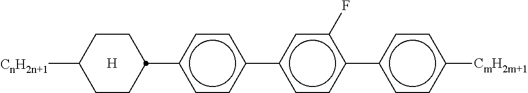 | CPGP-n-m |
| 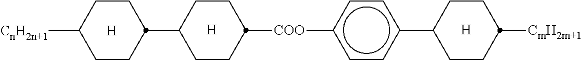 | CCZPC-n-m |
| 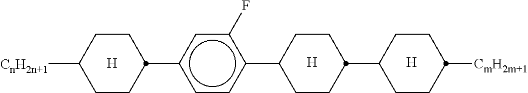 | CGCC-n-m |
| 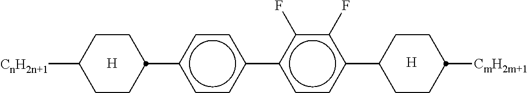 | CPYC-n-m |
| 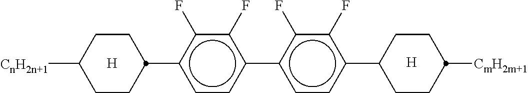 | CYYC-n-m |
| 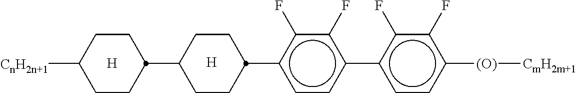 | CCYY-n-m |
| 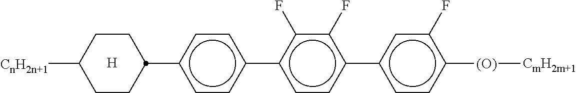 | CPYG-n-(O)m |
| 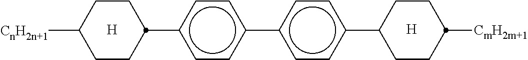 | CBC-nm |
| 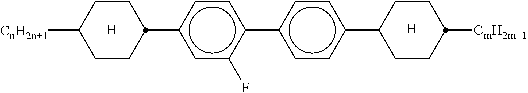 | CBC-nmF |
| 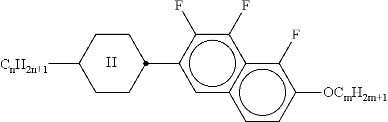 | CNap-n-Om |
| 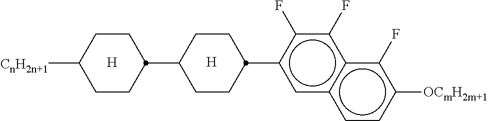 | CCNap-n-Om |
| 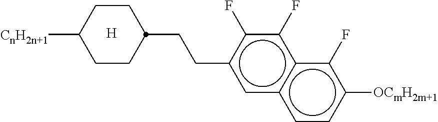 | CENap-n-Om |
| 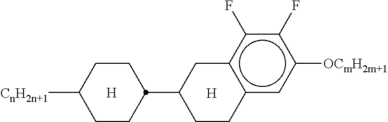 | CTNap-n-Om |
| 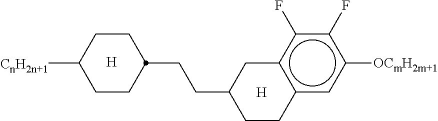 | CETNap-n-Om |
| 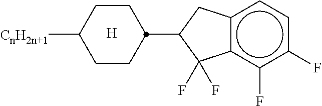 | CK-n-F |
| 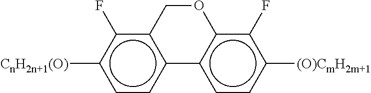 | DFDBC-n(O)-(O)m |
| 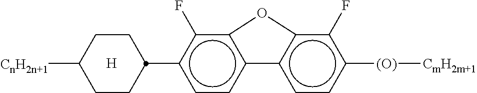 | C-DFDBF-n-(O)m |

In a preferred embodiment of the present invention, the LC media according to the invention comprise one or more compounds selected from the group consisting of compounds from Table A.

TABLE B
Table B shows possible chiral dopants which can be added to the LC media
according to the invention.

| | |
|---|---|
| 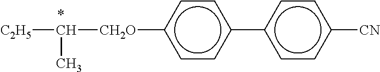 | C 15 |
| 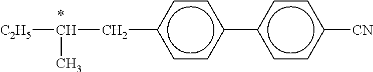 | CB 15 |
| 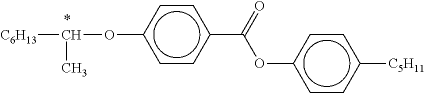 | CM 21 |
| 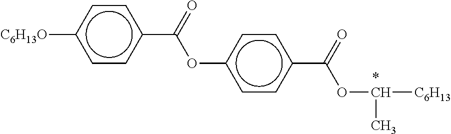 | R/S-811 |
| 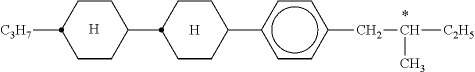 | CM 44 |
| 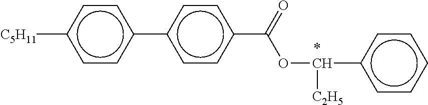 | CM 45 |
| 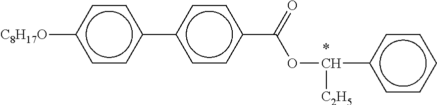 | CM 47 |
| 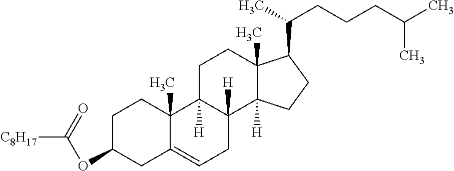 | CN |
| 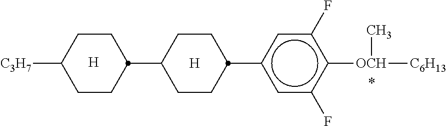 | R/S-2011 |
| 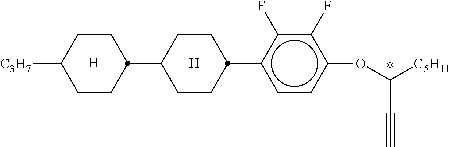 | R/S-3011 |
| 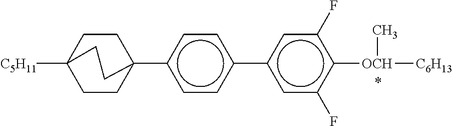 | R/S-4011 |
| 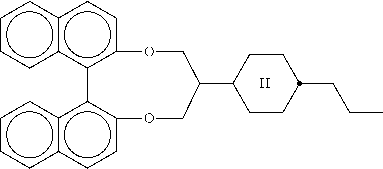 | R/S-5011 |
| 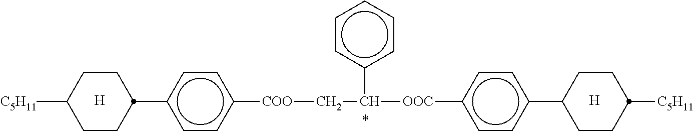 | R/S-1011 |

The LC media preferably comprise 0 to 10% by weight, in particular 0.01 to 5% by weight, particularly preferably 0.1 to 3% by weight, of dopants. The LC media preferably comprise one or more dopants selected from the group consisting of compounds from Table B.

TABLE C
Table C shows possible stabilisers which can be added to the LC media
according to the invention.
(n here denotes an integer from 1 to 12, preferably 1, 2, 3, 4, 5, 6, 7 or 8,
terminal methyl groups are not shown).

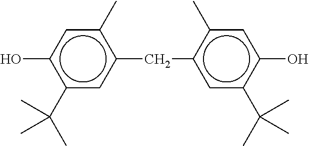

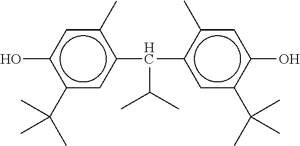

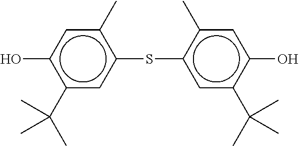

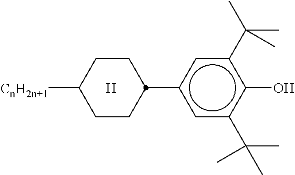

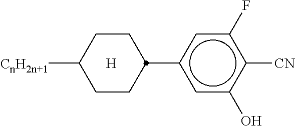

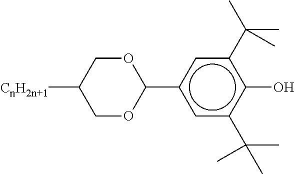

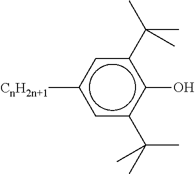

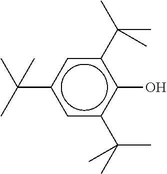

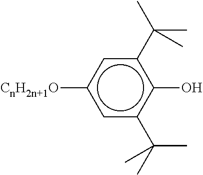

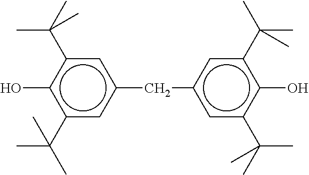

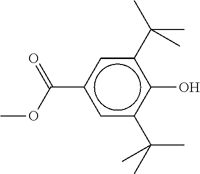

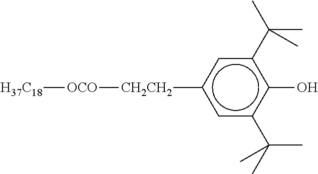

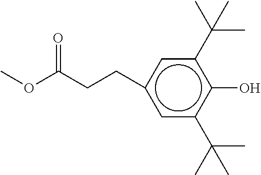

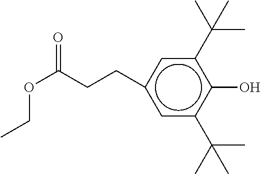

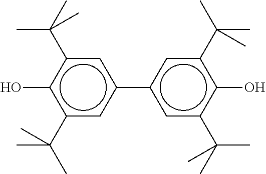

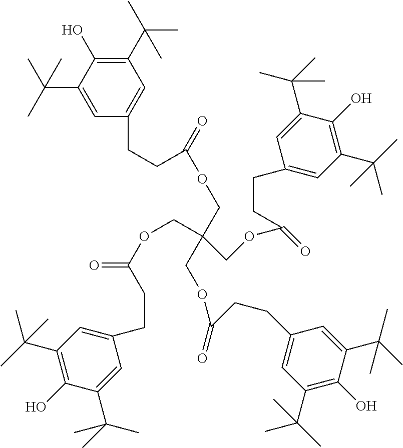 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

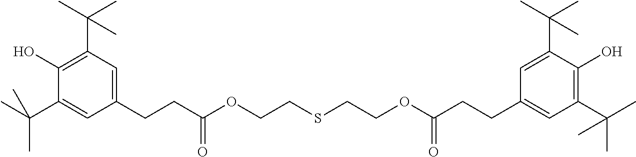 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

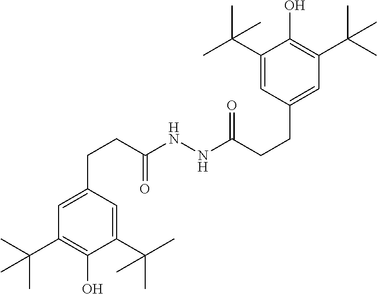 [SMILES: CC(C)(C)c1cc(CCC(=O)NNC(=O)CCc2cc(C(C)(C)C)c(O)c(C(C)(C)C)c2)cc(C(C)(C)C)c1O]

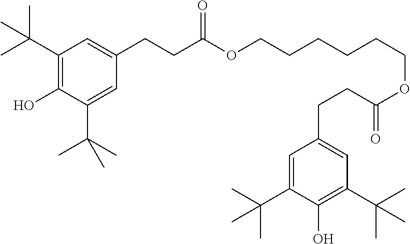 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

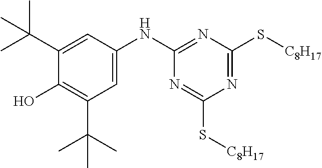

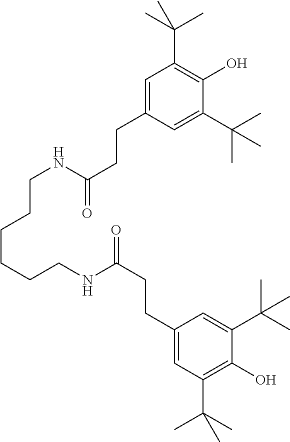 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

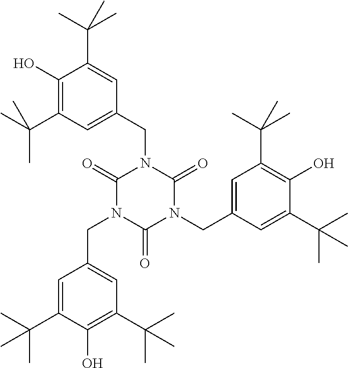 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

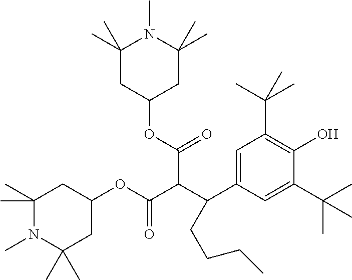 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

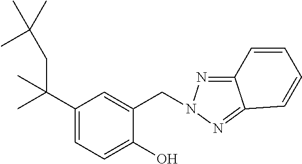 [SMILES: CC(C)(C)CC(C)(C)c1ccc(O)c(Cn2nc3ccccc3n2)c1]

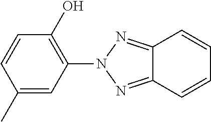 [SMILES: Cc1ccc(O)c(-n2nc3ccccc3n2)c1]

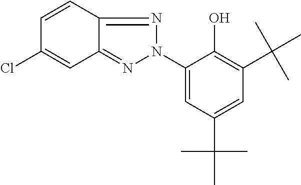 [SMILES: CC(C)(C)c1cc(-n2nc3ccc(Cl)cc3n2)c(O)c(C(C)(C)C)c1]

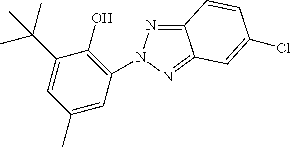 [SMILES: Cc1cc(-n2nc3ccc(Cl)cc3n2)c(O)c(C(C)(C)C)c1]

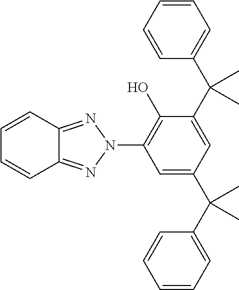 [SMILES: CC(C)(c1ccccc1)c1cc(-n2nc3ccccc3n2)c(O)c(C(C)(C)c2ccccc2)c1]

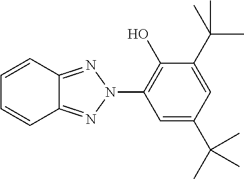 [SMILES: CC(C)(C)c1cc(-n2nc3ccccc3n2)c(O)c(C(C)(C)C)c1]

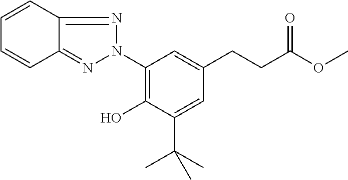 [SMILES: COC(=O)CCc1cc(-n2nc3ccccc3n2)c(O)c(C(C)(C)C)c1]

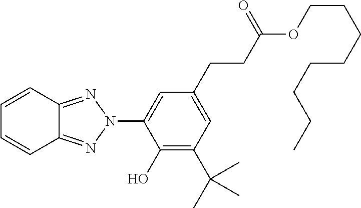 [SMILES: CCCCCCCCOC(=O)CCc1cc(-n2nc3ccccc3n2)c(O)c(C(C)(C)C)c1]

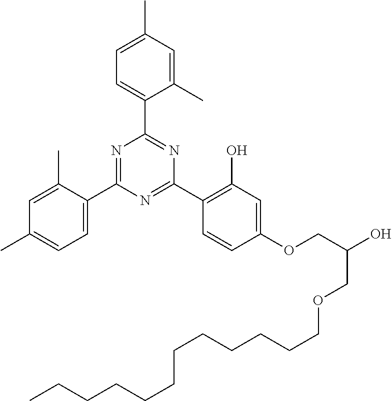 [SMILES: CCCCCCCCCCCCOCC(O)COc1ccc(-c2nc(-c3ccc(C)cc3C)nc(-c3ccc(C)cc3C)n2)c(O)c1]

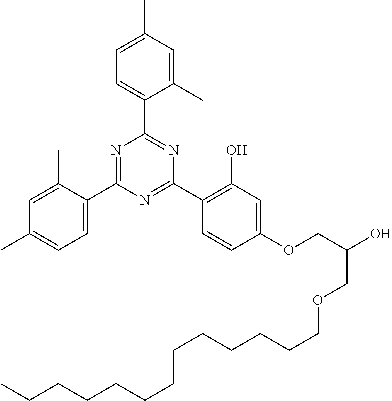 [SMILES: CCCCCCCCCCCCCOCC(O)COc1ccc(-c2nc(-c3ccc(C)cc3C)nc(-c3ccc(C)cc3C)n2)c(O)c1]

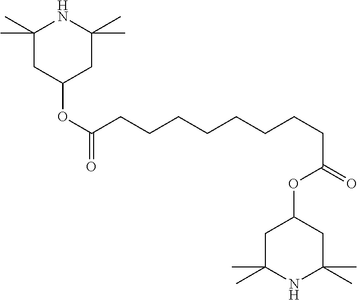

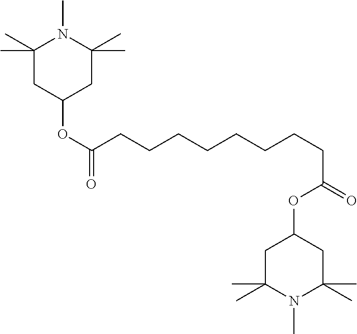

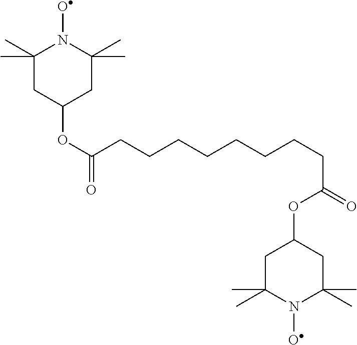

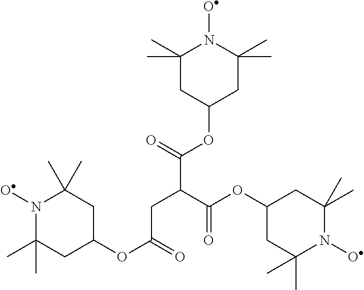

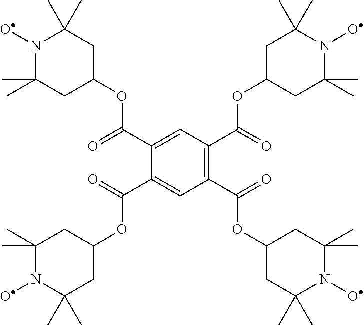

The LC media preferably comprise 0 to 10% by weight, in particular 1 ppm to 5% by weight, particularly preferably 1 ppm to 1% by weight, of stabilisers. The LC media preferably comprise one or more stabilisers selected from the group consisting of compounds from Table C.

TABLE D
Table D shows illustrative compounds which can be used in the LC media in
accordance with the present invention, preferably as stabilisers.

| | |
|---|---|
| 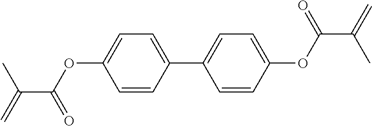 [SMILES: C=C(C)C(=O)Oc1ccc(-c2ccc(OC(=O)C(=C)C)cc2)cc1] | S-1 |
| 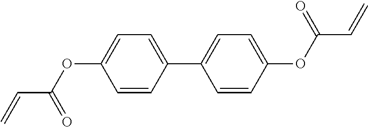 [SMILES: C=CC(=O)Oc1ccc(-c2ccc(OC(=O)C=C)cc2)cc1] | S-2 |
| 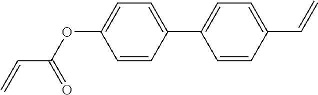 [SMILES: C=CC(=O)Oc1ccc(-c2ccc(C=C)cc2)cc1] | S-3 |
| 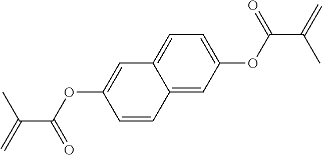 [SMILES: C=C(C)C(=O)Oc1ccc2cc(OC(=O)C(=C)C)ccc2c1] | S-4 |
| 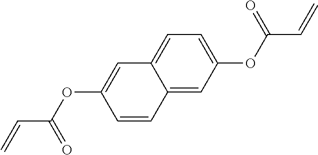 [SMILES: C=CC(=O)Oc1ccc2cc(OC(=O)C=C)ccc2c1] | S-5 |
| 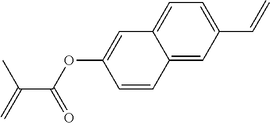 [SMILES: C=Cc1ccc2cc(OC(=O)C(=C)C)ccc2c1] | S-6 |
| 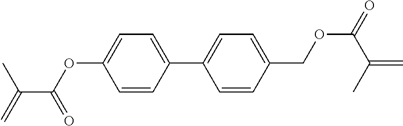 [SMILES: C=C(C)C(=O)OCc1ccc(-c2ccc(OC(=O)C(=C)C)cc2)cc1] | S-7 |
| 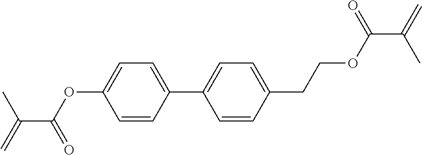 [SMILES: C=C(C)C(=O)OCCc1ccc(-c2ccc(OC(=O)C(=C)C)cc2)cc1] | S-8 |
| 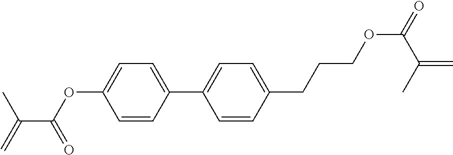 [SMILES: C=C(C)C(=O)OCCCc1ccc(-c2ccc(OC(=O)C(=C)C)cc2)cc1] | S-9 |
| 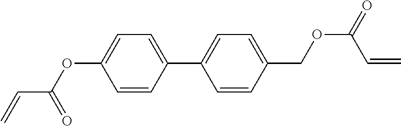 [SMILES: C=CC(=O)OCc1ccc(-c2ccc(OC(=O)C=C)cc2)cc1] | S-10 |
| 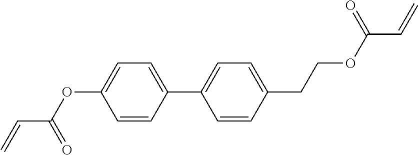 [SMILES: C=CC(=O)OCCc1ccc(-c2ccc(OC(=O)C=C)cc2)cc1] | S-11 |
| 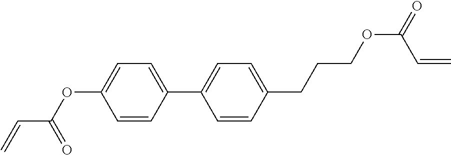 [SMILES: C=CC(=O)OCCCc1ccc(-c2ccc(OC(=O)C=C)cc2)cc1] | S-12 |
| 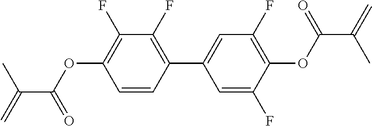 [SMILES: C=C(C)C(=O)Oc1ccc(-c2cc(F)c(OC(=O)C(=C)C)c(F)c2)c(F)c1F] | S-13 |
| 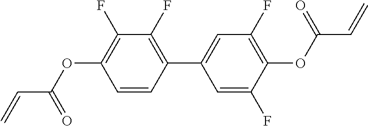 [SMILES: C=CC(=O)Oc1ccc(-c2cc(F)c(OC(=O)C=C)c(F)c2)c(F)c1F] | S-14 |
| 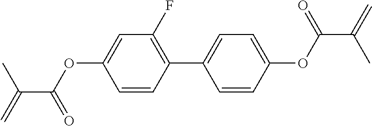 [SMILES: C=C(C)C(=O)Oc1ccc(-c2ccc(OC(=O)C(=C)C)cc2F)cc1] | S-15 |
| 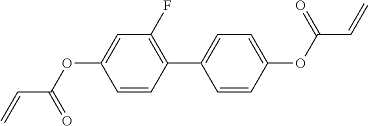 [SMILES: C=CC(=O)Oc1ccc(-c2ccc(OC(=O)C=C)cc2F)cc1] | S-16 |
| 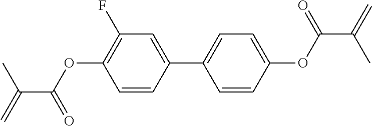 [SMILES: C=C(C)C(=O)Oc1ccc(-c2ccc(OC(=O)C(=C)C)c(F)c2)cc1] | S-17 |
| 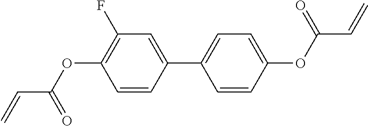 [SMILES: C=CC(=O)Oc1ccc(-c2ccc(OC(=O)C=C)c(F)c2)cc1] | S-18 |
| 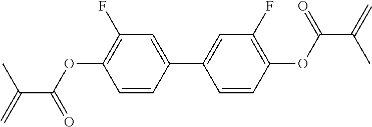 [SMILES: C=C(C)C(=O)Oc1ccc(-c2ccc(OC(=O)C(=C)C)c(F)c2)cc1F] | S-19 |
| 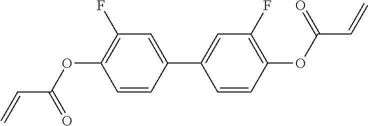 [SMILES: C=CC(=O)Oc1ccc(-c2ccc(OC(=O)C=C)c(F)c2)cc1F] | S-20 |
| 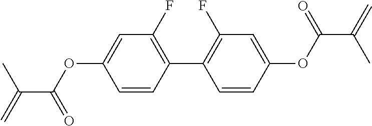 [SMILES: C=C(C)C(=O)Oc1ccc(-c2ccc(OC(=O)C(=C)C)cc2F)c(F)c1] | S-21 |
| 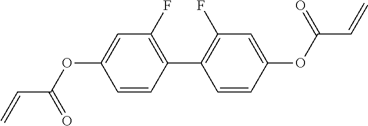 [SMILES: C=CC(=O)Oc1ccc(-c2ccc(OC(=O)C=C)cc2F)c(F)c1] | S-22 |
| 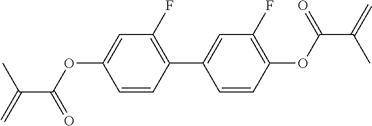 [SMILES: C=C(C)C(=O)Oc1ccc(-c2ccc(OC(=O)C(=C)C)c(F)c2)c(F)c1] | S-23 |
| 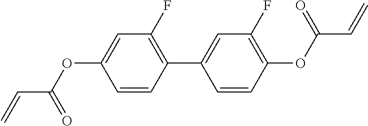 [SMILES: C=CC(=O)Oc1ccc(-c2ccc(OC(=O)C=C)c(F)c2)c(F)c1] | S-24 |
| 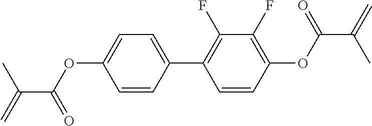 [SMILES: C=C(C)C(=O)Oc1ccc(-c2ccc(OC(=O)C(=C)C)c(F)c2F)cc1] | S-25 |
| 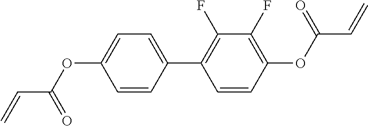 [SMILES: C=CC(=O)Oc1ccc(-c2ccc(OC(=O)C=C)c(F)c2F)cc1] | S-26 |
| 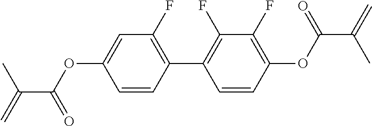 [SMILES: C=C(C)C(=O)Oc1ccc(-c2ccc(OC(=O)C(=C)C)c(F)c2F)c(F)c1] | S-27 |
| 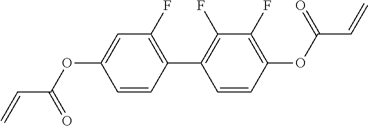 [SMILES: C=CC(=O)Oc1ccc(-c2ccc(OC(=O)C=C)c(F)c2F)c(F)c1] | S-28 |
| 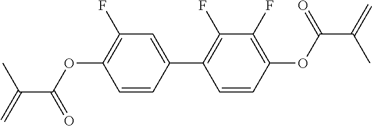 [SMILES: C=C(C)C(=O)Oc1ccc(-c2ccc(OC(=O)C(=C)C)c(F)c2F)cc1F] | S-29 |
| 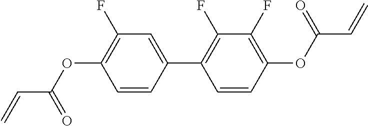 [SMILES: C=CC(=O)Oc1ccc(-c2ccc(OC(=O)C=C)c(F)c2F)cc1F] | S-30 |
| 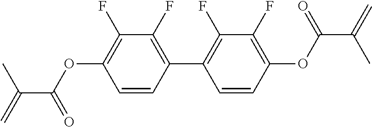 [SMILES: C=C(C)C(=O)Oc1ccc(-c2ccc(OC(=O)C(=C)C)c(F)c2F)c(F)c1F] | S-31 |
| 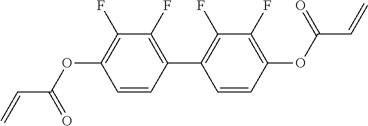 [SMILES: C=CC(=O)Oc1ccc(-c2ccc(OC(=O)C=C)c(F)c2F)c(F)c1F] | S-32 |
| 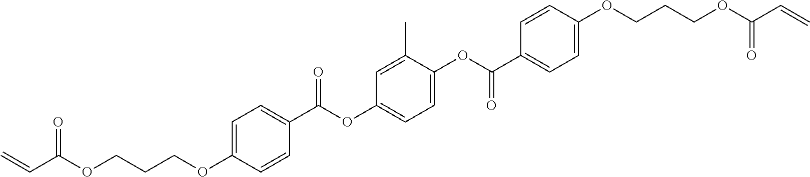 [SMILES: C=CC(=O)OCCCOc1ccc(C(=O)Oc2ccc(OC(=O)c3ccc(OCCCOC(=O)C=C)cc3)c(C)c2)cc1] | S-33 |
| 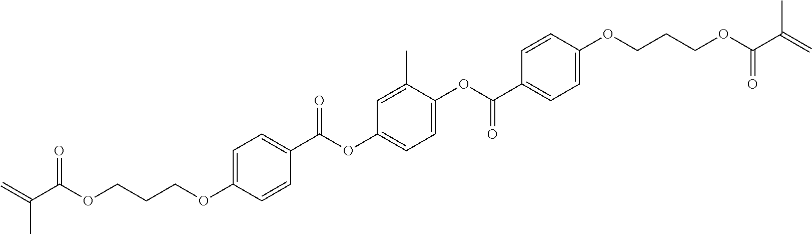 [SMILES: C=C(C)C(=O)OCCCOc1ccc(C(=O)Oc2ccc(OC(=O)c3ccc(OCCCOC(=O)C(=C)C)cc3)c(C)c2)cc1] | S-34 |
| 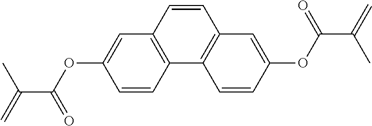 [SMILES: C=C(C)C(=O)Oc1ccc2c(ccc3cc(OC(=O)C(=C)C)ccc32)c1] | S-35 |
| 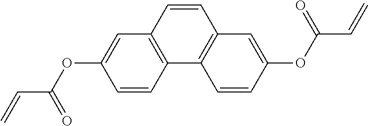 [SMILES: C=CC(=O)Oc1ccc2c(ccc3cc(OC(=O)C=C)ccc32)c1] | S-36 |
| 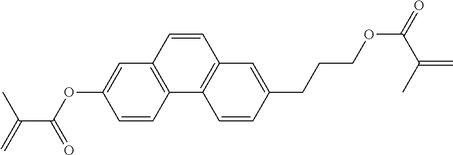 [SMILES: C=C(C)C(=O)OCCCc1ccc2c(ccc3cc(OC(=O)C(=C)C)ccc32)c1] | S-37 |
| 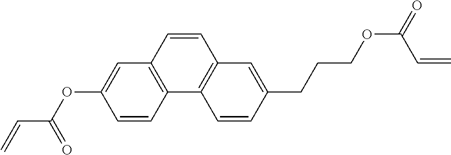 [SMILES: C=CC(=O)OCCCc1ccc2c(ccc3cc(OC(=O)C=C)ccc32)c1] | S-38 |
| 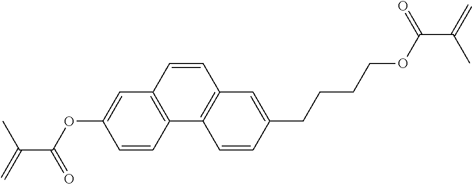 [SMILES: C=C(C)C(=O)OCCCCc1ccc2c(ccc3cc(OC(=O)C(=C)C)ccc32)c1] | S-39 |
| 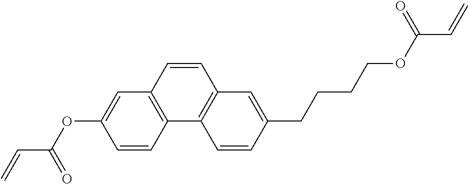 [SMILES: C=CC(=O)OCCCCc1ccc2c(ccc3cc(OC(=O)C=C)ccc32)c1] | S-40 |
| 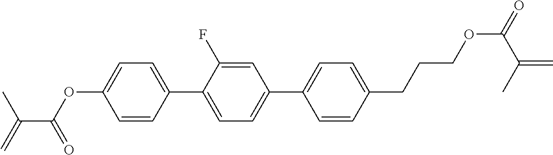 [SMILES: C=C(C)C(=O)OCCCc1ccc(-c2ccc(-c3ccc(OC(=O)C(=C)C)cc3)c(F)c2)cc1] | S-41 |
| 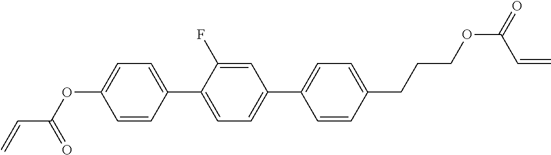 [SMILES: C=CC(=O)OCCCc1ccc(-c2ccc(-c3ccc(OC(=O)C=C)cc3)c(F)c2)cc1] | S-42 |
| 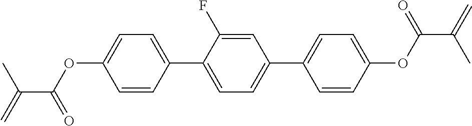 [SMILES: C=C(C)C(=O)Oc1ccc(-c2ccc(-c3ccc(OC(=O)C(=C)C)cc3)c(F)c2)cc1] | S-43 |
| 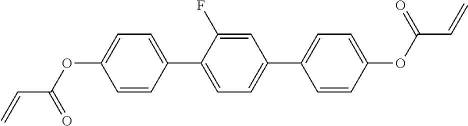 [SMILES: C=CC(=O)Oc1ccc(-c2ccc(-c3ccc(OC(=O)C=C)cc3)c(F)c2)cc1] | S-44 |
| 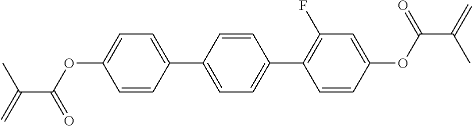 [SMILES: C=C(C)C(=O)Oc1ccc(-c2ccc(-c3ccc(OC(=O)C(=C)C)cc3F)cc2)cc1] | S-45 |
| 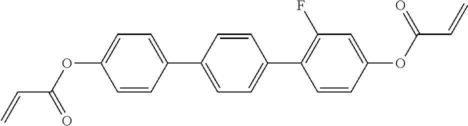 [SMILES: C=CC(=O)Oc1ccc(-c2ccc(-c3ccc(OC(=O)C=C)cc3F)cc2)cc1] | S-46 |
| 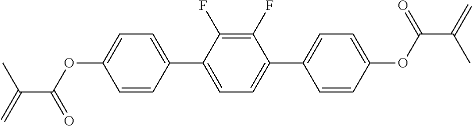 [SMILES: C=C(C)C(=O)Oc1ccc(-c2ccc(-c3ccc(OC(=O)C(=C)C)cc3)c(F)c2F)cc1] | S-47 |
| 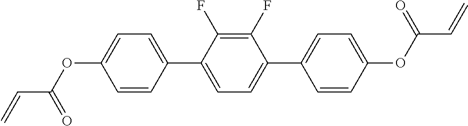 [SMILES: C=CC(=O)Oc1ccc(-c2ccc(-c3ccc(OC(=O)C=C)cc3)c(F)c2F)cc1] | S-48 |
| 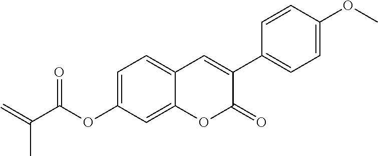 [SMILES: C=C(C)C(=O)Oc1ccc2cc(-c3ccc(OC)cc3)c(=O)oc2c1] | S-49 |
| 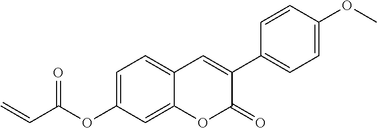 [SMILES: C=CC(=O)Oc1ccc2cc(-c3ccc(OC)cc3)c(=O)oc2c1] | S-50 |
| 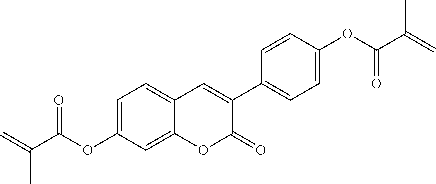 [SMILES: C=C(C)C(=O)Oc1ccc(-c2cc3ccc(OC(=O)C(=C)C)cc3oc2=O)cc1] | S-51 |
| 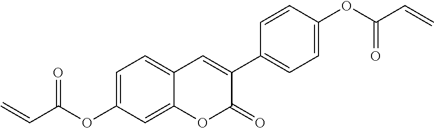 [SMILES: C=CC(=O)Oc1ccc(-c2cc3ccc(OC(=O)C=C)cc3oc2=O)cc1] | S-52 |
| 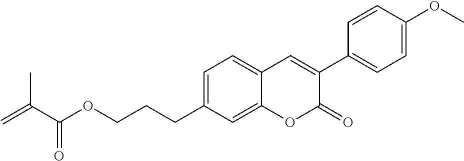 [SMILES: C=C(C)C(=O)OCCCc1ccc2cc(-c3ccc(OC)cc3)c(=O)oc2c1] | S-53 |
| 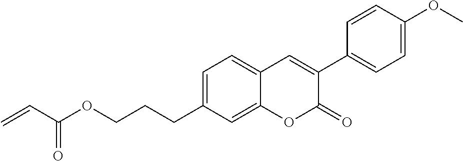 [SMILES: C=CC(=O)OCCCc1ccc2cc(-c3ccc(OC)cc3)c(=O)oc2c1] | S-54 |
| 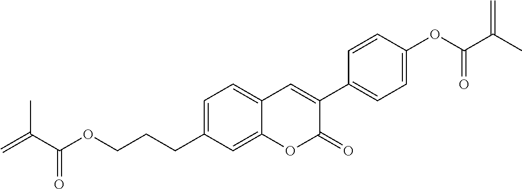 [SMILES: C=C(C)C(=O)OCCCc1ccc2cc(-c3ccc(OC(=O)C(=C)C)cc3)c(=O)oc2c1] | S-55 |
| 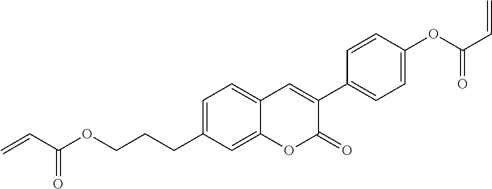 [SMILES: C=CC(=O)OCCCc1ccc2cc(-c3ccc(OC(=O)C=C)cc3)c(=O)oc2c1] | S-56 |
| 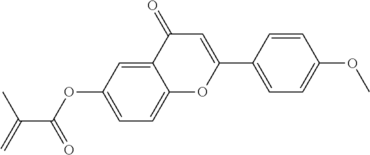 [SMILES: C=C(C)C(=O)Oc1ccc2oc(-c3ccc(OC)cc3)cc(=O)c2c1] | S-57 |
| 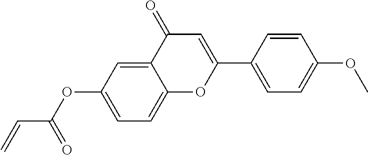 [SMILES: C=CC(=O)Oc1ccc2oc(-c3ccc(OC)cc3)cc(=O)c2c1] | S-58 |
| 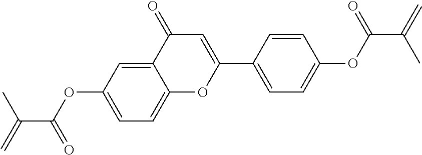 [SMILES: C=C(C)C(=O)Oc1ccc(-c2cc(=O)c3cc(OC(=O)C(=C)C)ccc3o2)cc1] | S-59 |
| 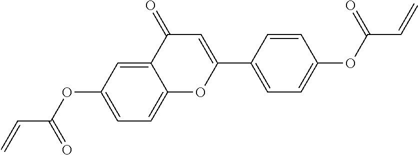 [SMILES: C=CC(=O)Oc1ccc(-c2cc(=O)c3cc(OC(=O)C=C)ccc3o2)cc1] | S-60 |
| 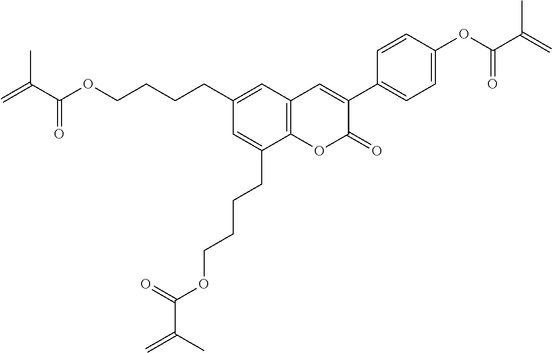 [SMILES: C=C(C)C(=O)OCCCCc1cc(CCCCOC(=O)C(=C)C)c2oc(=O)c(-c3ccc(OC(=O)C(=C)C)cc3)cc2c1] | S-61 |
| 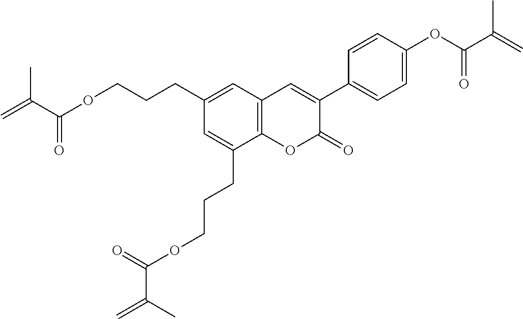 [SMILES: C=C(C)C(=O)OCCCc1cc(CCCOC(=O)C(=C)C)c2oc(=O)c(-c3ccc(OC(=O)C(=C)C)cc3)cc2c1] | S-62 |
| 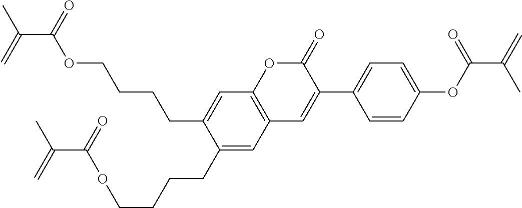 [SMILES: C=C(C)C(=O)OCCCCc1cc2cc(-c3ccc(OC(=O)C(=C)C)cc3)c(=O)oc2cc1CCCCOC(=O)C(=C)C] | S-63 |
| 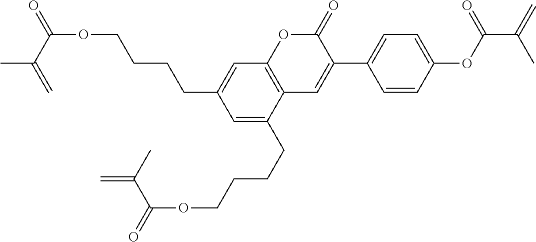 [SMILES: C=C(C)C(=O)OCCCCc1cc(CCCCOC(=O)C(=C)C)c2cc(-c3ccc(OC(=O)C(=C)C)cc3)c(=O)oc2c1] | S-64 |
| 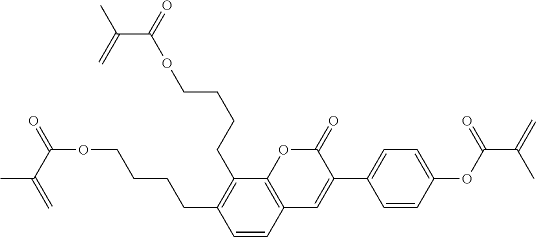 [SMILES: C=C(C)C(=O)OCCCCc1ccc2cc(-c3ccc(OC(=O)C(=C)C)cc3)c(=O)oc2c1CCCCOC(=O)C(=C)C] | S-65 |
| 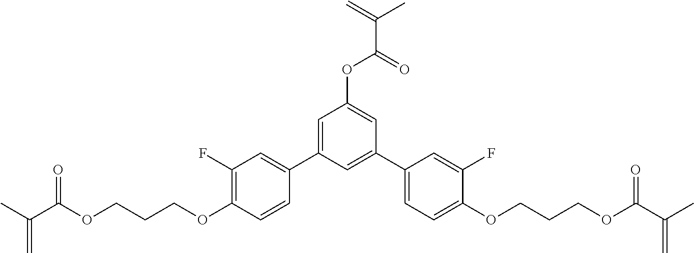 [SMILES: C=C(C)C(=O)OCCCOc1ccc(-c2cc(OC(=O)C(=C)C)cc(-c3ccc(OCCCOC(=O)C(=C)C)c(F)c3)c2)cc1F] | S-66 |
| 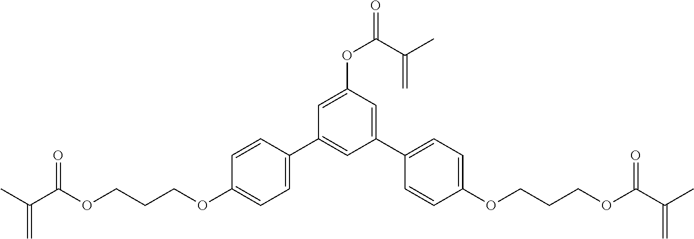 [SMILES: C=C(C)C(=O)OCCCOc1ccc(-c2cc(OC(=O)C(=C)C)cc(-c3ccc(OCCCOC(=O)C(=C)C)cc3)c2)cc1] | S-67 |
| 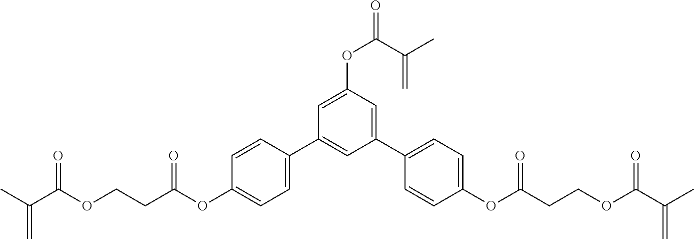 [SMILES: C=C(C)C(=O)OCCC(=O)Oc1ccc(-c2cc(OC(=O)C(=C)C)cc(-c3ccc(OC(=O)CCOC(=O)C(=C)C)cc3)c2)cc1] | S-68 |
| 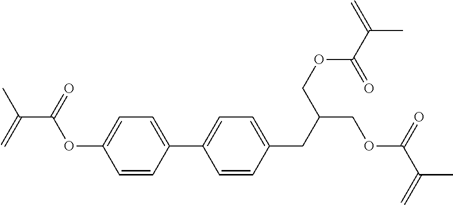 [SMILES: C=C(C)C(=O)OCC(COC(=O)C(=C)C)Cc1ccc(-c2ccc(OC(=O)C(=C)C)cc2)cc1] | S-69 |
| 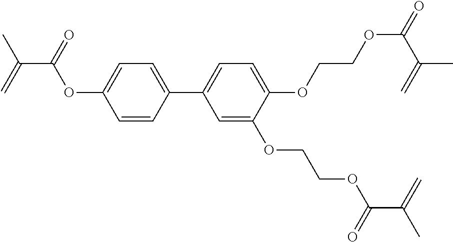 [SMILES: C=C(C)C(=O)OCCOc1ccc(-c2ccc(OC(=O)C(=C)C)cc2)cc1OCCOC(=O)C(=C)C] | S-70 |
| 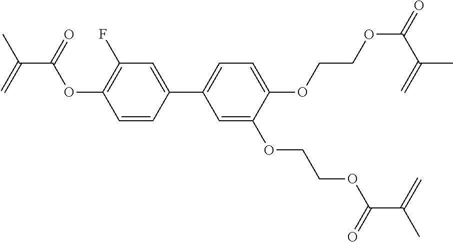 [SMILES: C=C(C)C(=O)OCCOc1ccc(-c2ccc(OC(=O)C(=C)C)c(F)c2)cc1OCCOC(=O)C(=C)C] | S-71 |
| 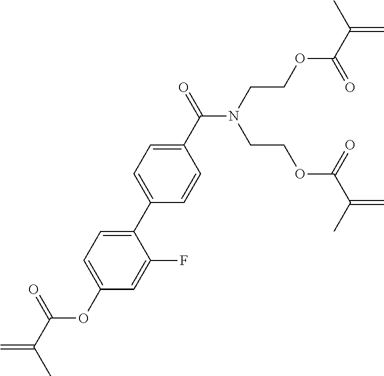 [SMILES: C=C(C)C(=O)OCCN(CCOC(=O)C(=C)C)C(=O)c1ccc(-c2ccc(OC(=O)C(=C)C)cc2F)cc1] | S-72 |
| 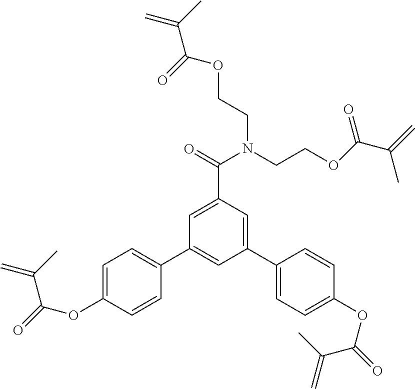 [SMILES: C=C(C)C(=O)OCCN(CCOC(=O)C(=C)C)C(=O)c1cc(-c2ccc(OC(=O)C(=C)C)cc2)cc(-c2ccc(OC(=O)C(=C)C)cc2)c1] | S-73 |
| 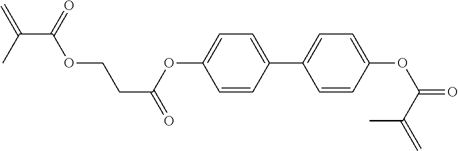 [SMILES: C=C(C)C(=O)OCCC(=O)Oc1ccc(-c2ccc(OC(=O)C(=C)C)cc2)cc1] | S-74 |
| 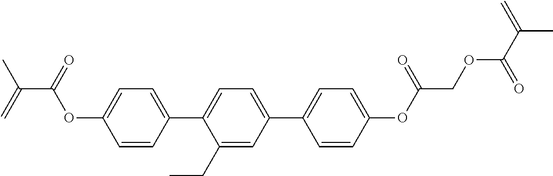 [SMILES: C=C(C)C(=O)OCC(=O)Oc1ccc(-c2ccc(-c3ccc(OC(=O)C(=C)C)cc3)c(CC)c2)cc1] | S-75 |
| 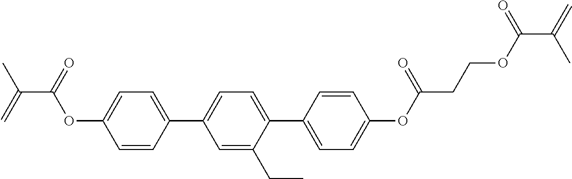 [SMILES: C=C(C)C(=O)OCCC(=O)Oc1ccc(-c2ccc(-c3ccc(OC(=O)C(=C)C)cc3)cc2CC)cc1] | S-76 |
| 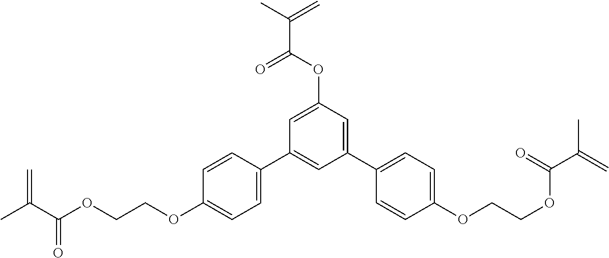 [SMILES: C=C(C)C(=O)OCCOc1ccc(-c2cc(OC(=O)C(=C)C)cc(-c3ccc(OCCOC(=O)C(=C)C)cc3)c2)cc1] | S-77 |
| 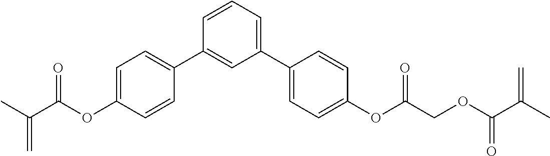 [SMILES: C=C(C)C(=O)OCC(=O)Oc1ccc(-c2cccc(-c3ccc(OC(=O)C(=C)C)cc3)c2)cc1] | S-78 |
| 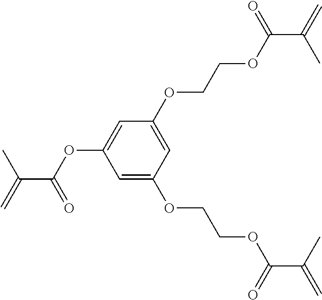 [SMILES: C=C(C)C(=O)OCCOc1cc(OCCOC(=O)C(=C)C)cc(OC(=O)C(=C)C)c1] | S-79 |

In a preferred embodiment of the present invention, the mesogenic media comprise one or more compounds selected from the group of the compounds from Table D.

In addition, the following abbreviations and symbols are used:
V₀ threshold voltage, capacitive [V] at 20° C.,
nₑ extraordinary refractive index at 20° C. and 589 nm,
nₒ ordinary refractive index at 20° C. and 589 nm,
Δn optical anisotropy at 20° C. and 589 nm,
ε_{⊥} dielectric permittivity perpendicular to the director at 20° C. and 1 kHz,
ε∥ dielectric permittivity parallel to the director at 20° C. and 1 kHz,
Δε dielectric anisotropy at 20° C. and 1 kHz,
cl.p., T(N,I) clearing point [° C.],
γ₁ rotational viscosity at 20° C. [mPa·s],
K₁ elastic constant, “splay” deformation at 20° C. [pN],
K₂ elastic constant, “twist” deformation at 20° C. [pN],
K₃ elastic constant, “bend” deformation at 20° C. [pN].

Unless explicitly noted otherwise, all concentrations in the present application are quoted in per cent by weight and relate to the corresponding mixture as a whole, comprising all solid or liquid crystalline components, without solvents. 1% by weight equals 10000 ppm.

Unless explicitly noted otherwise, all temperature values indicated in the present application, such as, for example, for the melting point T(C,N), the transition from the smectic (S) to the nematic (N) phase T(S,N) and the clearing point T(N,I), are quoted in degrees Celsius (° C.). M.p. denotes melting point, cl.p.=clearing point. Furthermore, C=crystalline state, N=nematic phase, S=smectic phase and I=isotropic phase. The data between these symbols represent the transition temperatures.

All physical properties are and have been determined in accordance with “Merck Liquid Crystals, Physical Properties of Liquid Crystals”, Status November 1997, Merck KGaA, Germany, and apply for a temperature of 20° C., and Δn is determined at 589 nm and Δε at 1 kHz, unless explicitly indicated otherwise in each case.

The term “threshold voltage” for the present invention relates to the capacitive threshold (V₀), also known as the Freedericks threshold, unless explicitly indicated otherwise. In the examples, the optical threshold may also, as generally usual, be quoted for 10% relative contrast (V₁₀).

Unless stated otherwise, methods of preparing test cells and measuring their electrooptical and other properties are carried out by the methods as described hereinafter or in analogy thereto.

The displays used for electrooptical (e/o)-measurements are produced by Merck Japan Ltd. The displays have substrates of alkali-free glass and have FFS configuration (pixel electrode with parallel ITO strips with a width of 3.5 μm at a distance of 6 μm, a full-surface ITO layer as common electrode, and an insulation layer made of silicon nitride in between). On the pixel electrode a polyimide alignment layer is located that induces a planar orientation of the LC. The orientation in the plane can be adjusted, either by means of a mechanical process or a photo-alignment step, in such a manner that a preferential orientation in the plane of 90° to 80° with respect to the electrode strips of the pixel electrode is achieved. The surface of the transparent, virtually square electrodes made of ITO is 25 mm². The layer thickness of the display can be adjusted according to the optical anisotropy of the liquid crystal mixture (Δn). Typical values for the layer thickness are between 3.0 μm and 3.5 μm.

The display used for measurement of the VHR consists of a glass substrate coated with an ITO layer which form a part of a parallel plate capacitor (because the glass substrate is sandwiched symmetrically with another identical substrate) and was purchased from Merck Japan Ltd. The substrates are made of alkali-free glass and are provided with a 50 nm thick layer of polyimide for planar alignment of the LC, using a commercially available polyimide material. The distance of both coated glass substrates are controlled via spacer materials. Optionally the polyimide material is treated by a rubbing process or a photoalignment process. The cell gap is either 3 μm or 6 μm. The transparent ITO electrode has a nearly square shape and an area of 1 cm².

The VHR value is measured as follows: the mixture is introduced into FFS-VHR test cells (optionally rubbed or treated by a photoalignment process step, polyimide alignment layer, LC-layer thickness d between 3 and 6 μm). The VHR value is determined after 5 min at 100° C. before and after light stress at 1 V, 60 Hz, 64 μs pulse (measuring instrument: Autronic-Melchers VHRM-105) unless stated otherwise.

The light stability is determined using a “Suntest CPS” which is commercially available from Heraeus, Germany. The sealed LC cells are irradiated for 30 min to 2.0 h unless stated otherwise, without additional heat. The light power in the wavelength range from 300 nm to 800 nm is 765 W/m² V. A UV “cut-off” Filter with a cut-off at 310 nm is used in order to simulate the so-called window glass mode. In each series at least four to six test cells are investigated and the average value is given for each measurement.

In analogy, the stability against an LC display backlight is determined by using a standard cold cathode fluorescent lamp(CCFL)-LCD-backlight. The LC cells are irradiated for 900 h and before and afterwards the VHR is determined after 5 min at 100° C.

The accuracy of the measured values of VHR depends on the value of the VHR. The accuracy decreases with decreasing values. The usually observed values of deviation in the different size ranges are collocated in their order in the table below.

| | deviation |
|---|---|
| VHR range | (relative) |
| VHR values | Δ_{G}VHR/VHR [%] |

| from | to | ca. |
|---|---|---|
| 99.6% | 100% | +/−0.1 |
| 99.0% | 99.6% | +/−0.2 |
| 98.0% | 99.0% | +/−0.3 |
| 95.0% | 98.0% | +/−0.5 |
| 90.0% | 95.0% | +/−1 |
| 80.0% | 90.0% | +/−2 |
| 60.0% | 80.0% | +/−4 |
| 40.0% | 60.0% | +/−8 |
| 20.0% | 40.0% | +/−10 |
| 10.0% | 20.0% | +/−20 |

LC Host Mixtures

The nematic LC host mixture N-1 is formulated as follows:

| | | | |
|---|---|---|---|
| BCH-32 | 4.50% | cl.p. | 86.0° C. |
| CC-3-V | 23.50% | Δn | 0.1118 |
| CCH-301 | 4.00% | Δε | −4.3 |
| CCY-3-O2 | 4.00% | ε_{\|\|} | 3.7 |
| CCY-3-O3 | 7.00% | K₃/K₁ | 1.13 |
| CCY-4-O2 | 8.00% | γ₁ | 143 mPa s |
| CLY-3-O2 | 8.00% | | |
| CPY-2-O2 | 7.00% | | |
| CPY-3-O2 | 11.00% | | |
| CY-3-O2 | 11.00% | | |
| PY-3-O2 | 12.00% | | |

The nematic LC host mixture N-2 is formulated as follows:

| | | | |
|---|---|---|---|
| CY-3-O2 | 12.00% | cl.p. | 86.5° C. |
| CY-3-O4 | 2.00% | Δn | 0.1092 |
| CY-5-O2 | 12.00% | | |
| CCY-3-O1 | 6.00% | | |
| CCY-3-O2 | 6.00% | Δε | −4.2 |
| CPY-2-O2 | 9.00% | ε_{\|\|} | 3.7 |
| CPY-3-O2 | 9.00% | K₃/K₁ | 1.13 |
| PYP-2-3 | 5.00% | γ₁ | 155 mPa s |
| CC-3-V1 | 5.00% | | |
| CC-3-V | 19.00% | | |
| BCH-32 | 5.00% | | |

Stabilised mixtures M1 to M-25 are prepared by adding in each case one of the stabilisers selected from the compounds listed in Table D to the LC host mixtures N1 and N2, respectively, at a concentration given in the respective tables below.

The VHR of the mixtures is measured and the mixtures are then exposed to light stress as described above and the VHR before and after light stress are compared.

The results are summarised in the tables 1 to 7 below.

### EXAMPLES 1.1 TO 1.10

TABLE 1
LED Backlight Stress (VHR: 100° C., 1 V, 60 Hz)

| | | | | VHR | VHR |
|---|---|---|---|---|---|
| Example | Mixture | Stabiliser | Conc./ppm | initial/% | (480 h)/% |
| (Ref.) | N-1 | — | 500 | 89.0 | 74.2 |
| 1.1 | M-1 | S-71 | 500 | 87.7 | 88.3 |
| 1.2 | M-2 | S-62 | 500 | 86.8 | 90.1 |
| 1.3 | M-3 | S-75 | 500 | 89.6 | 86.9 |
| 1.4 | M-4 | S-78 | 500 | 88.7 | 85.2 |
| 1.5 | M-5 | S-74 | 500 | 85.1 | 81.5 |
| 1.6 | M-6 | S-77 | 500 | 87.5 | 86.9 |
| 1.7 | M-7 | S-76 | 500 | 87.8 | 85.6 |

As can be seen in table 1, even a small amount of all stabilisers used leads to significantly improved VHR values after backlight stress compared to the unstabilised host mixture N-1.

TABLE 2
LED Backlight Stress (VHR: 100° C., 1 V, 10 Hz)

| | | | | VHR | VHR |
|---|---|---|---|---|---|
| Example | Mixture | Stabiliser | Conc./ppm | initial/% | (480 h)/% |
| (Ref.) | N-1 | none | — | 64.5 | 43.6 |
| 1.8 | M-8 | S-79 | 500 | 62.3 | 68.4 |
| 1.9 | M-9 | S-73- | 500 | 61.7 | 80.5 |
| 1.10 | M-10 | S-72 | 500 | 62.6 | 79.1 |

As can be seen from table 2, after backlight stress, a small concentration of stabilisers leads to better VHR values than the initial values whereas the unstabilised mixture N-1 shows a drop of VHR after backlight stress (note the low measurement frequency).

### EXAMPLES 2.1 TO 2.12

TABLE 3
Suntest (VHR 20° C., 1 Hz)

| | | | | VHR | VHR |
|---|---|---|---|---|---|
| Example | Mixture | Stabiliser | Conc./ppm | initial/% | (30 min)/% |
| (Ref.) | N-2 | none | — | 89.2 | 67.2 |
| 2.1 | M-11 | S-68 | 100 | 93.2 | 80.8 |
| 2.2 | M-12 | S-68 | 300 | 93.5 | 89.1 |
| 2.3 | M-13 | S-68 | 600 | 93.2 | 91.6 |

As can be seen from table 3, even a small amount of only 100 ppm of stabiliser S-68 is effective in significantly improving the VHR after Suntest compared to the unstabilised reference N-2. The effect is even better using 300 ppm of stabiliser. 600 ppm lead to a complete stabilisation within the error limit.

TABLE 4
Suntest (VHR 20° C., 1 Hz)

| | | | | VHR | VHR |
|---|---|---|---|---|---|
| Example | Mixture | Stabiliser | Conc./ppm | initial/% | (30 min)/% |
| (Ref.) | N-2 | none | — | 89.2 | 67.2 |
| 2.4 | M-14 | S-62 | 100 | 90.2 | 78.9 |
| 2.5 | M-15 | S-62 | 300 | 91.0 | 83.2 |
| 2.6 | M-16 | S-62 | 600 | 92.0 | 86.8 |

As can be seen from table 4, even a small amount of only 100 ppm of stabiliser S-62 is effective in significantly improving the VHR after Suntest compared to the unstabilised reference N-2. The effect is even better using 300 ppm of stabiliser. 600 ppm lead to a complete stabilisation within the error limit compared to the unstabilised mixture before light stress.

TABLE 5
Suntest (VHP 20° C., 1 Hz)

| | | | | VHR | VHR |
|---|---|---|---|---|---|
| Example | Mixture | Stabiliser | Conc./ppm | initial/% | (30 min)/% |
| (Ref.) | N-2 | none | — | 89.2 | 67.2 |
| 2.7 | M-17 | S-75 | 100 | 92.1 | 72.0 |
| 2.8 | M-18 | S-75 | 300 | 92.9 | 77.3 |
| 2.9 | M-19 | S-75 | 600 | 90.4 | 82.9 |

Table 5 shows excellent stabilising properties of stabiliser S-75.

TABLE 6
Suntest (VHR 100° C., 60 Hz)

| | | | | VHR | VHR |
|---|---|---|---|---|---|
| Example | Mixture | Stabiliser | Conc./ppm | initial/% | (30 min)/% |
| (Ref.) | N-2 | none | — | 66.3 | 65.7 |
| 2.10 | M-20 | S-68 | 100 | 66.7 | 68.0 |
| 2.11 | M-21 | S-68 | 500 | 68.0 | 74.2 |
| 2.12 | M-22 | S-68 | 1000 | 65.8 | 76.3 |

From Table 6 can be seen that within the error limits no significant improvement of the VHR after suntest can be achieved by using more than 500 ppm of stabiliser S-68.

### COMPARATIVE EXAMPLES C1.1 AND C1.2 AND EXAMPLE 2.13

Compounds HALS-1 and HALS-2 from the state of the art are tested according to the procedure described above and are compared with the compound S-68. All stabilisers are used in optimised concentrations. The results are shown in table 7.

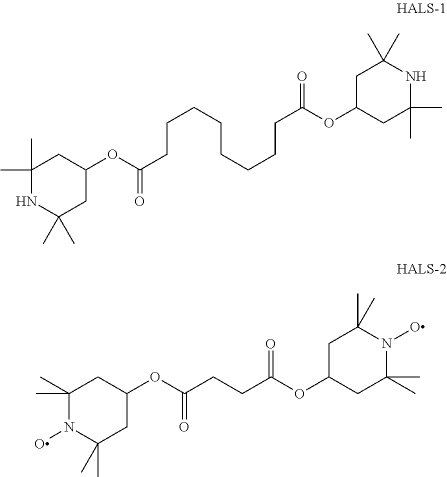

TABLE 7
LED Backlight Stress (VHR: 60° C., 5 V, 60 Hz)

| | | | | VHR | VHR |
|---|---|---|---|---|---|
| Example | Mixture | Stabiliser | Conc./ppm | initial/% | (900 h)/% |
| (Ref.) | N-2 | none | — | 98.9 | 88.9 |
| C1.1 | M-23 | HALS-1 | 250 | 96.9 | 89.9 |
| C1.2 | M-24 | HALS-2 | 150 | 97.8 | 94.0 |
| 2.13 | M-25 | S-68 | 500 | 99.0 | 97.6 |

From table 7 it can be seen that by using the stabiliser S-68 better VHR values after 900h of backlight load are achieved than by using the stabilisers HALS-1 or HALS-2 from the state of the art.

### EXAMPLE 3

A mixture N1 is prepared and one part is stabilised with 500 ppm of stabiliser S-68 (mixture M22) and the other is stabilised with 3000 ppm of S68 (mixture M-23). Both mixtures are filled into e/o-test cells and are irradiated for 10 min with UV-light using a metal halide mercury lamp with a 320 nm UV cut filter under application of a voltage of 6V.

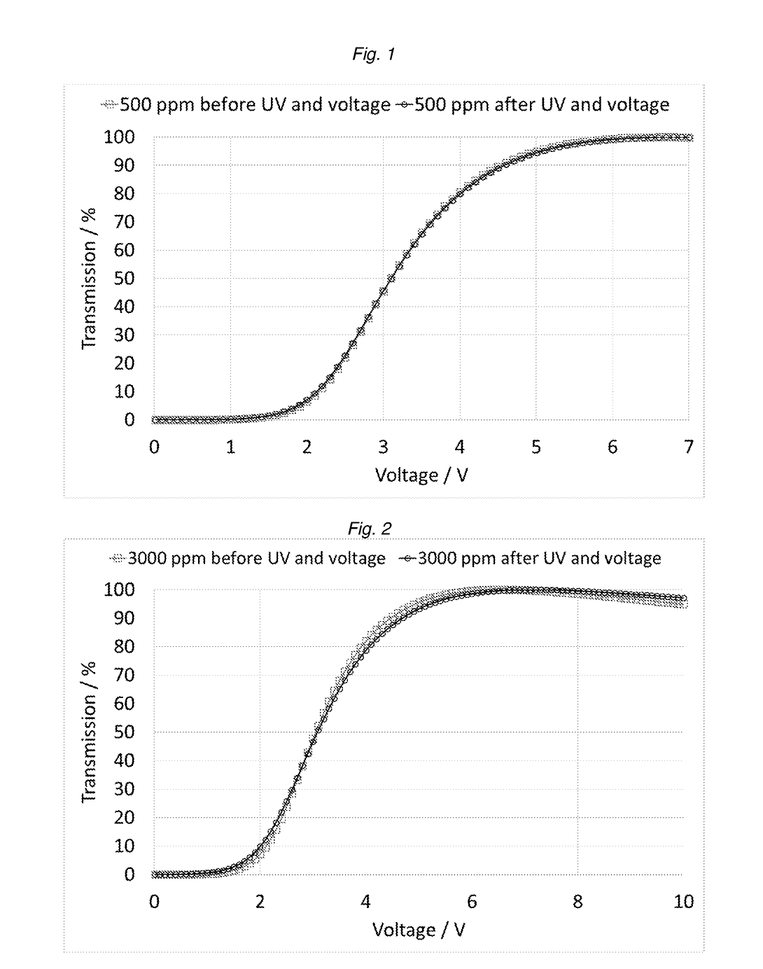

As can be seen from FIG. 1, the e/o curve remains unchanged for the sample containing 500 ppm of stabiliser upon irradiation whereas the e/o-curve of mixture M23 with 3000 ppm of stabiliser changes significantly (FIG. 2) after UV irradiation under application of a voltage.

1. Process for the stabilisation of a liquid crystal (LC) mixture with negative dielectric anisotropy, characterised in that one or more stabilisers of formula I
R^{a}-A¹-(Z¹-A²)ₘ₁-R^{b} I
are added to the LC mixture in a total amount of ≤0.1% by weight based on the total mixture, in which the individual radicals have the following meanings:
R^{a} and R^{b} each, independently of one another, denote P, P-Sp-, H, halogen, SF₅, NO₂, a carbyl group or a hydrocarbyl group,
P on each occurrence, identically or differently, denotes CH₂═CW¹—CO—O—,
W¹ denotes H, F, CF₃ or alkyl having 1 to 5 C atoms,
Sp on each occurrence, identically or differently, denotes a spacer group or a single bond,
A¹ and A² each, independently of one another, denote an aromatic, heteroaromatic, alicyclic or heterocyclic group, which may also contain fused rings, and which is optionally mono- or polysubstituted by L,
Z¹ on each occurrence, identically or differently, denotes —O—, —S—, —CO—, —CO—O—, —O—CO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —CR⁰R⁰⁰— or a single bond,
L denotes P, P-Sp-, H, OH, CH₂OH, halogen, SF₅, NO₂, a carbyl group or hydrocarbyl group,
R⁰ and R⁰⁰ each, independently of one another, denote H or alkyl having 1 to 12 C atoms,
m1 denotes 0, 1, 2, 3 or 4,
n1 denotes 1, 2, 3 or 4,
wherein at least one of the radicals R^{a}, R^{b} and L denotes or contains a group P or P-Sp-.

2. Process according to claim 1 characterised in that P denotes an acrylate or methacrylate group.

3. Process according to claim 1, characterised in that the total concentration of stabilisers of formula I in the LC mixture is in the range from 10 ppm to 900 ppm.

4. Process according to claim 1, characterised in that the total concentration of stabilisers of formula I in the LC mixture is in the range from 100 ppm to 750 ppm.

5. Process according to claim 1, wherein in formula I
A¹ and A² each, independently of one another, denote 1,4-phenylene, 1,3-phenylene, 1,2-phenylene, naphthalene-1,4-diyl, naphthalene-2,6-diyl, phenanthrene-2,7-diyl, anthracene-2,7-diyl, fluorene-2,7-diyl, in which, in addition, one or more CH groups in these groups may be replaced by N, cyclohexane-1,4-diyl, in which, in addition, one or more non-adjacent CH₂ groups may be replaced by —O— and/or —S—, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl, octahydro-4,7-methanoindane-2,5-diyl, 9,10-dihydro-phenanthrene-2,7-diyl, 2H-chromen-2-one-3,6-diyl, 2H-chromen-2-one-3,8-diyl, or 2H-chromen-2-one-3,7-diyl, [1,1′]Binaphthalenyl-2,2′-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, straight-chain or branched alkyl or alkoxy having 1 to 25 C atoms, or straight-chain or branched alkenyl, alkinyl, alkylcarbonyl, alkoxycarbonyl, alkylcarbonyloxy or alkoxycarbonyloxy having 2 to 25 C atoms, wherein in all of these groups, in addition, one or more H atoms may be replaced by F, Cl or P-Sp-,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl or P-Sp-, an optionally substituted aryl or aryloxy group having 6 to 40 C atoms, or an optionally substituted heteroaryl or heteroaryloxy group having 2 to 40 C atoms,
where at least one of the radicals R^{a}, R^{b} and L denotes P or P-Sp-.

6. Process according to claim 1 wherein the compounds of formula I are selected from the following formulae 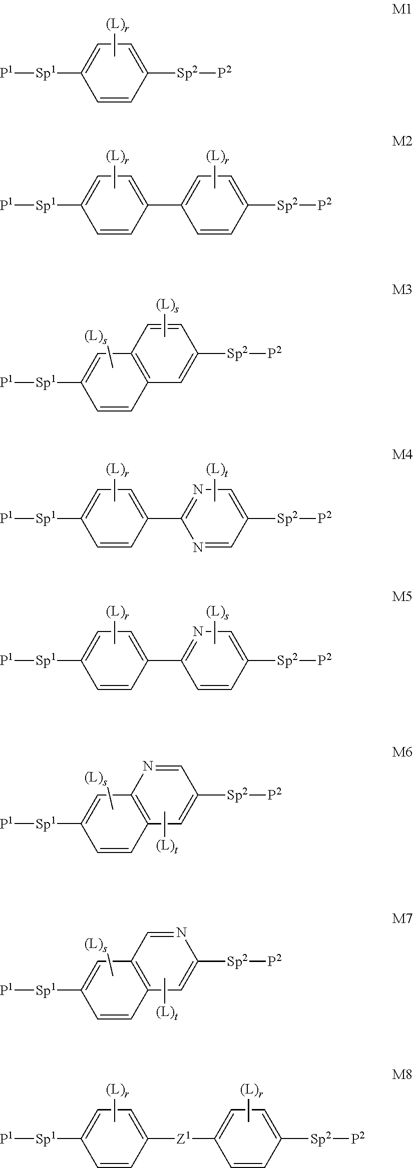 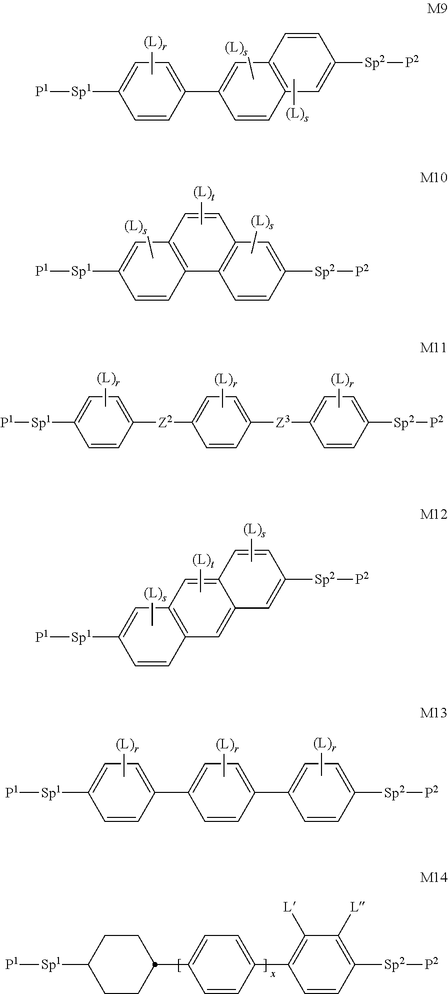 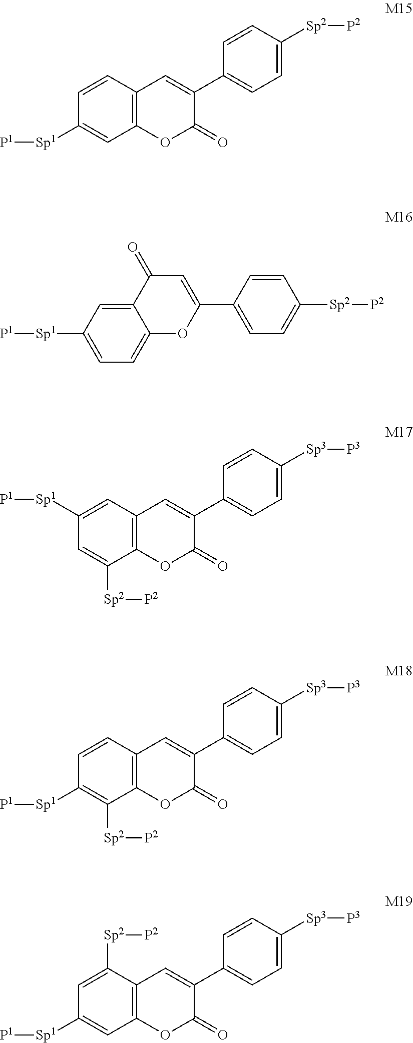 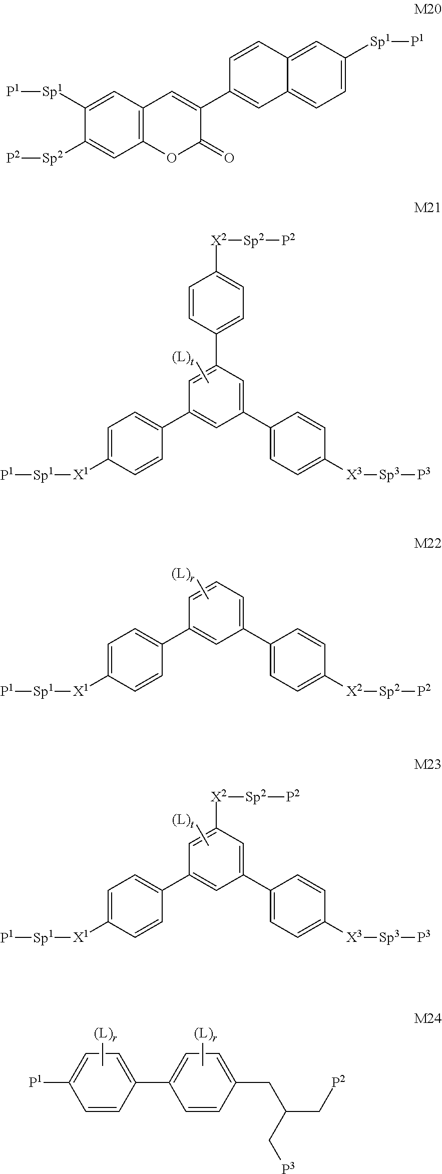 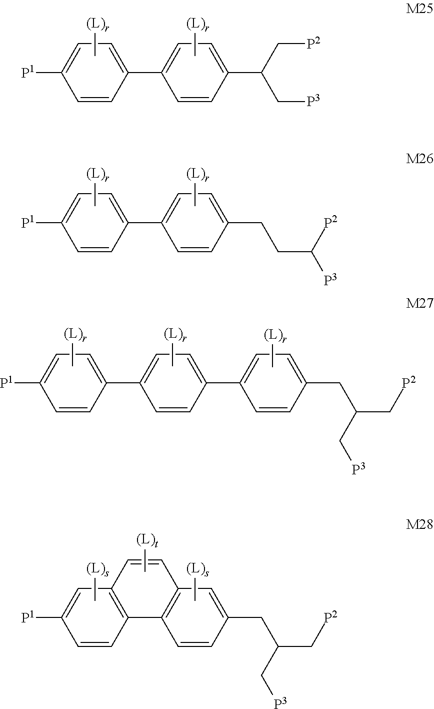 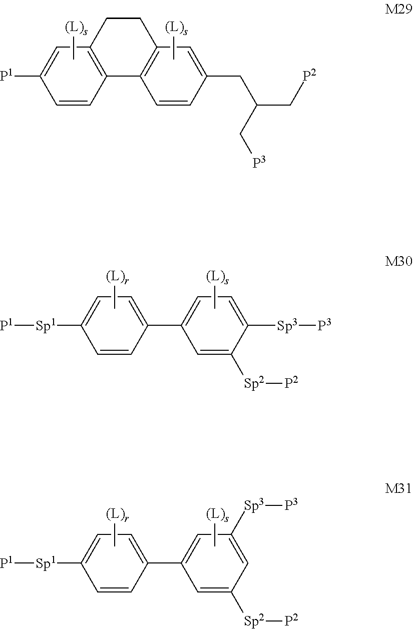
in which the individual radicals have the following meanings:
P¹, P² and P³ each, independently of one another, denote a stabilising group P as defined in claim 1,
Sp¹, Sp² and Sp³ each, independently of one another, denote a single bond or a spacer group where, in addition, one or more of the radicals P¹-Sp¹, P²-Sp²- and P³-Sp³- may denote R^{aa}, with the proviso that at least one of the radicals P¹-Sp¹-,
P²-Sp²- and P³-Sp³- present is different from R^{aa},
R^{aa} denotes H, F, Cl, CN or straight-chain or branched alkyl having 1 to 25 C atoms, in which, in addition, one or more non-adjacent CH₂ groups may each be replaced, independently of one another, by C(R⁰)═C(R⁰⁰)—, —C≡C—, —N(R⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, CN or P¹-Sp¹-,
R⁰, R⁰⁰ each, independently of one another and identically or differently on each occurrence, denote H or alkyl having 1 to 12 C atoms,
R^{y} and R^{z} each, independently of one another, denote H, F, CH₃ or CF₃,
X¹, X² and X³ each, independently of one another, denote —CO—O—, —O—CO— or a single bond,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ—, where n is 2, 3 or 4,
L on each occurrence, identically or differently, denotes F, Cl, CN or straight-chain or branched, optionally mono- or polyfluorinated alkyl, alkoxy, alkenyl, alkynyl, alkylcarbonyl, alkoxycarbonyl, alkylcarbonyloxy or alkoxycarbonyloxy having 1 to 12 C atoms, preferably F,
L′ and L″ each, independently of one another, denote H, F or Cl,
r denotes 0, 1, 2, 3 or 4,
s denotes 0, 1, 2 or 3,
t denotes 0, 1 or 2,
x denotes 0 or 1.

7. Process according to claim 6, wherein in the compounds of formulae M1 to M31
Sp¹, Sp² and Sp³ each, independently of one another, denote a single bond or —(CH₂)ₚ₁—, —(CH₂)ₚ₁—O—, —(CH₂)ₚ₁—CO—O—, —(CH₂)ₚ₁—O—CO— or —(CH₂)ₚ₁—O—CO—O—, in which p1 is an integer from 1 to 12.

8. Process according to claim 1, wherein the LC mixture comprises one or more stabilisers selected from the following formulae:

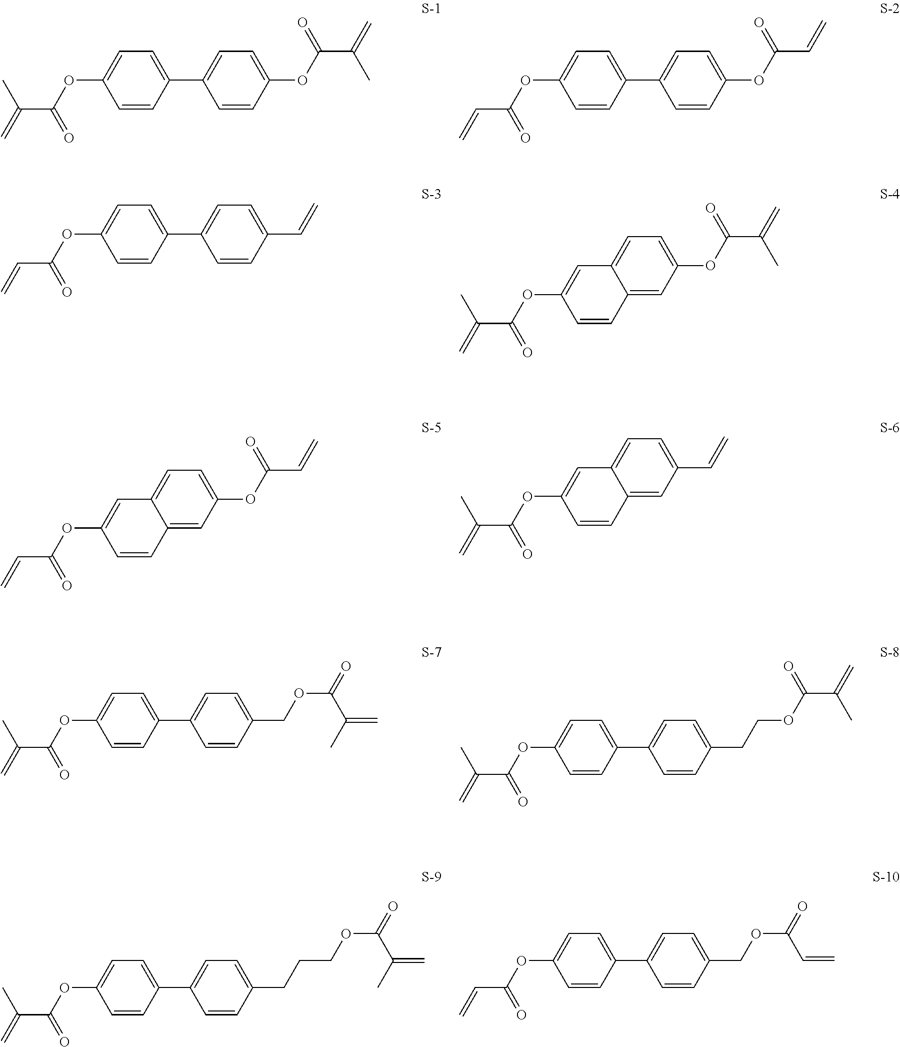

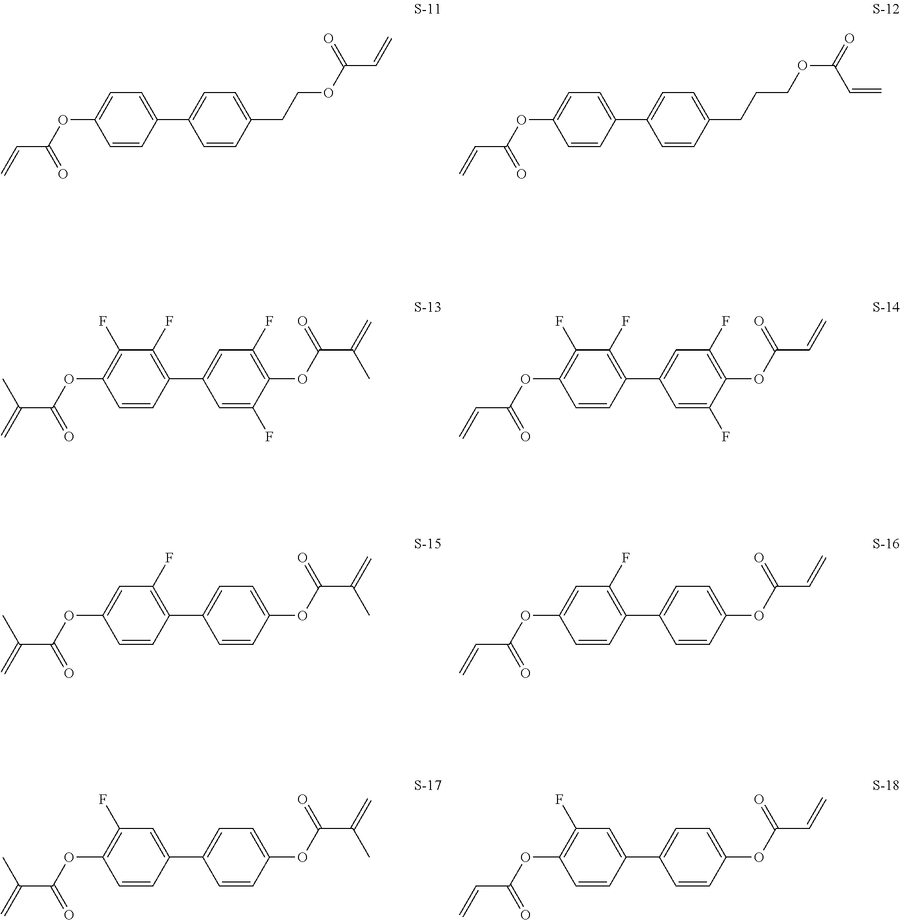

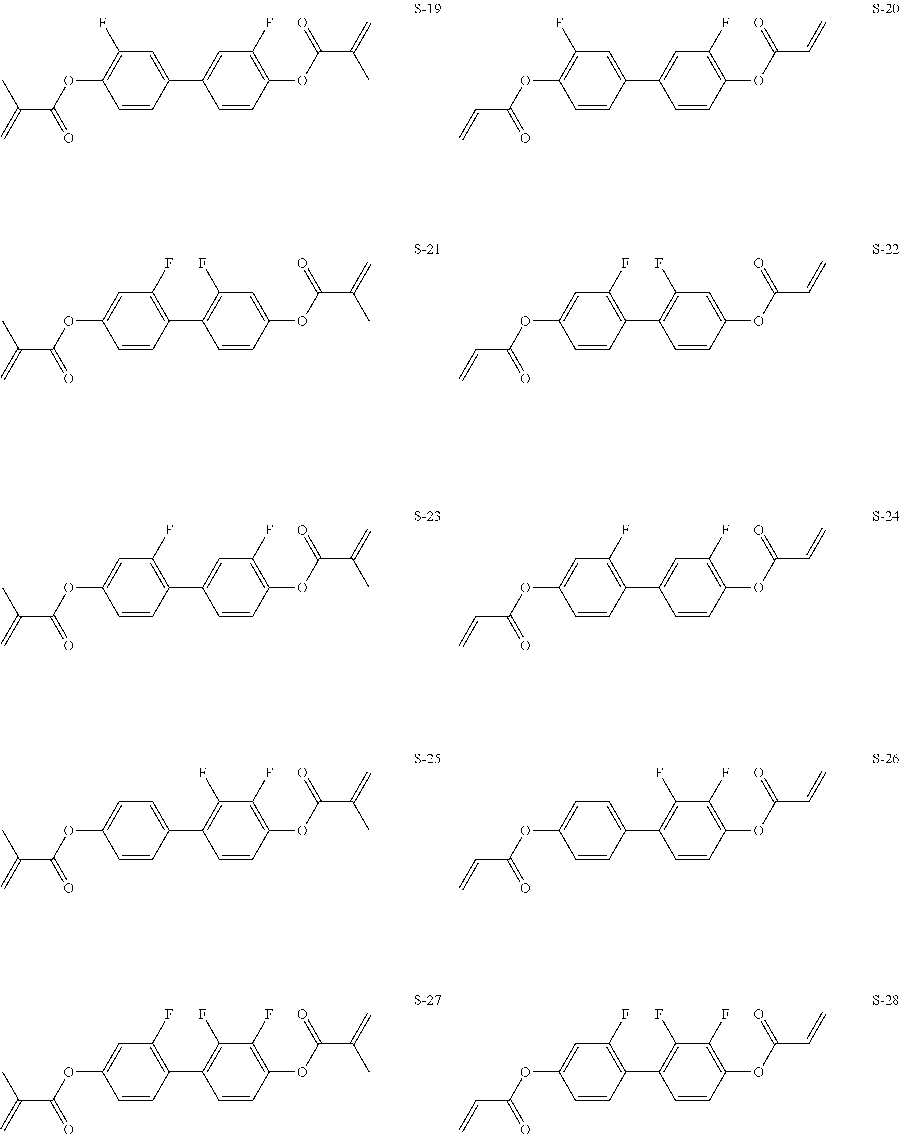

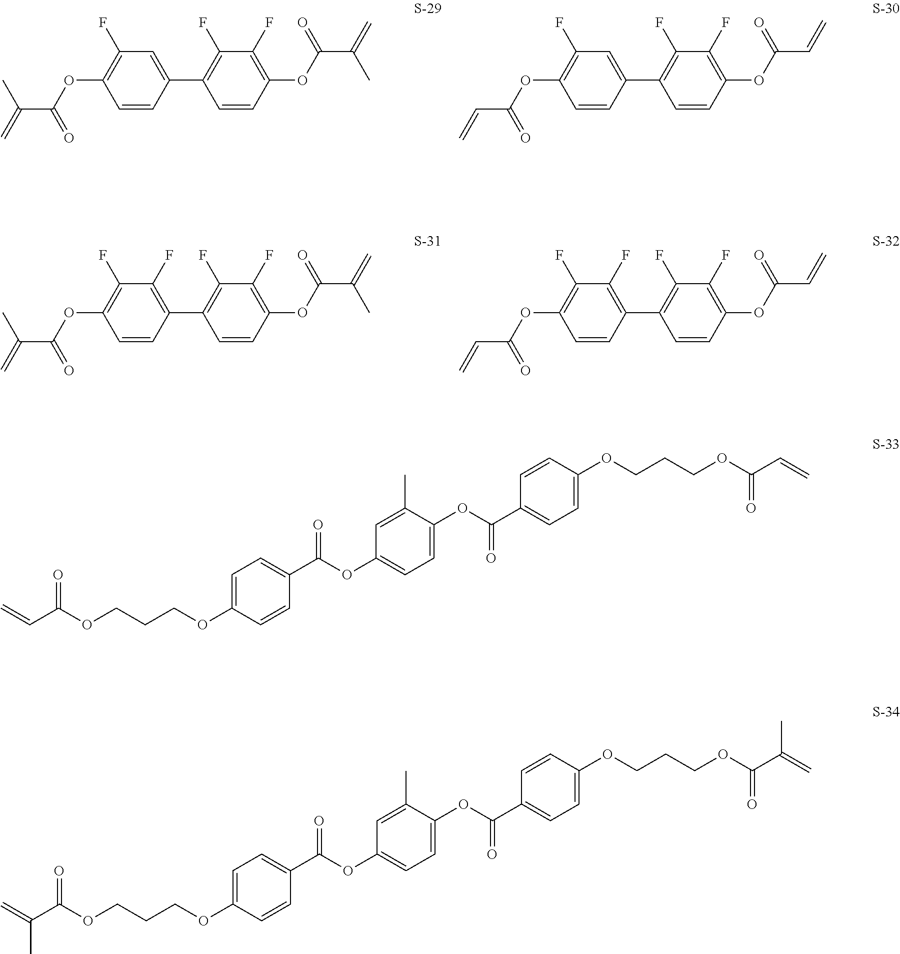

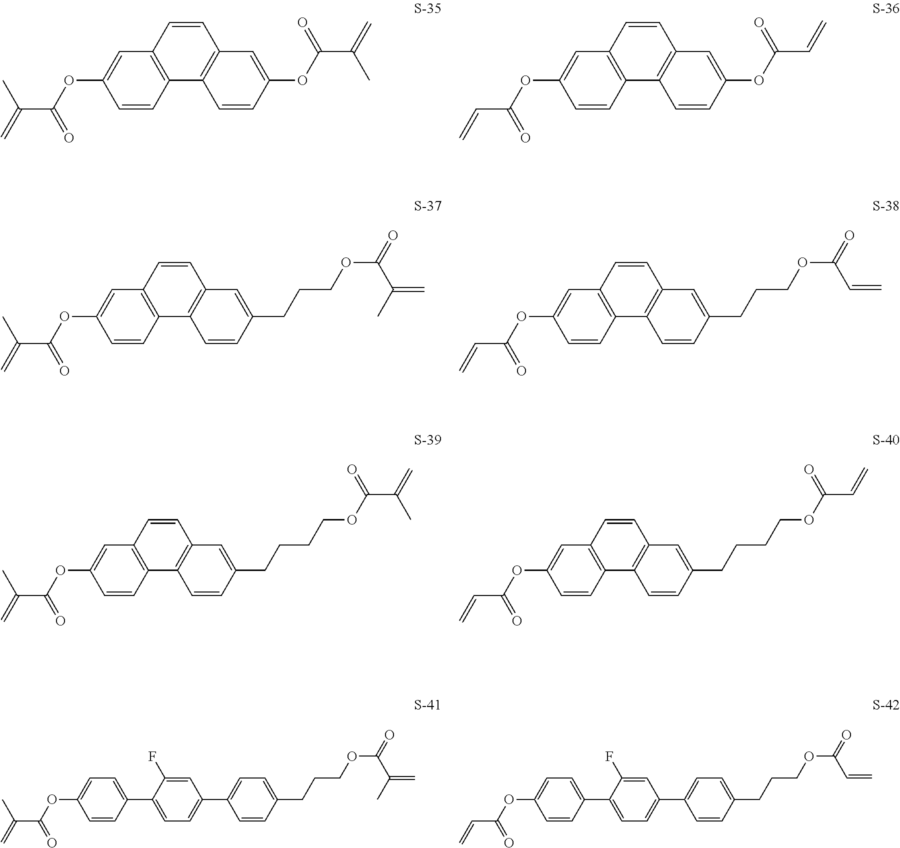

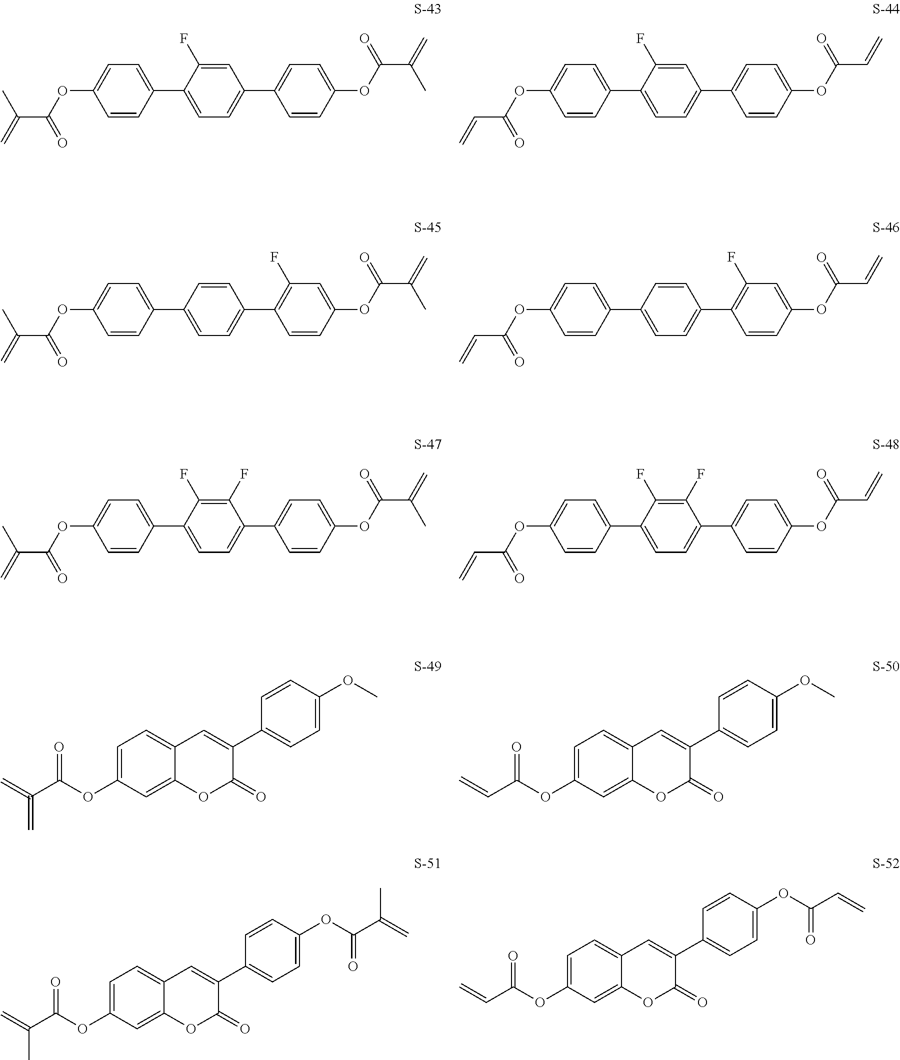

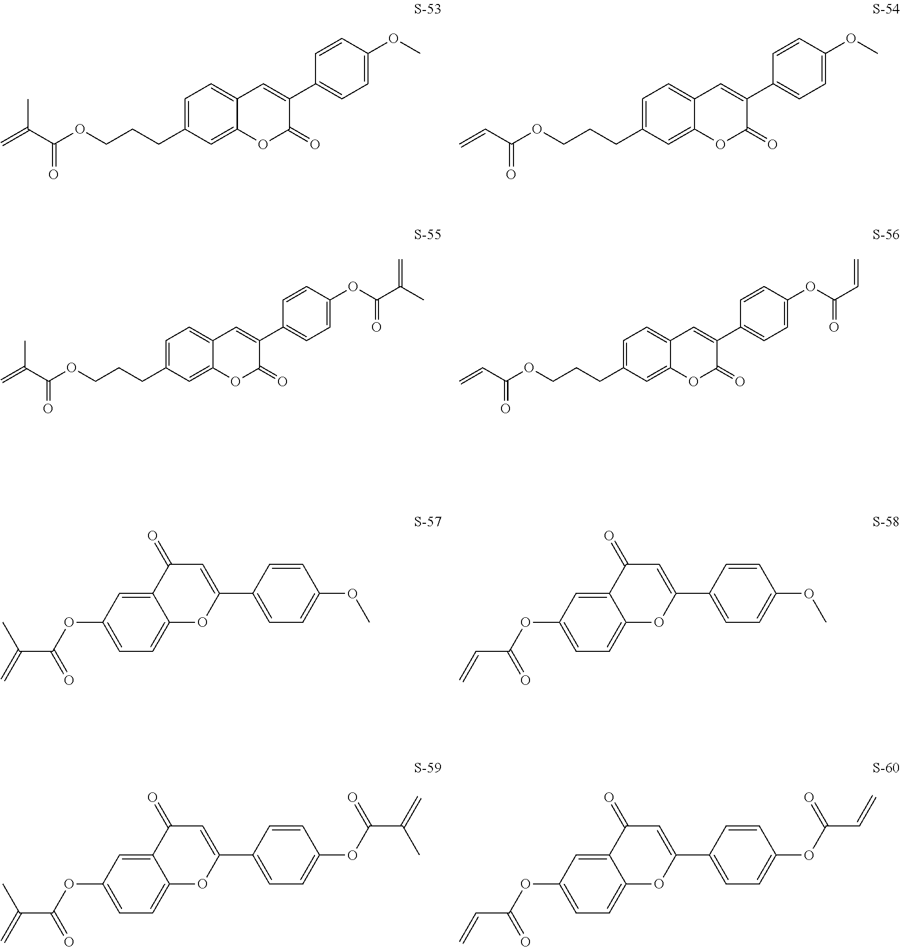

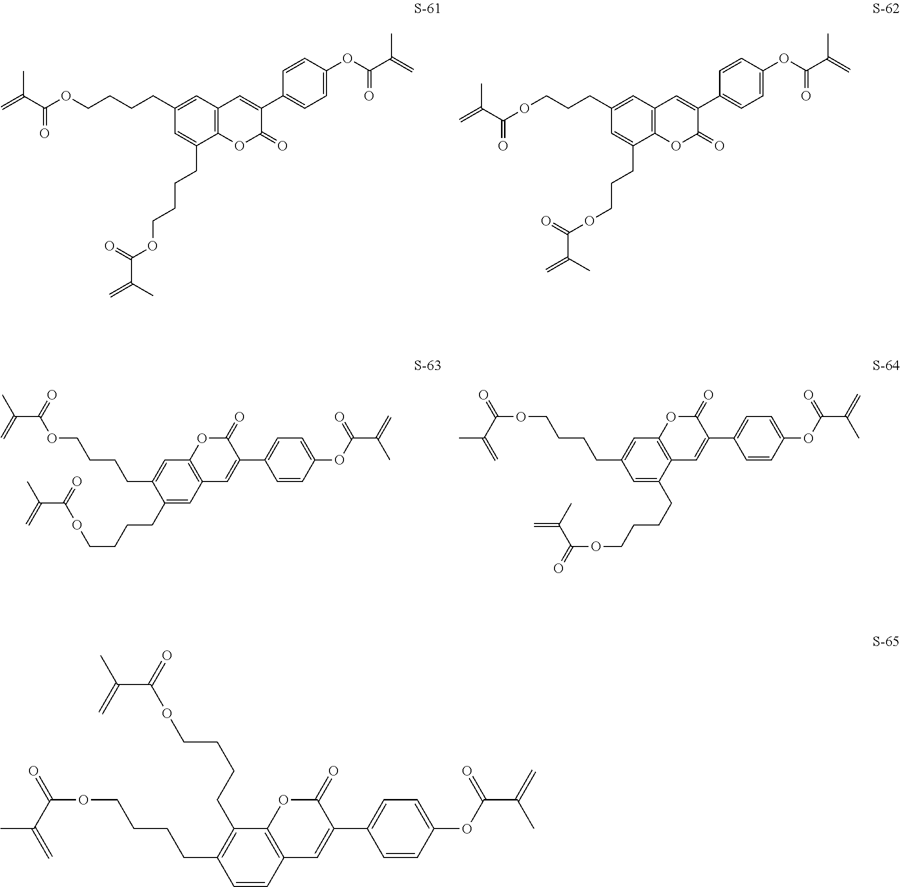 [SMILES: C=C(C)C(=O)OCCCCc1cc(CCCCOC(=O)C(=C)C)c2oc(=O)c(-c3ccc(OC(=O)C(=C)C)cc3)cc2c1 ; C=C(C)C(=O)OCCCc1cc(CCCOC(=O)C(=C)C)c2oc(=O)c(-c3ccc(OC(=O)C(=C)C)cc3)cc2c1 ; C=C(C)C(=O)OCCCCc1cc2cc(-c3ccc(OC(=O)C(=C)C)cc3)c(=O)oc2cc1CCCCOC(=O)C(=C)C ; C=C(C)C(=O)OCCCCc1cc(CCCCOC(=O)C(=C)C)c2cc(-c3ccc(OC(=O)C(=C)C)cc3)c(=O)oc2c1 ; C=C(C)C(=O)OCCCCc1ccc2cc(-c3ccc(OC(=O)C(=C)C)cc3)c(=O)oc2c1CCCCOC(=O)C(=C)C]

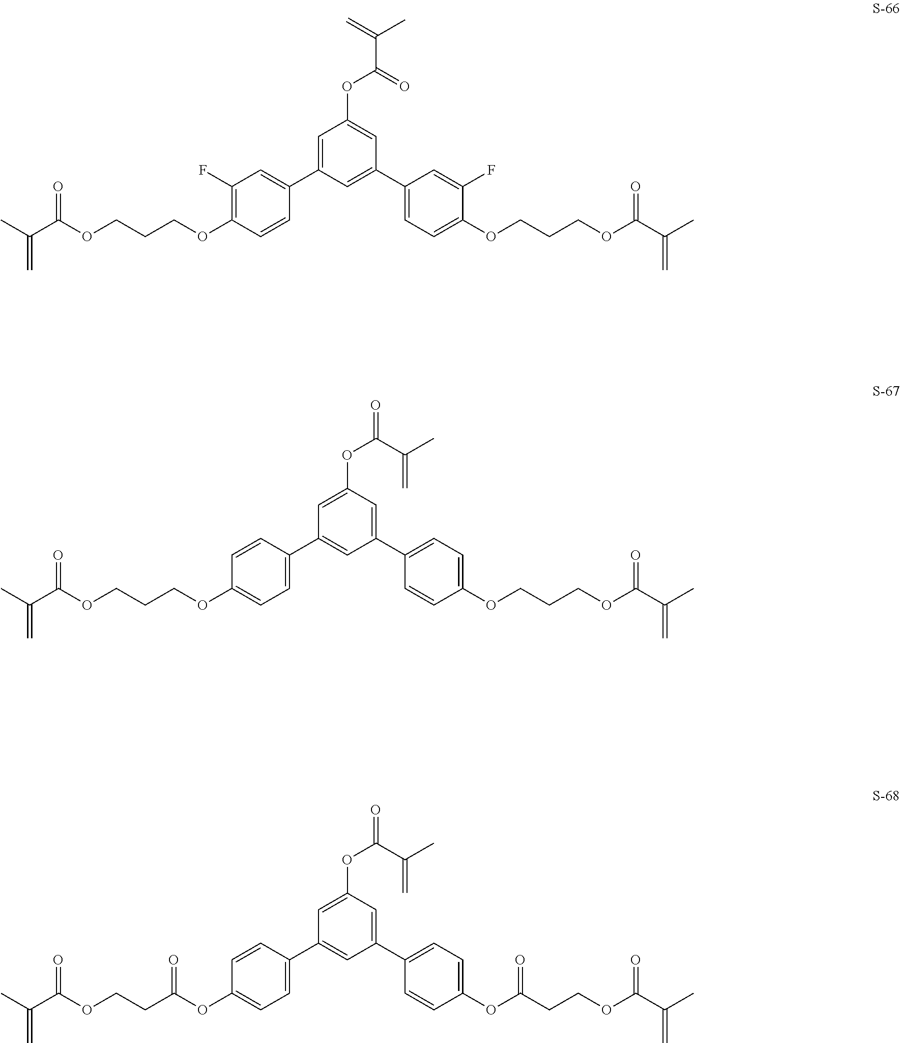

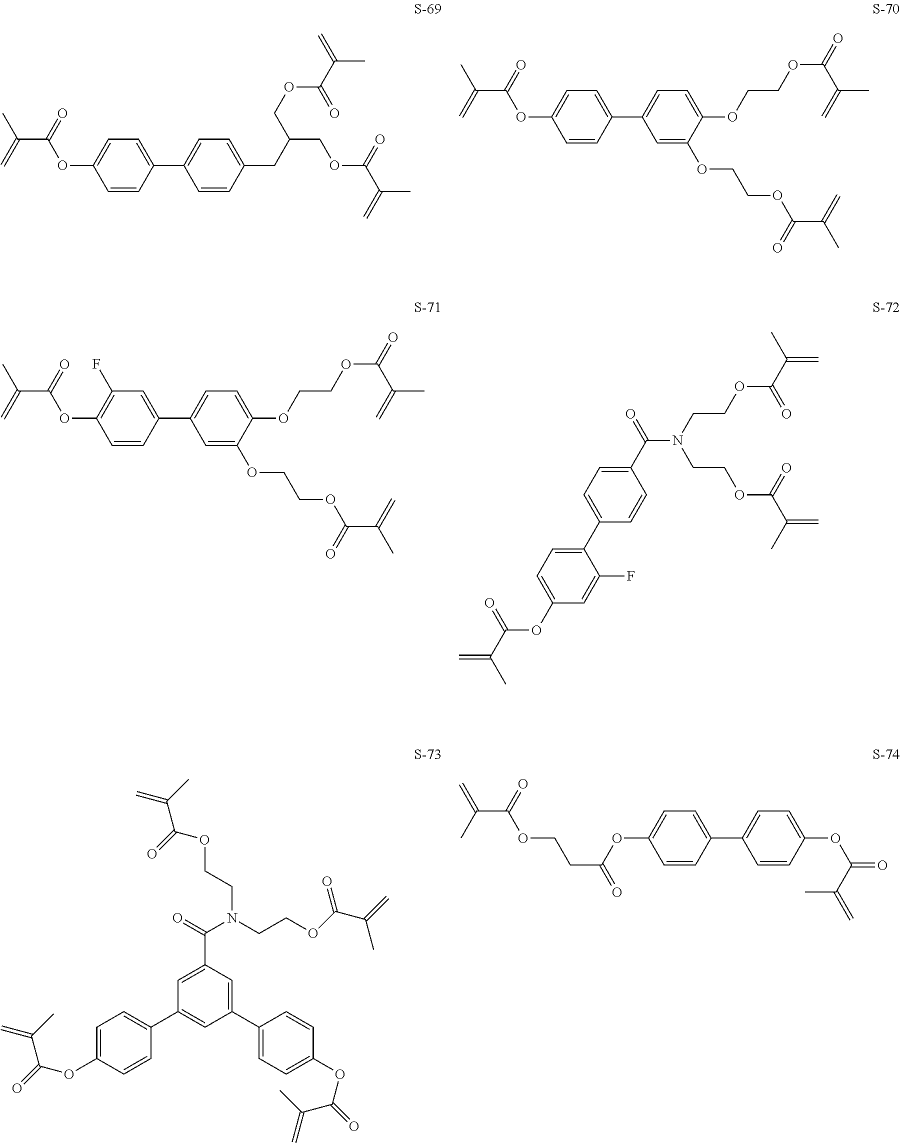 [SMILES: C=C(C)C(=O)OCC(COC(=O)C(=C)C)Cc1ccc(-c2ccc(OC(=O)C(=C)C)cc2)cc1 ; C=C(C)C(=O)OCCOc1ccc(-c2ccc(OC(=O)C(=C)C)cc2)cc1OCCOC(=O)C(=C)C ; C=C(C)C(=O)OCCOc1ccc(-c2ccc(OC(=O)C(=C)C)c(F)c2)cc1OCCOC(=O)C(=C)C ; C=C(C)C(=O)OCCN(CCOC(=O)C(=C)C)C(=O)c1ccc(-c2ccc(OC(=O)C(=C)C)cc2F)cc1 ; C=C(C)C(=O)OCCN(CCOC(=O)C(=C)C)C(=O)c1cc(-c2ccc(OC(=O)C(=C)C)cc2)cc(-c2ccc(OC(=O)C(=C)C)cc2)c1 ; C=C(C)C(=O)OCCC(=O)Oc1ccc(-c2ccc(OC(=O)C(=C)C)cc2)cc1]

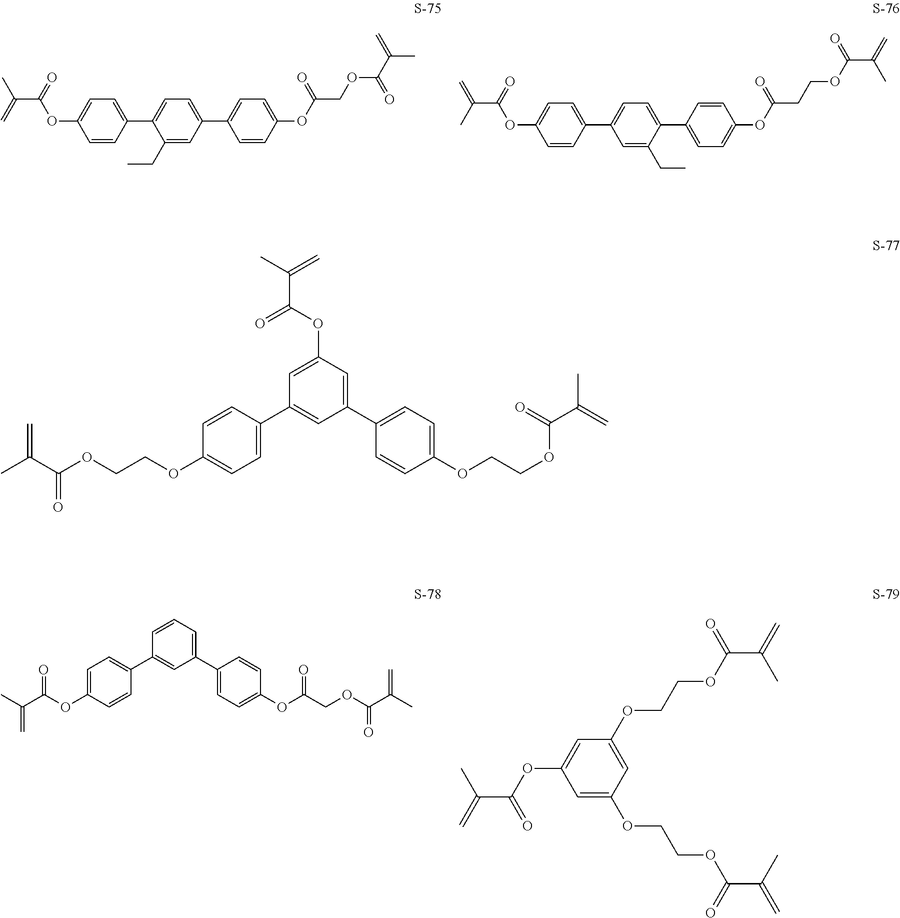

9. Process according to claim 1 wherein the LC mixture comprises one or more compounds selected from the following formulae: 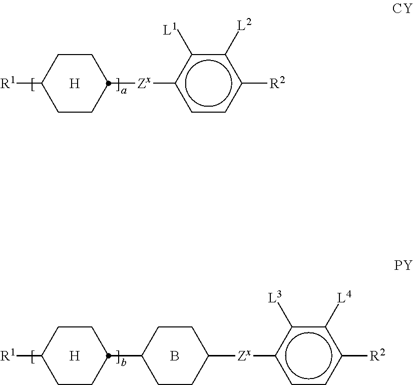
in which the individual radicals have the following meanings:
a denotes 1 or 2,
b denotes 0 or 1, 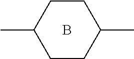
denotes 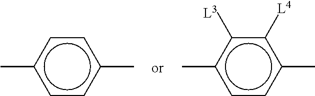
R¹ and R² each, independently of one another, denote alkyl having 1 to 12 C atoms, where, in addition, one or two non-adjacent CH₂ groups may be replaced by —O—, —CH═CH—, —CO—, —O—CO— or —CO—O— in such a way that O atoms are not linked directly to one another,
Z^{x} denotes —CH═CH—, —CH₂O—, —OCH₂—, —OCF₂—, —O—, —CH₂—, —CH₂CH₂— or a single bond,
L¹⁻⁴ each, independently of one another, denote F, Cl, OCF₃, CF₃, CH₃, CH₂F, CHF₂.

10. Process according to claim 1, wherein the LC mixture comprises one or more compounds selected from the following formula: 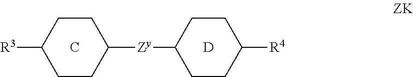
in which the individual radicals have the following meanings: 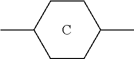
denotes 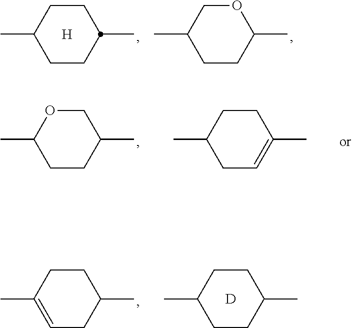
denotes 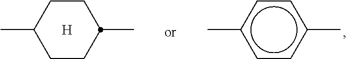
R³ and R⁴ each, independently of one another, denote alkyl having 1 to 12 C atoms, in which, in addition, one or two non-adjacent CH₂ groups may be replaced by —O—, —CH═CH—, —CO—, —O—CO— or —CO—O— in such a way that O atoms are not linked directly to one another,
Z^{y} denotes —CH₂CH₂—, —CH═CH—, —OCF₂—, —CH₂O—, —OCH₂—, —COO—, —OCO—, —C₂F₄—, —CF═CF— or a single bond.

11. Process according to claim 10, wherein the LC mixture comprises one or more compounds selected from the following formulae:

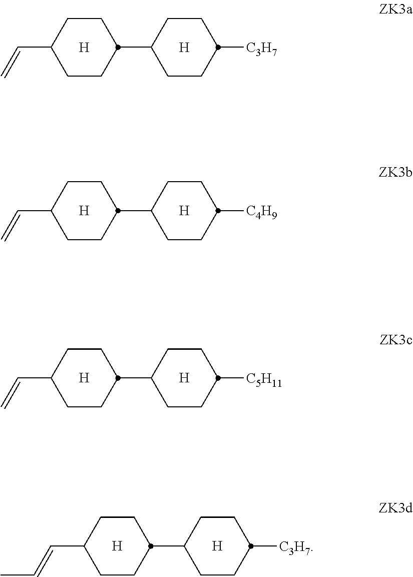

12. A stabilised LC mixture obtainable by the process of claim 1.

13. Process for manufacturing a liquid crystal display, comprising at least the steps of: forming a plurality of pixel electrodes in an active region on a first substrate; applying UV-type hardening sealant on a sealing region positioned along a periphery of the active region;
forming a second substrate, the second substrate facing the first substrate, interposing a liquid crystal mixture according to claim 12 between the first substrate and the second substrate; coupling the first substrate and the second substrate together with a distance therebetween; and irradiating UV-rays to the sealant.

14. Process according to claim 13, characterised in that the active region of at least one substrate is covered with a shadow mask during hardening of the sealant.

15. Process according to claim 13, characterised in that the liquid crystal mixture is not exposed to UV light during manufacture of the display.

16. LC display, characterised in that it comprises an LC mixture according to claim 12.

17. Display according to claim 16, characterised in that it is a display of the VA-, IPS- or FFS mode.
